(19) United States
(12) Patent Application Publication
(10) Pub. No.: US 2021/0042709 A1
(43) Pub. Date: Feb. 11, 2021

(54) VEHICLE ASSISTANCE APPARATUS AND METHOD

(71) Applicant: RSR Technologies Ltd., Cambridge (CA)

(72) Inventors: Leonard Alfred Schuller, Cambridge (CA); Lindsay Kristin Schuller, Cambridge (CA); Kevin Klein, Cambridge (CA)

(21) Appl. No.: 16/942,921

(22) Filed: Jul. 30, 2020

Related U.S. Application Data
(60) Provisional application No. 62/883,516, filed on Aug. 6, 2019.

(51) Int. Cl. G06Q 10/00; G06Q 50/30; G06Q 10/06; G06Q 30/00; H04W 4/02; H04W 4/40

(52) U.S. Cl. CPC G06Q 10/20; G06Q 50/30; H04W 4/40; G06Q 30/018; H04W 4/025; G06Q 10/063112

(57) ABSTRACT

A roadside assistance system includes at least one processor and at least one data storage device communicatively coupled to the at least one processor. The at least one processor is operable to provide a first navigator style interface to a service user; prompt, via the first navigator style interface, the service user to provide a user vehicle identifier to identify a vehicle of the service user; receive the user vehicle identifier; present a plurality of roadside service options to the service user; receive a user service selection of the plurality of roadside service options from the service user; receive a user location of the service user; match the user service selection to a service provider; and provide the service provider with the user service selection, the user vehicle identifier, and the user location.

### CROSS-REFERENCE TO RELATED APPLICATIONS

This application claims the benefit of U.S. Patent Application No. 62/883,516 filed Aug. 6, 2019, the entire content of which is hereby incorporated by reference.

### TECHNICAL FIELD

The present disclosure relates generally to vehicle assistance and, more particularly, to a community-based online vehicle assistance apparatus and method.

### BACKGROUND

U.S. Pat. No. 4,070,775 to Brooks (“Brooks”) purports to disclose a plurality of elongated generally rectangular panel members which include first and second sets of corresponding ends. A pivot fastener is secured through and pivotally joins one set of corresponding ends of the panel members together for relative angular displacement of the panel members. The panel members are swingable from a compact position with the panel members in full registry with each other and positions with at least one of the panel members angularly displaced relative to the remaining panel members. A spacing and friction washer is disposed between each pair of adjacent panel members and about the pivot fastener whereby the panel members may be frictionally retained in relatively angularly displaced positions. Each panel member is white in color and has word defining letters formed on its opposite sides with light reflective material of a color other than white. The word defining indicia on the opposite sides of each panel member are identical, the word forming indicia on the remote panel members is identical, and the word forming indicia on each panel member intermediate the remote panel members different.

U.S. Pat. No. 5,572,204 to Timm et al. (“Timm”) purports to disclose a vehicle user can request emergency or roadside assistance from a response center by activating a button in the vehicle. The global positioning system is used to continuously store the vehicle location. A cellular telephone network is used to contact a response center and transfer a data string via modem containing information to assist the response center in acting on the request. If a first attempt to contact the response center at a phone number for receiving a data transfer is unsuccessful, a second call is made to a different number bypassing the data transfer and immediately placing the cellular phone into an unmuted condition. This allows the user to hear and interact with a cellular operator, if necessary, prior to being connected to the response center.

### SUMMARY

According to a first aspect, there is provided a roadside assistance system, comprising at least one processor; and at least one data storage device communicatively coupled to the at least one processor, and wherein the at least one processor is operable to provide a first navigator style interface to a service user; prompt, via the first navigator style interface, the service user to provide a user vehicle identifier to identify a vehicle of the service user; receive the user vehicle identifier; present a plurality of roadside service options to the service user; receive a user service selection of the plurality of roadside service options from the service user; receive a user location of the service user; match the user service selection to a service provider; and provide the service provider with the user service selection, the user vehicle identifier, and the user location.

In some examples, the at least one processor is operable to, prior to matching the user service selection to the service provider provide a second navigator style interface to the service provider; prompt, via the second navigator style interface, the service provider to provide a first piece of evidence of possession of a roadside service skill for performing the user service selection; prompt, via the second navigator style interface, the service provider to provide a second piece of evidence of possession of a roadside service tool for performing the user service selection; receive the first piece of evidence and the second piece of evidence from the service provider.

In some examples, the at least one processor is operable to, prior to matching the user service selection to the service provider provide the first piece of evidence and the second piece of evidence to an administrator user; and receive a confirmation of eligibility from the administrator user, the confirmation of eligibility indicating that the service provider is eligible to provide the user service selection.

In some examples, the at least one processor is operable to prompt, via the second navigator interface, the service provider to provide a provider vehicle identifier to identify a vehicle of the service provider; and provide the provider vehicle identifier to the service user.

In some examples, the at least one processor is operable to, prior to matching the user service selection to the service provider present, via the second navigator style interface, the service provider with a choice of at least two classes of roadside services, each of the at least two classes including at least two roadside service types; and receive from the service provider, via the second navigator style interface, at least one class selection of the at least two classes and at least one service type selection of the at least two roadside service types, the at least one service type selection including the user service selection.

In some examples, the first piece of evidence includes evidence of a mechanic's license and the second piece of evidence includes evidence of a set of mechanic's tools.

In some examples, the plurality of roadside service options includes a battery boost service, a vehicle unlock service, a tire change service, a towing service, and a fluid top up service.

According to a second aspect, there is provided a method of providing roadside assistance, comprising providing a service user with a first navigator style interface for walking the user through a user profile creation process; eliciting from the service user, via the first navigator style interface, at least one user vehicle identifier for identifying a user vehicle of the service user; generating a user profile, the user profile including the at least one user vehicle identifier; presenting the service user with a plurality of roadside service options each directed to a different type of roadside assistance; receiving from the service user a user service selection of the plurality of roadside service options; receiving a user location of the service user; matching the user service selection to a service provider; and providing the service provider with the user service selection, the user vehicle identifier, and the user location.

In some examples, the method further comprises, prior to matching the user service selection to the service provider providing a second navigator style interface to the service provider; prompting, via the second navigator style interface, the service provider to provide a first piece of evidence of possession of a roadside service skill for performing the user service selection; prompting, via the second navigator style interface, the service provider to provide a second piece of evidence of possession of a roadside service tool for performing the user service selection; and receiving the first piece of evidence and the second piece of evidence from the service provider.

In some examples, the method further comprises, prior to matching the user service selection to the service provider providing the first piece of evidence and the second piece of evidence to an administrator user; and receiving a confirmation of eligibility from the administrator user, the confirmation of eligibility indicating that the service provider is eligible to provide the user service selection.

In some examples, the method further comprises prompting, via the second navigator interface, the service provider to provide a provider vehicle identifier to identify a vehicle of the service provider; and providing the provider vehicle identifier to the service user.

In some examples, the method further comprises, prior to matching the user service selection to the service provider presenting, via the second navigator style interface, the service provider with a choice of at least two classes of roadside services, each of the at least two classes including at least two roadside service types; and receiving from the service provider, via the second navigator style interface, at least one class selection of the at least two classes and at least one service type selection of the at least two roadside service types, the at least one service type selection including the user service selection.

In some examples, the first piece of evidence includes evidence of a mechanic's license and the second piece of evidence includes evidence of a set of mechanic's tools.

In some examples, the plurality of roadside service options includes a battery boost service, a vehicle unlock service, a tire change service, a towing service, and a fluid top up service.

According to a third aspect, there is provided a roadside assistance system, comprising at least one processor; and at least one data storage device communicatively coupled to the at least one processor, and wherein the at least one processor is operable to provide a first navigator style interface to a service user; present, via the first navigator style interface, a plurality of roadside service options to the service user; receive, via the first navigator style interface, a user service selection of the plurality of roadside service options from the service user;

receive a user location of the service user; access the at least one data storage device to retrieve a user profile associated with the service user, the user profile including a user vehicle identifier to identify a vehicle of the service user; access the at least one data storage device to retrieve a provider profile of a service provider, the provider profile including a confirmation that the service provider possesses a roadside service skill and a roadside service tool for performing the user service selection; and send the user service selection, the user vehicle identifier, and the user location to the service provider.

In some examples, the selected service is a first roadside service, and the plurality of roadside service options also includes a second roadside service, the first roadside service associated with a first set of skills and tools and the second roadside service associated with a second set of skills and tools different from the first set of skills and tools.

In some examples, the confirmation includes a first piece of evidence of possession of the roadside service skill and a second piece of evidence of possession of the roadside service tool.

In some examples, the first piece of evidence includes evidence of a mechanic's license and the second piece of evidence includes evidence of a set of mechanic's tools.

In some examples, the provider profile includes a provider vehicle identifier to identify a vehicle of the service provider, and the at least one processor is operable to provide the provider vehicle identifier to the service user.

In some examples, the plurality of roadside service options includes a battery boost service, a vehicle unlock service, a tire change service, a towing service, and a fluid top up service.

### BRIEF DESCRIPTION OF THE DRAWINGS

The drawings included herewith are for illustrating various examples of systems, methods, and apparatus of the present specification. In the drawings:

FIG. 1 is a schematic diagram of a vehicle assistance system;

FIG. 2 is a flow chart of a method of providing roadside assistance;

FIG. 3 depicts a first home page;

FIG. 4 depicts a second home page;

FIG. 5 depicts a one-time password verification page;

FIG. 6 depicts a sign in page of a user or provider sign in navigator style interface;

FIGS. 7 to 10 depict pages generated by a first user sign up navigator style interface;

FIGS. 11 to 17 depict pages generated by a second user sign up navigator style interface;

FIG. 18 depicts a page generated by a third user sign up navigator style interface;

FIGS. 19 to 32 depict pages generated by a first service request navigator style interface;

FIGS. 33 to 59 depict pages generated by a second service request navigator style interface;

FIGS. 60 to 66 depict pages generated by a first service provider sign up navigator style interface;

FIGS. 67 and 68 depict pages generated by a second service provider sign up navigator style interface;

FIGS. 69 and 70 depict pages generated by a first service provider response navigator style interface;

FIG. 71 depicts a dashboard of a user vehicle, with a mobile device displaying a page generated by the vehicle assistance system;

FIGS. 72 to 79 show further examples of pages generated by the first service prover response navigator style interface;

FIGS. 80 to 98 depict pages generated by an administrator navigator style interface;

FIGS. 99 to 114 depict pages generated by a third provider sign up navigator style interface;

FIGS. 115 to 129 depict pages generated by a second service provider response navigator style interface; and

FIG. 130 depicts a page generated by a third service provider response navigator style interface.

### DETAILED DESCRIPTION

Various apparatus or processes will be described below to provide an example of each claimed embodiment. No example described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatus or processes described below.

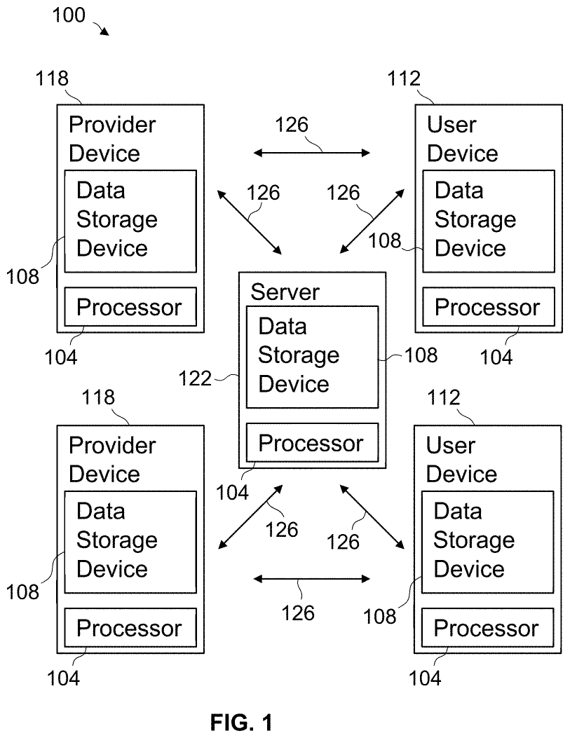

Referring to FIG. 1, illustrated is an example of a vehicle assistance system 100. The vehicle assistance system 100 may be provided to connect a service user having a user vehicle with a service provider having a set of skills and a set of tools able to assist the service user by providing a vehicle service to the user vehicle.

For example, the user vehicle may be a trailer, and the service provider may possess a provider vehicle with a hitch for towing the trailer. In another example, the user vehicle may be a boat, and the service provider may possess a trailer for use in transporting the boat. In another example, the user vehicle may be a car, and the service provider may be able to rotate or change the tires on the car.

In some examples, the vehicle assistance system 100 is a roadside assistance system. A roadside assistance system may connect the service user with a service provider able to provide a roadside assistance service to the user vehicle at a roadside, such as an emergency repair. For example, the user vehicle may be a car, and the service provider may be able to repair a flat tire on the car, deliver fuel for the car, or tow the car.

The vehicle assistance system 100 includes at least one processor 104 and at least one data storage device 108. The at least one data storage device 108 is communicatively coupled to the at least one processor 104.

Optionally, the vehicle assistance system 100 includes at least one user device 112 of a service user, such as a mobile device (e.g. a smartphone or tablet). Similarly, the vehicle assistance system 100 may include at least one provider device 118 of a service provider, such as a mobile device (e.g. a smartphone or tablet).

Optionally, the vehicle assistance system 100 is communicatively coupled to a plurality of user devices 112 and a plurality of provider devices 118 to receive a request from one user device 112 and automatically send the request to at least one provider device 118 to directly notify the associated service provider. Optionally, the service user associated with the one user device and the service provider associated with the at least one provider device 118 may be directly connected to coordinate the provision of a vehicle service with one another.

Optionally, the vehicle assistance system 100 includes at least one server 122 having at least one processor 104 and/or at least one data storage device 108. The at least one server 122 may be provided to process and/or store information received from the at least one user device 112 and/or at least one provider device 118. The at least one server 122 may store one or more databases of information. The at least one server 122 may provide computational power to assist in processing the request. For example, the request may be routed to the at least one server 122, and the at least one processor 104 of the at least one server 122 may determine which provider device(s) 118 to provide the request to.

Components of the vehicle assistance system 100 may be communicatively coupled through one or more wireless or wired connections. As in the illustrated example, wireless connections 126 may be used, such as wireless local area network connections or a wireless wide area network connections.

The at least one processor 104 may be operable to connect the service user with the service provider. In some examples, the at least one processor 104 is operable to present information to and/or receive information from the service user and/or the service provider via one or more navigator style interfaces. A navigator style interface includes a program enabling the user to communicate with the at least one processor 104, and may include a program operable to generate one or more structured navigator pages, such as described further below.

In some examples, the at least one processor 104 is operable to prompt the service user to provide a user vehicle identifier to identify a vehicle of the service user. For example, the at least one processor 104 may be operable to provide a user sign-up navigator style interface to prompt the user to enter the user vehicle identifier. The user vehicle identifier may include one or more of a vehicle color, a vehicle make, a vehicle manufacturer, and a vehicle year of manufacture.

The at least one processor 104 may also be operable to prompt the service user for other user information. For example, the at least one processor 104 may prompt, via the user sign-up navigator or otherwise, the service user to provide a user name, a user address, and/or a set of user billing information.

The at least one processor 104 may be operable to receive the user vehicle identifier and/or other user information from the service user. Optionally, the at least one processor 104 is operable to store the user vehicle identifier and/or other user information, such as on the at least one data storage device 108. For example, the at least one processor 104 may be operable to generate a user profile including information about the service user (e.g. one or more of the user vehicle identifier, a user name, a user address, and a set of user billing information), and store the user profile on the at least one data storage device 108 for later use. Optionally, the user profile may be stored in a database, such as a database on the at least one server 122.

In some examples, the at least one processor 104 is also operable to collect information from a service provider. For example, the at least one processor 104 may be operable to provide a provider sign-up navigator style interface to the service provider. The user sign-up navigator style interface and the provider sign-up navigator style interface may be the same navigator style interface and/or the provider sign-up navigator style interface may be the same as or different from the user sign-up navigator style interface.

In some examples, the at least one processor 104 is operable to prompt, via the provider sign-up navigator interface, the service provider to provide a provider vehicle identifier to identify a vehicle of the service provider. The at least one processor 104 may also be operable to prompt, via the provider sign-up navigator interface, the service provider to provide one or more of a provider name, a provider address, and a set of provider billing information.

The at least one processor 104 may be operable to prompt the service provider (e.g. via the provider sign-up navigator interface) to indicate at least one service type (e.g. delivering fuel, changing a flat tire, or towing a vehicle) that the service provider is able to perform.

In some examples, the at least one processor 104 prompts the service provider for the indication of the at least one service type using a tiered prompt. A tiered prompt may set out at least two service classes, each service class including at least two services types, and requesting that the service provider to indicate at least one of the vehicle services. For example, the at least one processor 104 may present (e.g. via the provider sign-up navigator style interface) the service provider with a choice of at least two classes of roadside services, each of the at least two classes including at least two roadside service types, and receive from the service provider (e.g. via the provider sign-up navigator style interface) at least one class selection of the at least two classes and at least one service type selection of the at least two roadside service types. The at least one service type selection may include a user service selection, in which case the service provider may be eligible to be matched with the service user, as discussed further below.

The at least one processor 104 may be operable to prompt (e.g. via the provider sign-up navigator style interface) the service provider to provide a first piece of evidence of possession of a roadside service skill and/or a second piece of evidence of possession of a roadside service tool for performing the at least one service type selection. For example, a roadside service skill may be evidenced by a mechanic's license or a towing operator's license, while a roadside service tool may be evidenced by a photograph of a set of tools (e.g. a photograph of a gas container for delivering fuel or a photograph of a jack or set of wrenches for use in changing a flat tire).

Each service type may be associated with at least one service skill and at least one service tool. Optionally, the vehicle assistance system 100 provides at least two different service types (e.g. two different roadside service types), each associated with a different set of skills and a different set of tools. For example, the plurality of roadside service options may include a first roadside service associated with a first set of skills and tools and a second roadside service associated with a second set of skills and tools different from the first set of skills and tools.

The at least one processor 104 may be operable to receive the first piece of evidence and the second piece of evidence from the service provider. Optionally, the at least one processor 104 may be operable to store the first piece of evidence and the second piece of evidence, such as on the at least one data storage device 108. For example, the at least one processor 104 may be operable to generate a provider profile including information about the service provider (e.g. one or more of the first piece of evidence, the second piece of evidence, the indicated roadside service, the provider vehicle identifier, the provider name, the provider address, and the set of provider billing information), and store the user profile on the at least one data storage device 108 for later use. The provider profile may be stored in a database, such as a database on the at least one server 122.

In some examples, evidence provided by a service user may be reviewed by an administrator user. The administrator user may need to approve the service provider and/or the at least one service type selection of the service provider prior to the service provider being available to be matched to a service user and/or prior to the service provider being available to be matched to the service user for the at least one service type selection.

In some examples, the at least one processor 104 is operable to, provide the first piece of evidence and the second piece of evidence to the administrator user, such as via an administrator navigator style interface. The administrator navigator style interface and one or both of the provider sign-up navigator style interface or the user sign-up navigator style interface may be the same navigator style interface. The administrator navigator style interface may be the same as or different from one or both of the provider sign-up navigator style interface or the user sign-up navigator style interface.

The at least one processor 104 may be operable to receive a confirmation of eligibility from the administrator user, the confirmation of eligibility indicating that the service provider is eligible to provide the user service selection.

For example, the at least one processor 104 may receive a confirmation that the first piece of evidence and the second piece of evidence have been reviewed and accepted as genuine.

Once a service user and/or a service provider has signed up, their profile may be stored for use. To access the vehicle assistance system 100 one or both of the service user or service provider may need to sign in, and the associated profile may include sign in information such as a user name and password.

The at least one processor 104 may be operable to provide a user sign-in navigator style interface to the service user. The user sign-in navigator style interface may be the same navigator style interface as one of the other navigator style interfaces, and/or may be the same as or different from one or more of the other navigator style interfaces.

The user sign-in navigator style interface may prompt the service user to provide sign-in credentials, such as credentials established via the user sign-up navigator style interface and stored in the user profile. Once the service user is verified via the user sign-in navigator style interface, the service user may be able to be matched to a service provider for the provision of a vehicle service.

Similarly, the at least one processor 104 may be operable to provide a provider sign-in navigator style interface to the service provider. The provider sign-in navigator style interface may be the same navigator style interface as one of the other navigator style interfaces, and/or may be the same as or different from one or more of the other navigator style interfaces.

The provider sign-in navigator style interface may prompt the service provider to provide sign-in credentials, such as credentials established via the provider sign-up navigator style interface and stored in the provider profile. Once the service provider is verified via the provider sign-in navigator style interface, the service provider may be able to be matched to a service user for the provision of a vehicle service.

Matching a service user and a service provider may include receiving a user service selection from the service user and matching the user service selection to the service provider.

The at least one processor 104 may be operable to present a plurality of vehicle service options to the service user. The at least one processor 104 may be operable to present the plurality of vehicle service options via a service request navigator style interface. The service request navigator style interface may be the same navigator style interface as one of the other navigator style interfaces, and/or may be the same as or different from one or more of the other navigator style interfaces. The plurality of vehicle service options may include a plurality of roadside service options includes a battery boost service, a vehicle unlock service, a tire change service, a towing service, and a fluid top up service.

The at least one processor 104 may be operable to receive a user service selection of the plurality of vehicle service options from the service user (e.g. via the service request navigator style interface).

To match the service user to a service provider the vehicle assistance system 100 may need information about the service user. The at least one processor 104 may be operable to receive a user location of the service user. The user location may be provided by the service user (e.g. entered manually via the service request navigator style interface) and/or provided automatically by the user device 112 associated with the service user. The at least one processor 104 may be operable to access the at least one data storage device to retrieve the user profile associated with the service user, the user profile including the user vehicle identifier to identify the vehicle of the service user.

The at least one processor 104 may be operable to match the user service selection to a service provider. Matching the user service selection to a service provider may involve using stored information about the service provider, such as information regarding whether the service provider has a skill and/or tool needed to provide the user service selection. For example, if the user service selection is a battery boost service, the service provider may need to have booster cables.

The at least one processor 104 may be operable to access the at least one data storage device to retrieve a provider profile of a service provider, the provider profile including a confirmation that the service provider possesses a roadside service skill and a roadside service tool for performing the user service selection.

The at least one processor 104 may be operable to provide the service provider matched to the user service selection with the user service selection, the user vehicle identifier, and the user location. The at least one processor 104 may be operable to provide this information via a service response navigator style interface. The service response navigator style interface may be the same navigator style interface as one of the other navigator style interfaces, and/or may be the same as or different from one or more of the other navigator style interfaces.

In some examples, the at least one processor 104 sends a notification to a plurality of service provider devices 118, such as to all service provider devices 118 in the network or to all service provider devices 118 in the network that are within a geographic area and/or all service provider devices 118 that are associated with a status indicating that the service provider is available. In some examples, the notification includes the user service selection, the user vehicle identifier, and the user location, and in some examples, the notification includes a subset of this information with the rest of the information provided if the task is accepted. In some examples, the notification is maintained until the task is accepted from one of the service provider devices 118, and then the notification is removed from all the remaining service provider devices 118.

The at least one processor 104 may be operable to provide the service user with information about the matched service provider. For example, the at least one processor 104 may be operable to provide the provider vehicle identifier to the service user and/or other information from the service provider profile.

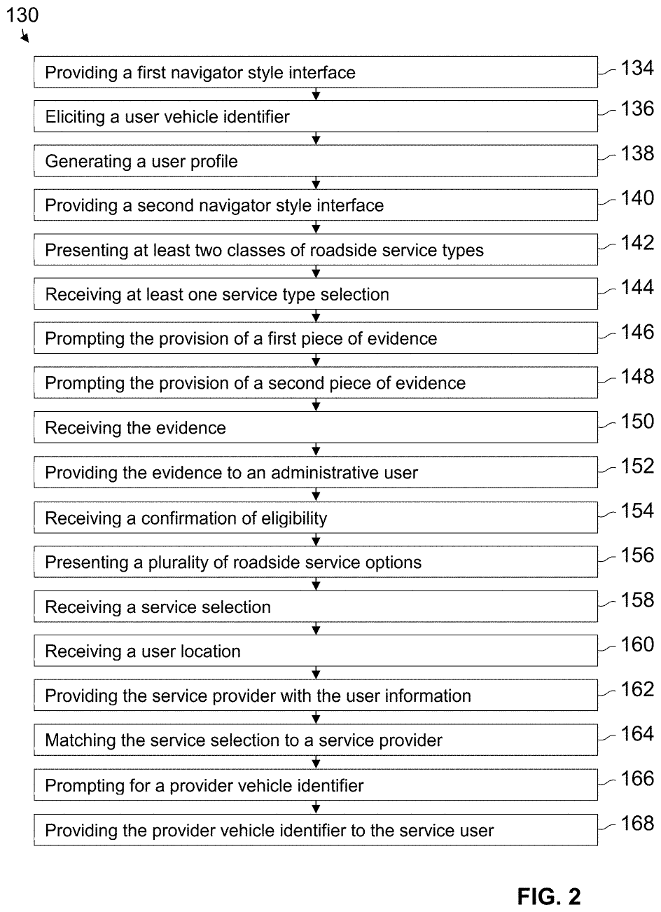

Referring now to FIG. 2, illustrated is a method 130 of providing roadside assistance. The method 130 includes, at step 134, providing a service user with a first navigator style interface for walking the user through a user profile creation process.

At step 136 the method 130 includes eliciting from the service user, via the first navigator style interface, at least one user vehicle identifier for identifying a user vehicle of the service user. At step 138 the method includes generating a user profile, the user profile including the at least one user vehicle identifier.

The method 130 may also include, at step 140, providing a second navigator style interface to the service provider. The method 130 may include, at step 142, presenting, via the second navigator style interface, the service provider with a choice of at least two classes of roadside services, each of the at least two classes including at least two roadside service types. At step 144 the method includes receiving from the service provider, via the second navigator style interface, at least one class selection of the at least two classes and at least one service type selection of the at least two roadside service types, the at least one service type selection including a user service selection.

Optionally, at step 146, the method may include prompting, via the second navigator style interface, the service provider to provide a first piece of evidence of possession of a roadside service skill for performing the user service selection. At step 148 the method 130 may include prompting, via the second navigator style interface, the service provider to provide a second piece of evidence of possession of a roadside service tool for performing the user service selection. Then, at step 150 the method 130 may include receiving the first piece of evidence and the second piece of evidence from the service provider.

Optionally, the method 130 may also include, at step 152, providing the first piece of evidence and the second piece of evidence to an administrator user, and, at step 154 receiving a confirmation of eligibility from the administrator user, the confirmation of eligibility indicating that the service provider is eligible to provide the user service selection.

At step 156 the method 130 includes presenting the service user with a plurality of roadside service options each directed to a different type of roadside assistance. At step 158 the method 130 includes receiving from the service user the user service selection of the plurality of roadside service options. Step 160 includes receiving a user location of the service user.

Step 162 includes matching the user service selection to a service provider. Step 164 includes providing the service provider with the user service selection, the user vehicle identifier, and the user location.

The method 130 may also include, at step 166, prompting, via the second navigator interface, the service provider to provide a provider vehicle identifier to identify a vehicle of the service provider, and, at step 168, providing the provider vehicle identifier to the service user.

A roadside assistance system may be provided for a service user who finds themselves stranded roadside and in need of a fluid service (e.g. a gas top up), a battery service (e.g. a boost), a lock service (e.g. reentering a vehicle when locked out), a towing service, a quick repair, or a tire change after their vehicle has broken down or stopped.. A service provider may be an individual skilled in vehicle repair and providing roadside assistance, and may need to be connected to a service user.

A roadside assistance system may add to or replace existing towing or roadside assistance models. Existing towing and roadside assistance models may be inadequate. Many roadside assistance models include membership in an automobile association. Emergency roadside assistance services provided to automobile association members (i.e. service users) in exchange for annual membership fees may require service users to wait unduly long by the side of the road. Indeed, for many service users it be quicker to get a jump start from a neighbor or from another member of the community. Yet, for peace of mind, service users often pay annual membership fees for membership in automobile associations.

Further, many automobile associations contract with automotive fleets and private local towing companies to provide emergency roadside assistance services for members of the automobile associations. This extra layer of relationships may add an undue level of complexity, and may contribute to roadside tensions between drivers of stranded cars and tow truck operators due to billing uncertainties.

A roadside assistance system may be operable to locating a vehicle. For example, global positioning systems (GPS) are available for vehicles, such as tow trucks. In another example, the LoJack™ stolen vehicle recovery system (offered by CalAmp Corp. of Irvine, Calif.) may enable vehicles and equipment to be tracked and recovered. Geolocation, vehicle tracking, distance logging, etc. may be available, such as through various software applications (or “apps”).

In some examples, a roadside assistance system incorporates accepts of a gig economy model; characterized by short-term contracts and freelance work, often with last-minute scheduling. In non-analogous prior art, ride-sharing apps and platforms—e.g., the Uber™ platform offered by Uber Technologies, Inc. and the Lyft™ platform offered by Lyft, Inc. (both of San Francisco, Calif.)—are examples of gig economy models. The roadside assistance system may replace traditional dispatch systems, and reduce the need for tow trucks to idle roadside and on highway on-ramps waiting for a call. The roadside assistance system may facilitate going without membership-based roadside protection services. The roadside assistance system may facilitate immediate and communicative service from service providers. The roadside assistance system may allow service users to pay for the services they need, when they need them, at a price that fits their needs.

The roadside assistance system may match and connect those in need of emergency roadside assistance, with others nearby in their community offering such assistance, using an efficient online pay-per-use model. The roadside assistance system may provide community-based online emergency roadside assistance. The roadside assistance system may mobilize community-based rescuers (i.e. service providers) as partners to service users, and may be delivered as a mobile application-based service. The roadside assistance system may notify service users in need of roadside rescue and assistance when a rescuer (i.e. service provider) has accepted their request and/or is en route.

The roadside assistance system may be delivered as a consumer-based smartphone app and/or web platform, and/or may enable users in need of simple roadside assistance and/or vehicle transportation services to sign up and/or connect with those who can help keep them moving.

The roadside assistance system may have a simple sign-up user interface and experience. The roadside assistance system may be adapted for use on Android™ and Apple™ smartphones. The roadside assistance system may enable users to readily connect to the app when they need help and/or when they can provide help, such as by accessing a service provider app to provide a service or a service user app to request a service.

The roadside assistance system may enable a service provider to answer a service call originating from anywhere within a predetermined geographic area. The roadside assistance system may enable a service provider to, in transit and/or prior thereto, communicate directly with the individuals in need (i.e. service user). In some examples, the roadside assistance system is operable to allow a service provider to communicate with a service user and/or vice versa via automated and/or (voice dictation and/or other) non-automated text and/or short message service (SMS) messages. The roadside assistance system may be operable to allow a service user to pay for emergency roadside assistance services via and/or directly in the app.

The roadside assistance system may enable individuals (i.e. service users) to request a roadside rescue. Optionally, after a nearby rescuer-partner (i.e. service provider) accepts the request, the roadside assistance system displays an estimated time of arrival for the rescuer-partner heading to the service user's location. The roadside assistance system may notify the service user when the rescuer-partner is about to arrive. The app also preferably provides the service user with information about the service provider who will provide the rescue services, such as including first name, vehicle type, and license plate number. This information may help the two connect at the rescue service location.

The roadside assistance system may enable entry of a user location anytime before the rescuer arrives. If the service user needs a preferred or specific roadside service, the service user can use the app to talk through this information with the rescuer en route. Preferably, after the rescuer arrives and completes the requested roadside service, the transaction ends, such as when the service provider indicates using their device that the service is complete. Fees for the roadside service are preferably automatically calculated and charged to the payment method linked to the service user's account in the app.

Optionally, substantially immediately after a transaction ends, the app will ask the service user to rate the rescuer and/or the rescuer's roadside service (e.g. on a scale from 1 to 5 stars). Service providers may also be asked to rate service users. This rating and feedback may foster a community of respect and accountability.

In some examples, to become a service provider, the service provider preferably starts by downloading a mobile device app, and filling out information about themselves (e.g., preferably including their social security number and/or social insurance number, for a simple background check) and their vehicle.

Service providers may be required to have a valid provincial and/or state driver's license. Service providers may need to be properly insured. In some examples, service providers need to pass a background check and/or a criminal history check prior to being available to be matched to a service user.

In some examples, a minor offence such as a speeding ticket is acceptable while a more significant offence such as a drunk driving offence will result in a service provider being disqualified. In some examples, a service provider is still able to provide a subset of the plurality of possible service types; for example, a service provider who has been charged and/or convicted of a drunk driving offence may be eligible to provide a fuel top up service but not a towing service. In some examples, the subset of the plurality of possible service types is a class of a plurality of classes of services each including at least two service types.

In some examples, service providers must be at least a certain minimum age (e.g. at least 21 years old). In some examples, service providers must have at least three years of driving experience if they are 23 years old or under, and/or at least one year of driving experience if they are 24 or older.

Other requirements may apply to the rescuer's car. In some examples, service providers must own a vehicle no older than a certain predetermined age (e.g. less than 10 years old) and/or a vehicle that has not been salvaged. In some examples, service providers can be approved for certain service types such as fuel top ups even if they do not meet minimum age and/or equipment levels required to be approved to provide other services. In some examples, service providers must have a vehicle that is insured and registered, and has passed a vehicle inspection (e.g. an inspection of basic items such as brakes, tires, lights, and seat belts).

In some examples, service providers may submit evidence of meeting one or more requirement (e.g. via a navigator style interface), such as photos and/or other proof of a driver's license, an insurance policy, a vehicle registration, work eligibility, or a vehicle inspection certificate. In some examples, service providers may be approved to be matched to a service user once the evidence has been reviewed and accepted (e.g. by an administrator user using a navigator style interface).

In some examples, service providers may log in and selectively indicate they are available to receive notifications from service users who need roadside assistance. In some examples, service providers can decide how many hours to work, and the amount of money made may depend on how much a service provider operates and when the service provider operates.

In some examples, service providers are not employed by the vehicle assistance system or by a party operating the vehicle assistance system. For example, service providers may be independent contractors. Consumables such as gasoline, vehicle maintenance (e.g., tires, oil changes, etc), and depreciation on service provider vehicles may be paid or covered by the service providers themselves. Service providers may keep about 75 percent of a payment from a service user for each transaction. The party operating the vehicle assistance system may retain the remainder (e.g., about 25 percent).

In some examples, service providers use mobile data on a mobile device. In some examples, the vehicle assistance system requires between about 1 GB and 2 GB of data per month from a service provider mobile device. In some examples, service providers may at least some use of the vehicle assistance system even if they do not have access to the Internet or a wireless mobile device signal from their wireless service provider.

In some examples, service users download a mobile device app on an Android™ or Apple™ device and provide their basic information (e.g. their name, phone number, and credit card number).

In some examples, after everything has been set up, when the service user needs roadside assistance, the service user may be required to enter and/or confirm a rescue address in a box in the app that may be labeled “Rescue Me?” near the top of the screen.

The service user may be asked to confirm the rescue and the type of rescue service required, and to confirm a substantially precise rescue point (e.g., by dropping a blue pin) on the map. The app may tell the service user approximately how long it will take for the service provider to get there.

The app may provide an estimated cost of each rescue service (e.g., well before the service provider's arrival) to ensure transparency. The cost of the rescue may depend, among other things, on which rescue service is required. A basic class of vehicle services (e.g. roadside rescue services) may include Fluid Services, Battery Boosts, Tire Services, Simple Repairs, and Unlocking Services. Each of the service types of the basic class of roadside rescue services may be broken down into one or more different subservices. For example, Fluid Services may include one or more of the following: fuel delivery, oil delivery, windshield washer/antifreeze fluid delivery, transmission fluid delivery, and/or radiator coolant fluid delivery. Different roadside rescue services may have different prices. A second class of vehicle services may include towing, vehicle transportation services, and/or trailer vehicle transportation services.

In some examples, service providers and/or service users are provided, via one or more navigator style interfaces, with information regarding their own past interaction with the vehicle assistance system, such as rescues and payments they receive from within the app. In some examples, a service provider can request a payment, track past interaction with the vehicle assistance system, and communicate with a service user and/or other service provider, all from within the app and from within the rescuer's account. In some examples, a service provider can provide an update to the vehicle assistance system, such as by adding information about an additional skill or tool from within the app. For example, if a rescuer acquires a trailer or can provide vehicle transportation, the rescuer can simply and easily add this information to their profile.

In some examples, service users can benefit from comprehensive promotion and/or coupon engines within the platform. The vehicle assistance system may promote the roadside assistance services provided by service providers via the app, preferably through comprehensive and substantially continuous promotion and coupon engines within the vehicle assistance system. These engines preferably help grow the app's base of service providers and service users who may need roadside rescue. In some examples, service providers can reply to comments, such as compliments, directly from within the app. The vehicle assistance system may enable communication between service users, service providers, and/or administrator users, including via ratings, compliments, and complaints. In some examples, the vehicle assistance system enables one or more administrator user to monitor interactions conducted via the app.

The vehicle assistance system may be operable to allow service users to make in-app payments and make payments only for services rendered, rather than for a subscription or membership. In some examples, service users are offered one or more incentives (e.g., in the form of savings and/or credits on roadside assistance) to help promote the vehicle assistance system. The vehicle assistance system may promote its roadside assistance services and/or provide service users with opportunities to help with promotions, ratings, and more, all from within the app itself.

In some examples, a system or method may include end to end encryption. The system or method may include end to end encryption even if payment is handled by a third party through the system or method.

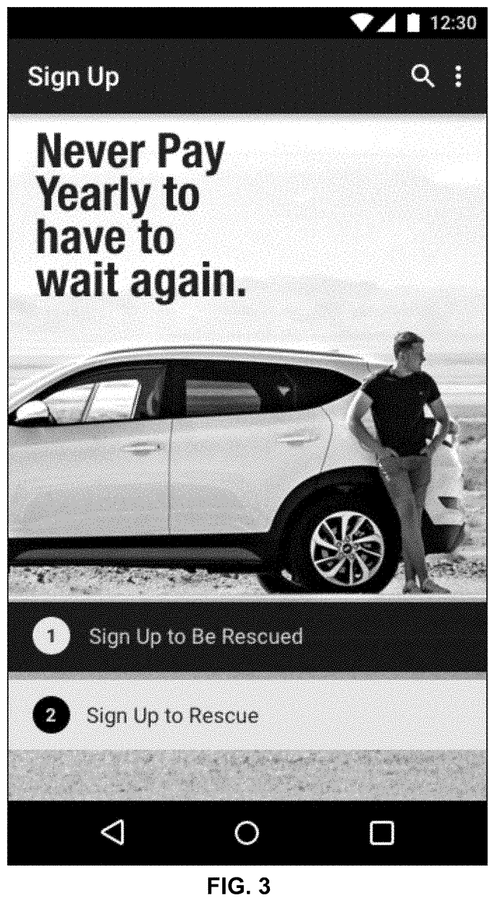

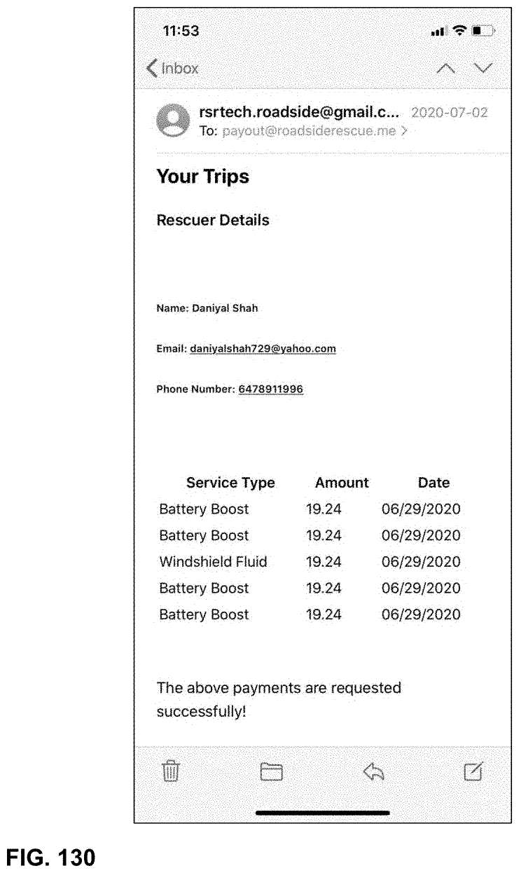

Referring now to FIGS. 3 to 130, illustrated are examples of pages generated by one or more navigator style interface of an example vehicle assistance system 100.

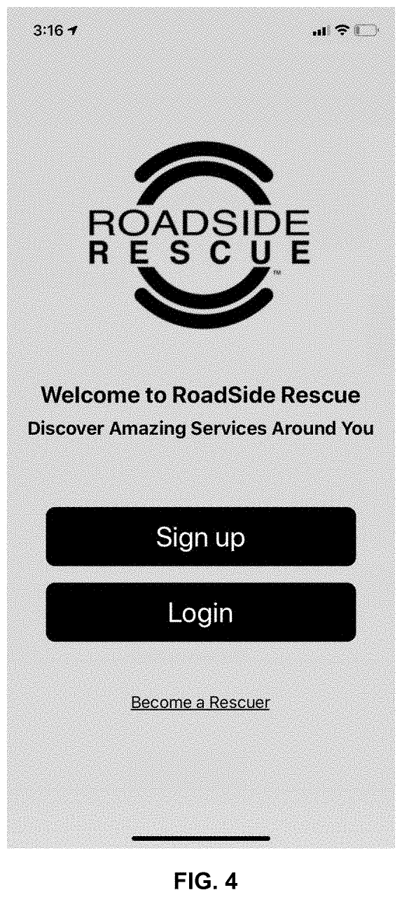

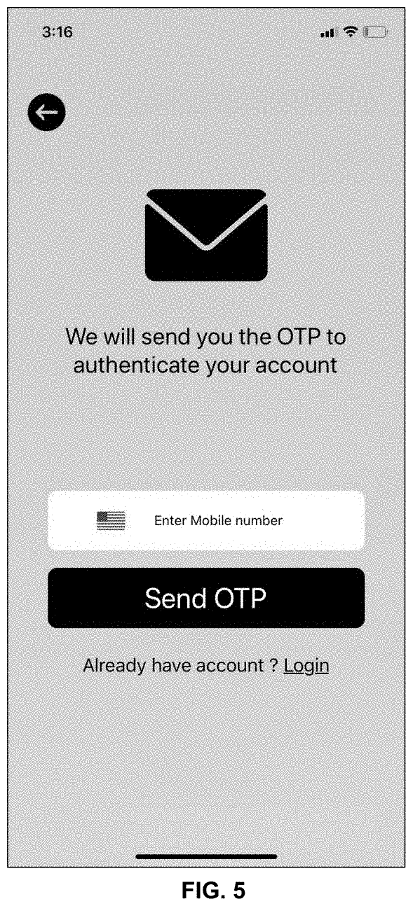

A home page may be provided to allow an individual to sign up or sign in as a service user or service provider. FIG. 3 depicts an example home/loading page that enables an individual to sign up as a service user or service provider and/or sign in as a service user or service provider. The home page of FIG. 3 may be displayed on a device when first starting the end-user app. FIG. 4 shows an alternative example home page. FIG. 5 depicts a page asking the service user to provide a mobile number for use in generating a one time password.

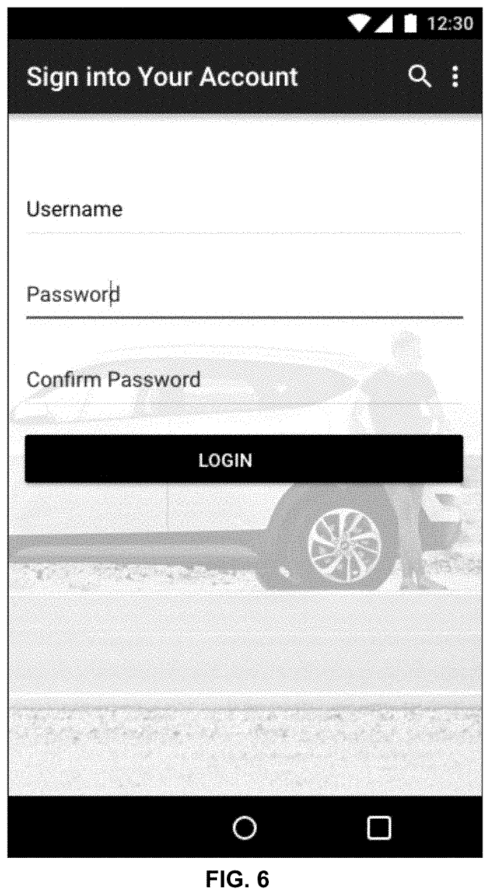

FIG. 6 depicts an example sign-in page for those who have already signed-up for an account on the platform or app.

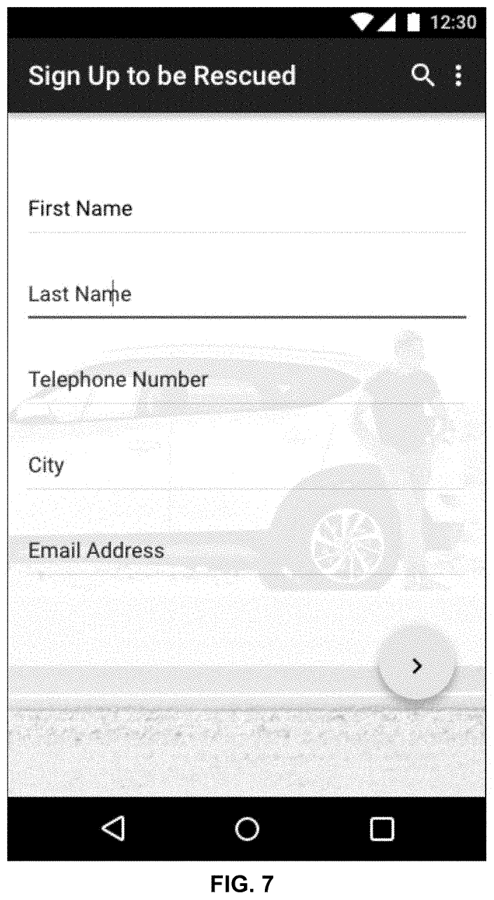

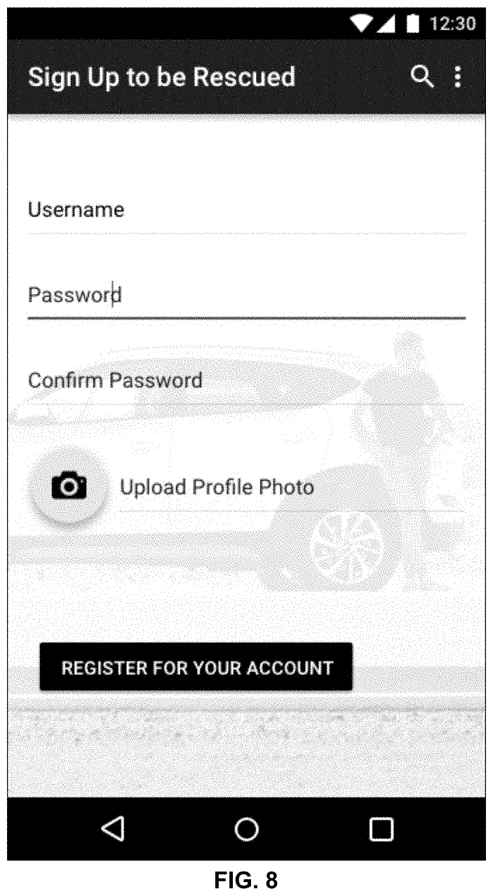

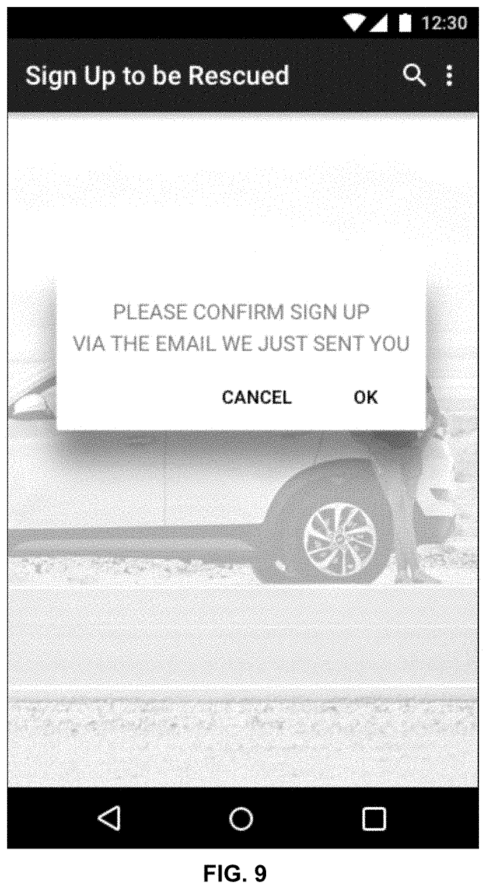

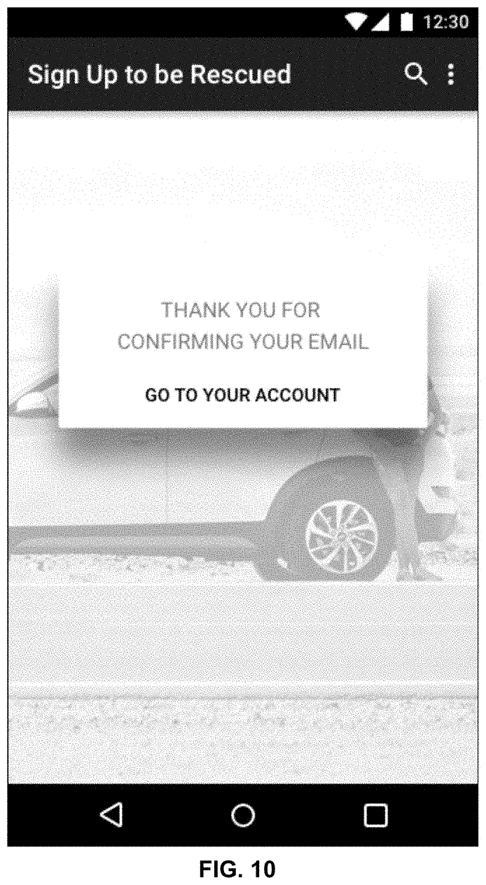

A service user signing up for an account may be presented with one or more pages prompting the user for personal and vehicle information. FIGS. 6 to 9 show example pages generated by a first user sign up navigator style interface. FIG. 7 shows a first page asking for a name, phone number, street address, and email address. FIG. 8 shows a second sign up page asking for a username, password, and profile photo. FIG. 9 shows a third sign up page asking the service user to confirm sign up. FIG. 10 shows a forth sign up page asking notifying the service user that confirmation has been received.

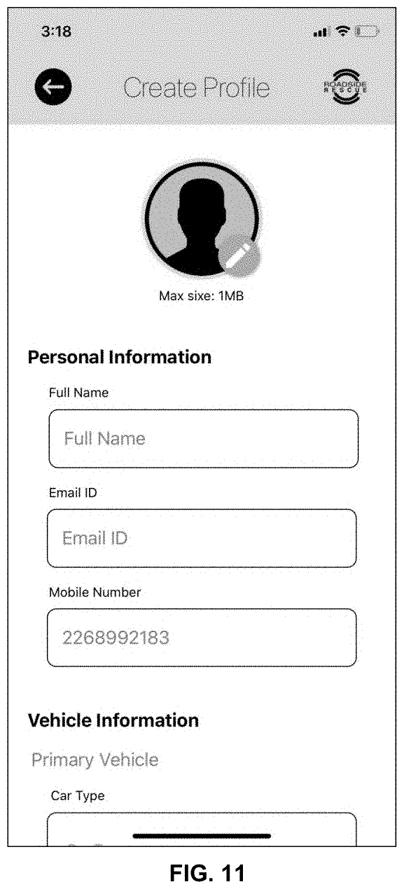

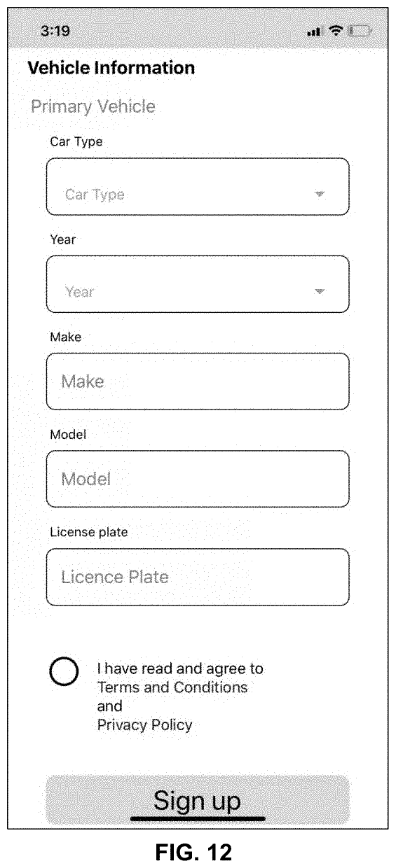

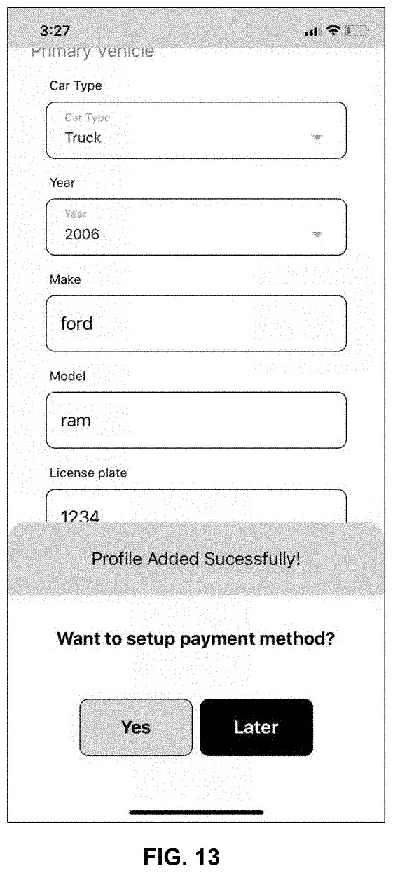

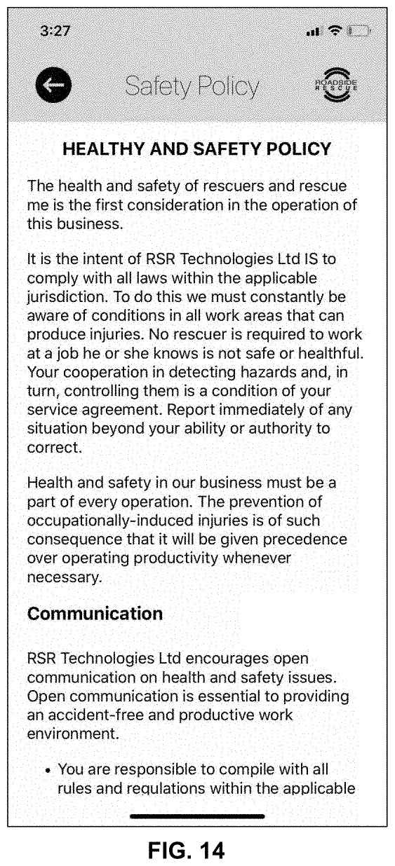

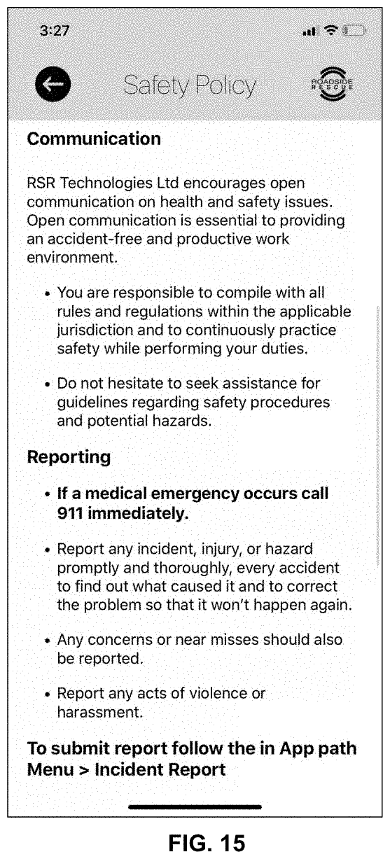

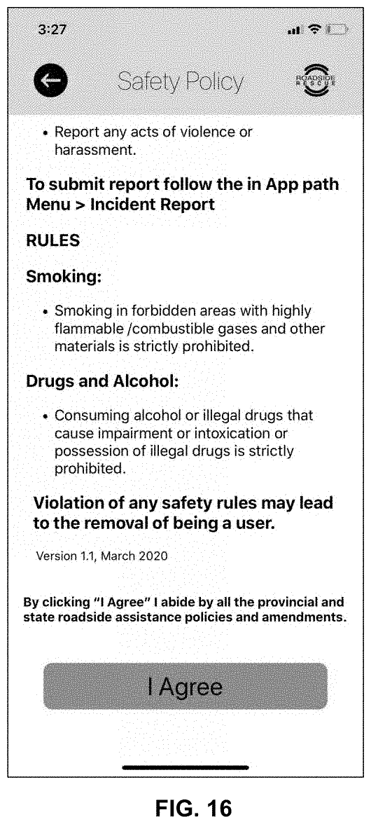

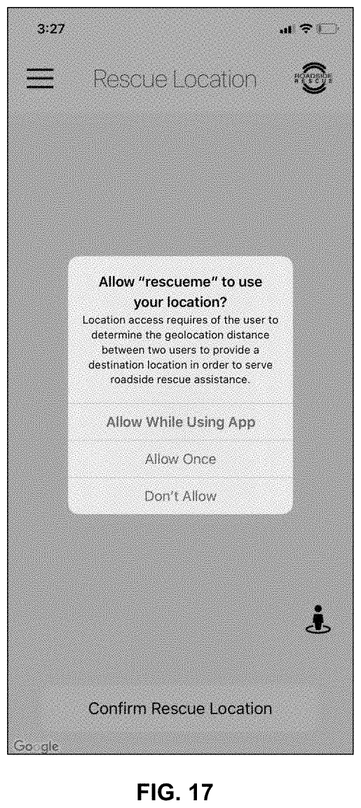

FIGS. 11 to 17 show pages generated by a second example user sign up navigator style interface. FIG. 11 shows a first sign up page e, asking for user personal information. FIG. 12 shows a second sign up page asking for user vehicle information. FIG. 13 shows a third sign up page asking if the user would like to set up a payment method. FIGS. 14 to 16 show a fourth sign up page asking the user to accept a safety policy. FIG. 17 shows a fifth sign up page asking the user to allow the vehicle assistance system to use location information generated by the user's mobile device.

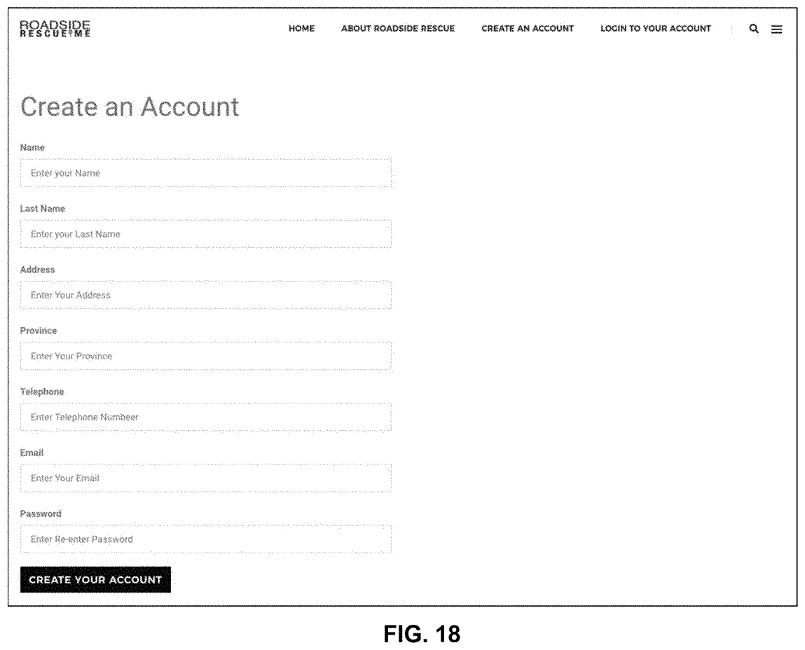

FIG. 18 shows a first sign up page generated by a third, alternative example service user sign up navigator style interface, asking for user information. The third service user sign up navigator style interface generates web-based pages rather than mobile application pages.

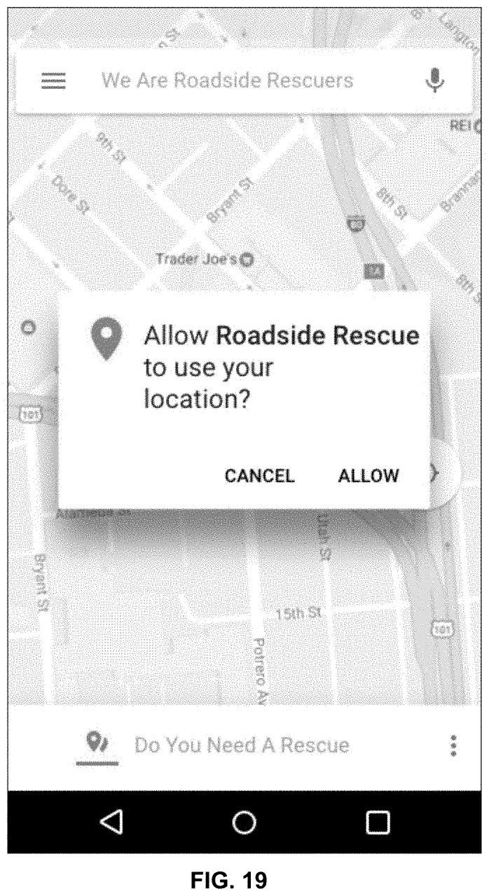

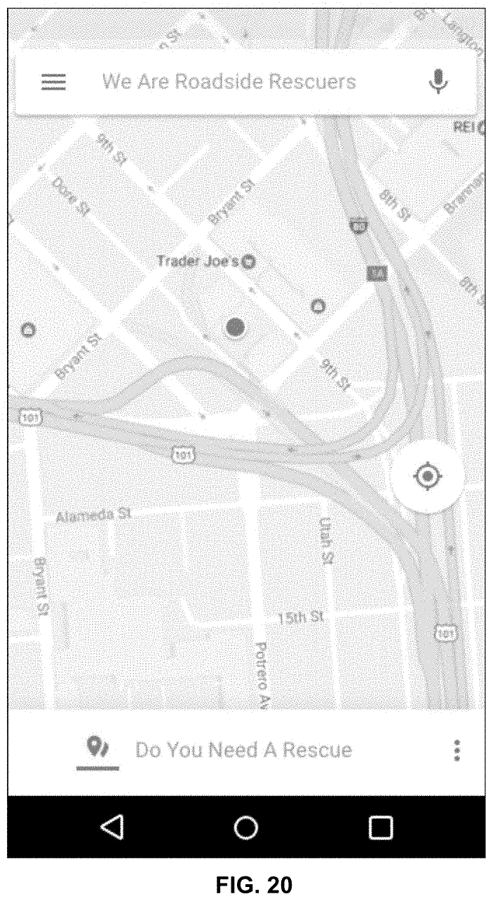

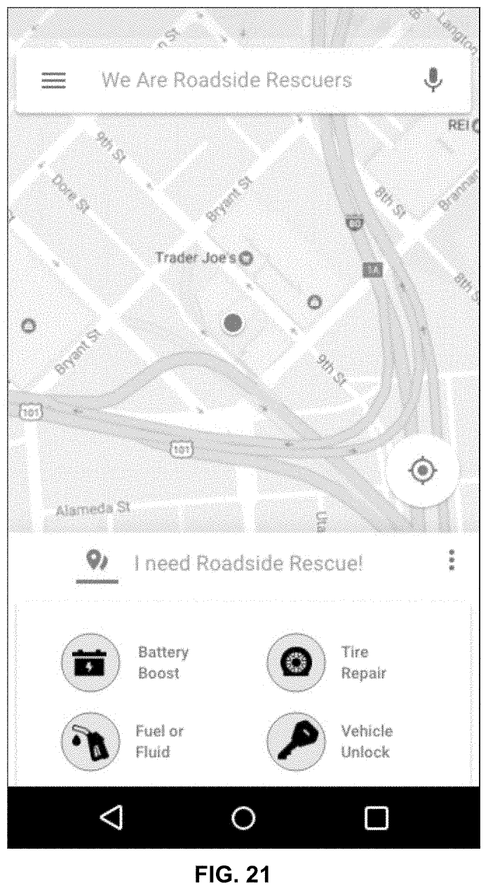

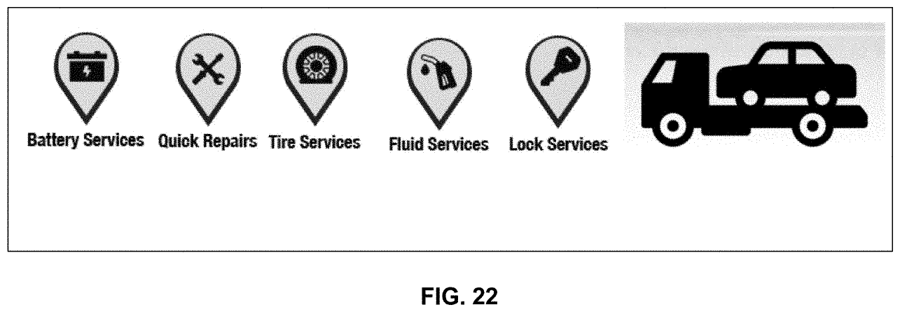

A service user who is signed in may be able to request a service. FIGS. 19 to 32 show pages generated by a first example service request navigator style interface. FIG. 19 shows a first page asking the service user for permission to use the service user's mobile device location (such as determined by the mobile device's GPS or other location services). FIG. 20 shows a second page depicting a location display identifying the service user's location. FIG. 21 shows a third page depicting a roadside assistance services menu showing a plurality of roadside service options. FIG. 22 is a fourth page showing another plurality of roadside assistance service options.

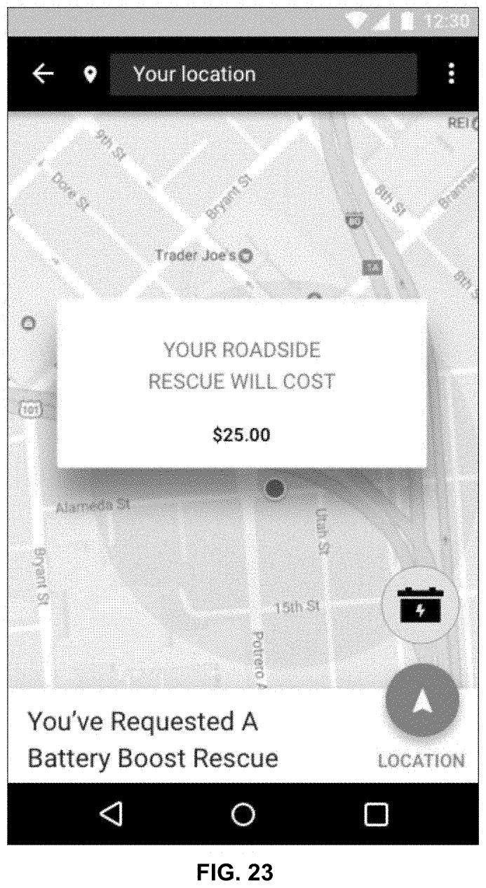

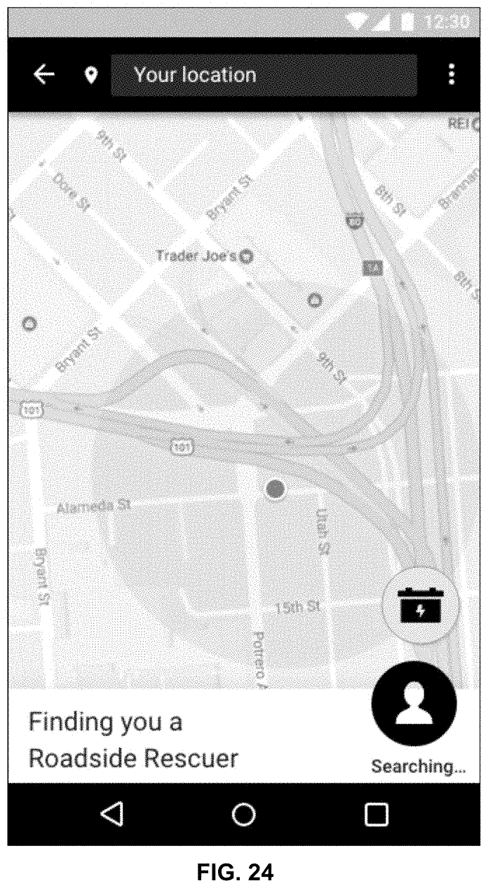

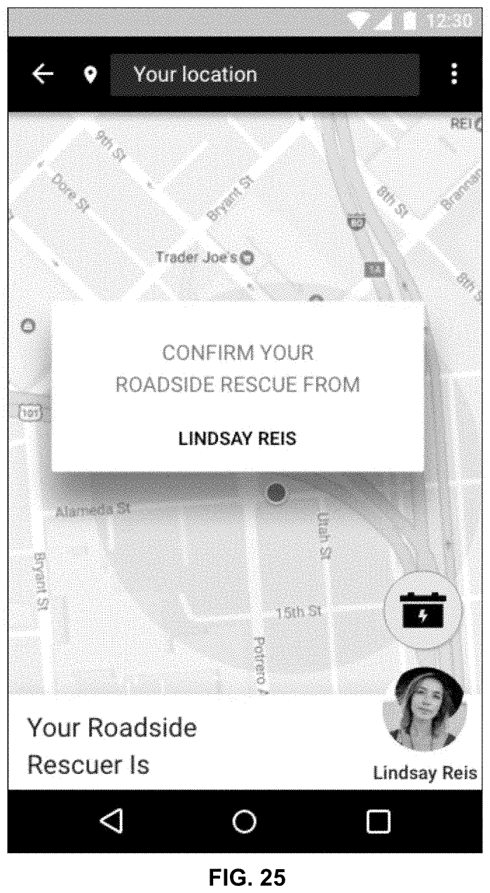

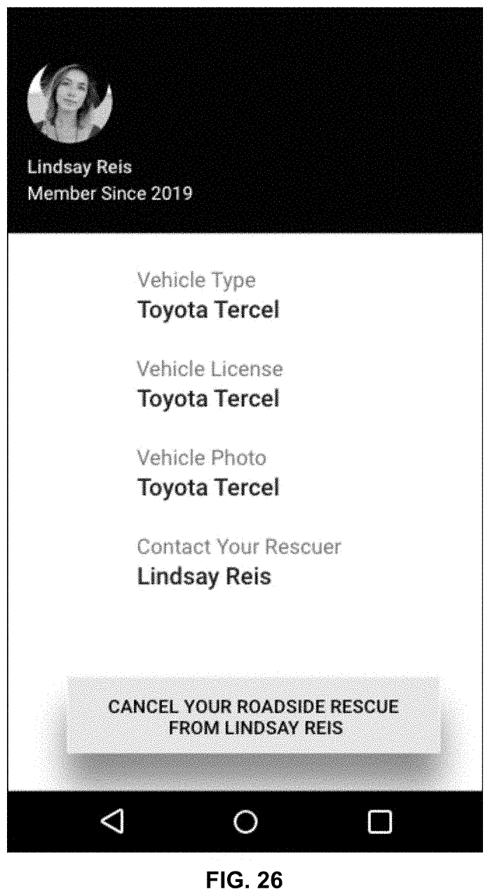

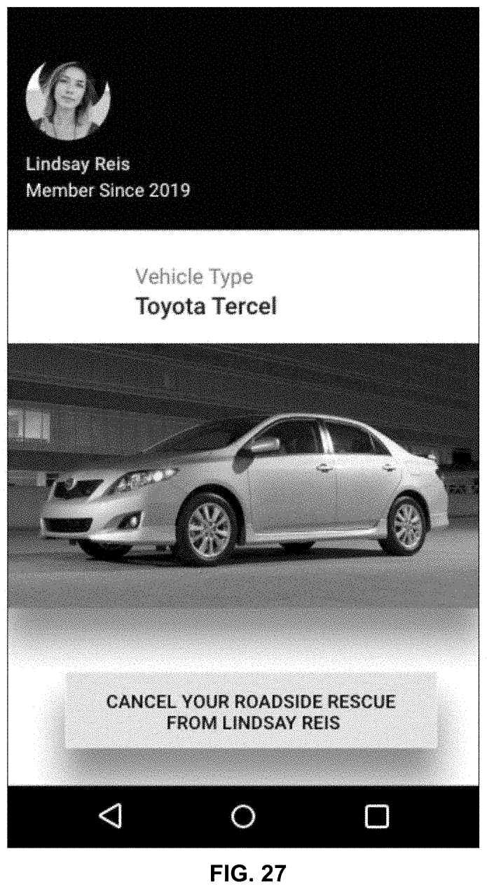

FIG. 23 is a fifth page showing a roadside service provider request that is underway. Specifically, the fifth page shows a cost of the request. In some examples, after the roadside assistance service type has been selected, the vehicle assistance system starts a search for nearby available service providers. FIG. 24 is a sixth page showing that a search is underway. The vehicle assistance system may search for the nearest available service provider suited to provide the requested service type. FIG. 25 is a seventh page presenting a selected service provider and prompting the service user to confirm that they are willing to have the request sent to the selected service provider. In some examples, after the service user has confirmed, the service user can view the service provider's profile and/or contact them directly using an eighth page as shown in FIG. 26. A ninth page is show in FIG. 27, displaying information about the service provider's vehicle.

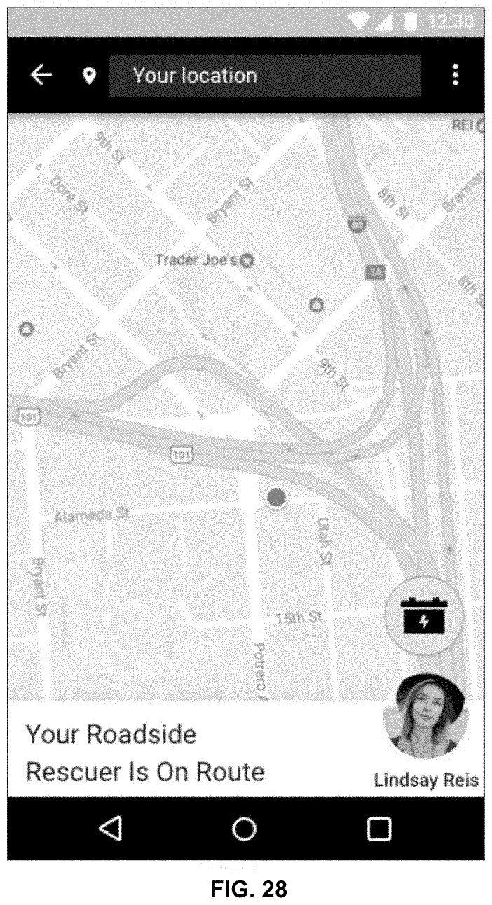

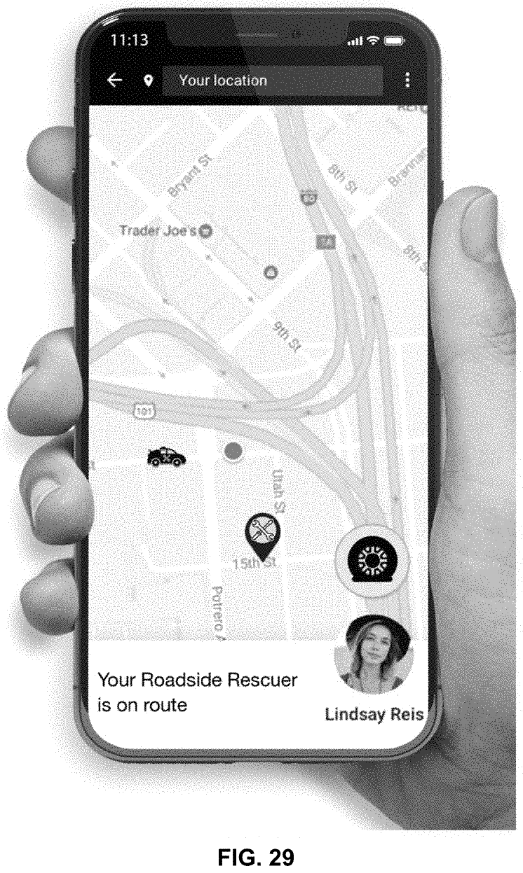

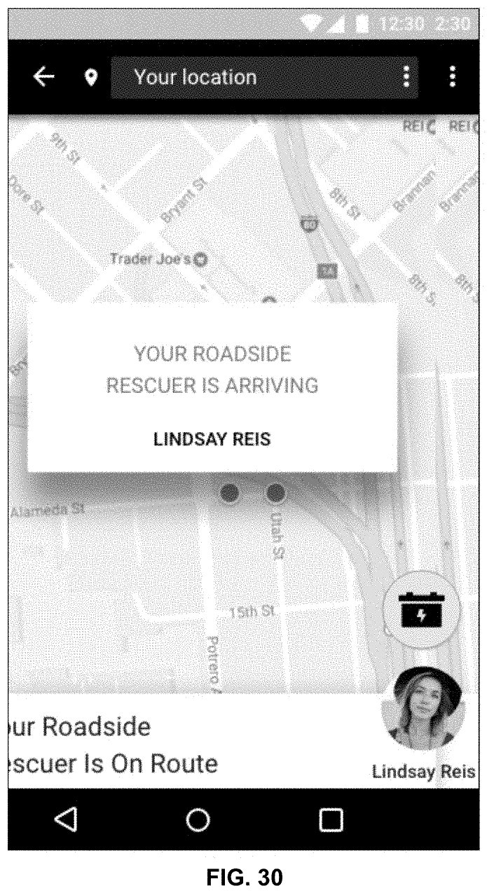

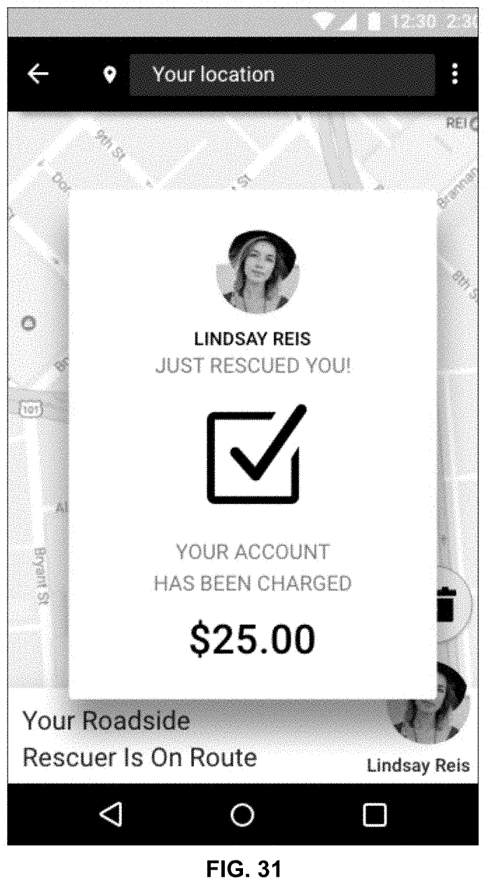

FIG. 28 shows a notification page informing the service user that the service provider is on the way. FIG. 29 shows a tenth page displaying the position of the selected service provider to enable the service user to track the service provider's progress towards the service location. In some examples, as the service provider arrives, the vehicle assistance system presents a service provider arriving notification to the service user, as shown in the page of FIG. 30. After the service provider finishes the rescue, the vehicle assistance system may presents a completion and price notification as shown in the page of FIG. 31.

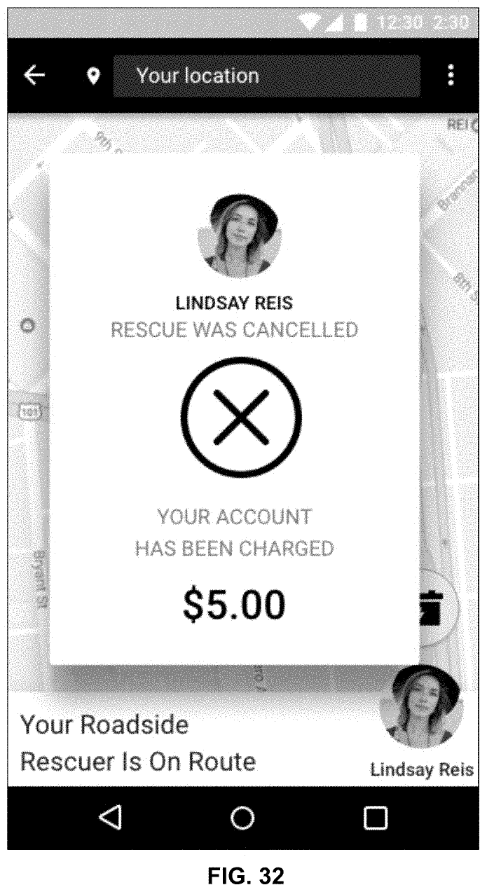

The service provider profile page shown in FIG. 26 may also enable the service user to cancel the forthcoming rescue from the assigned service provider. If the service user cancels the rescue operation, the vehicle assistance system may present a confirmation and charge notification as shown in the page of FIG. 32.

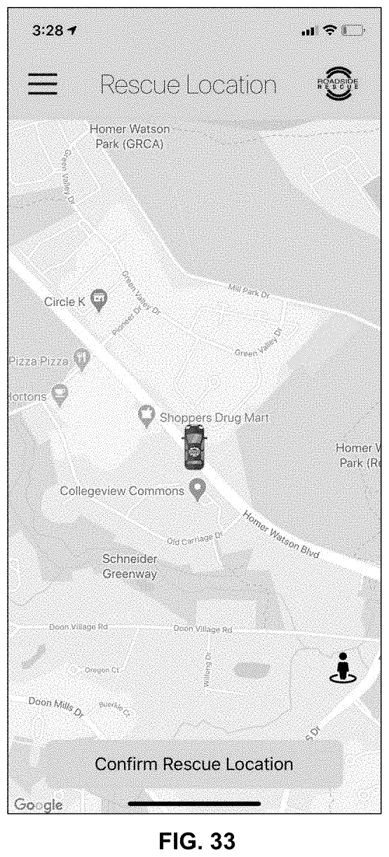

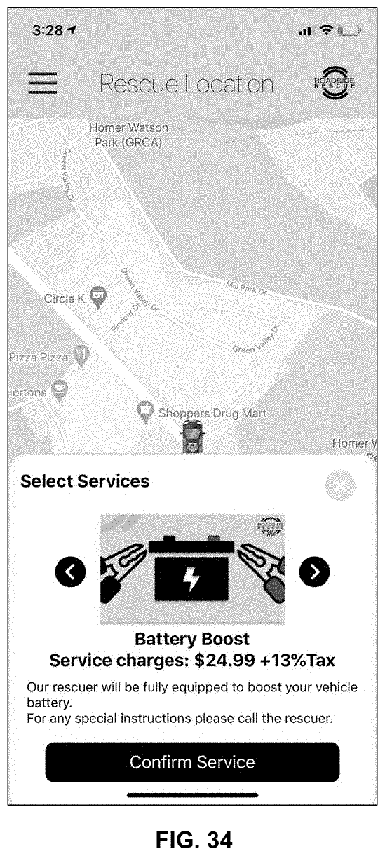

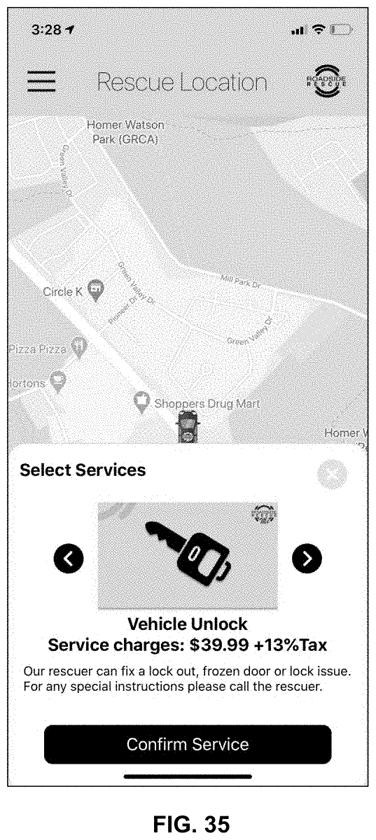

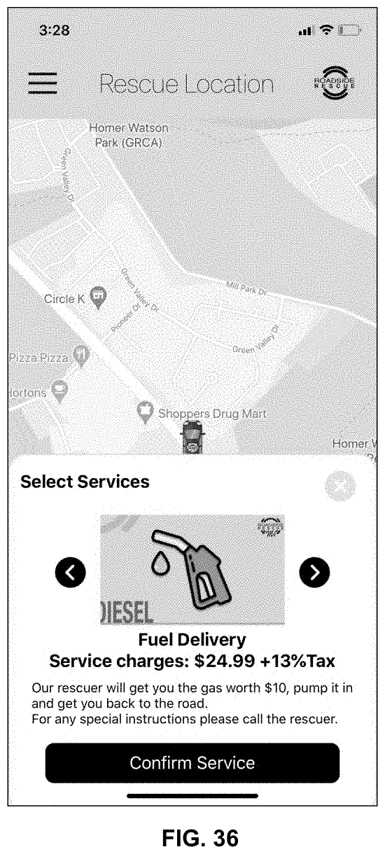

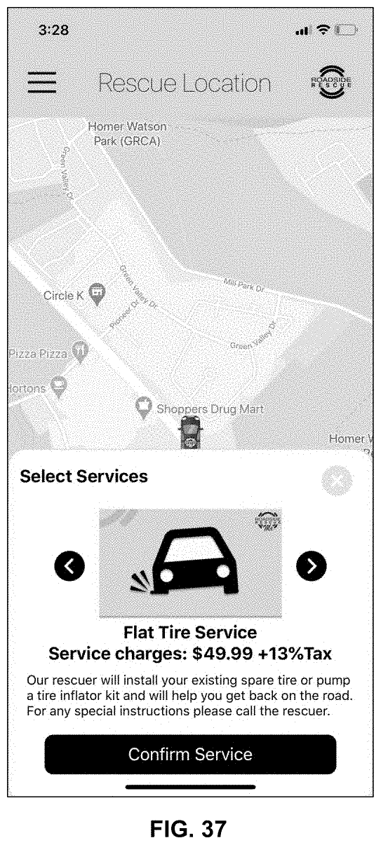

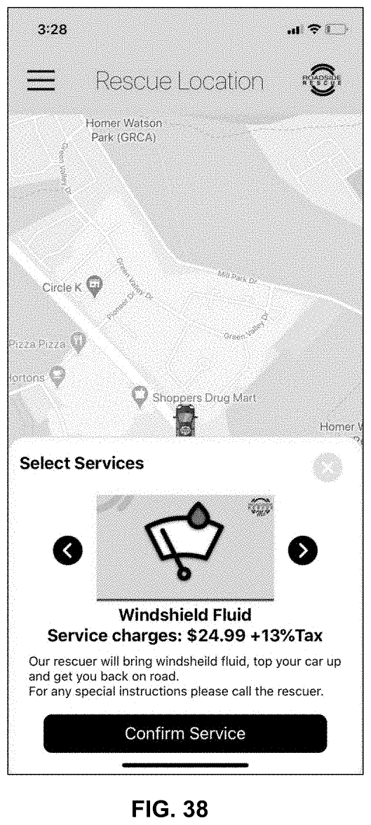

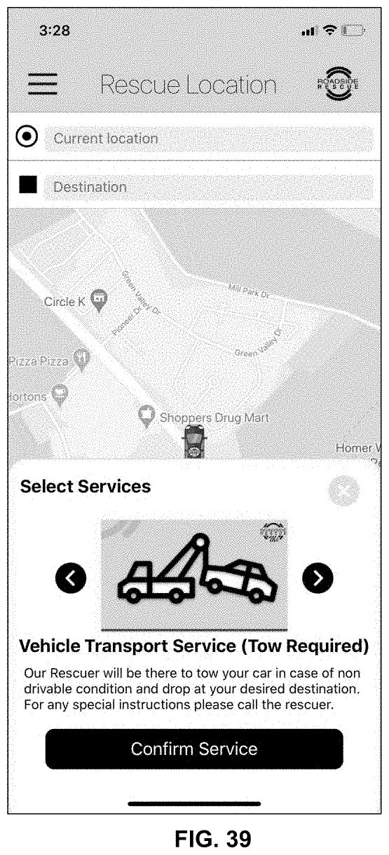

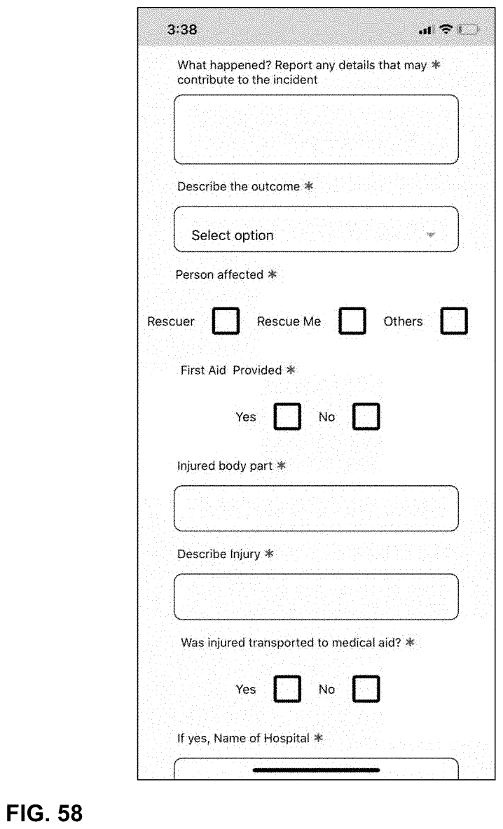

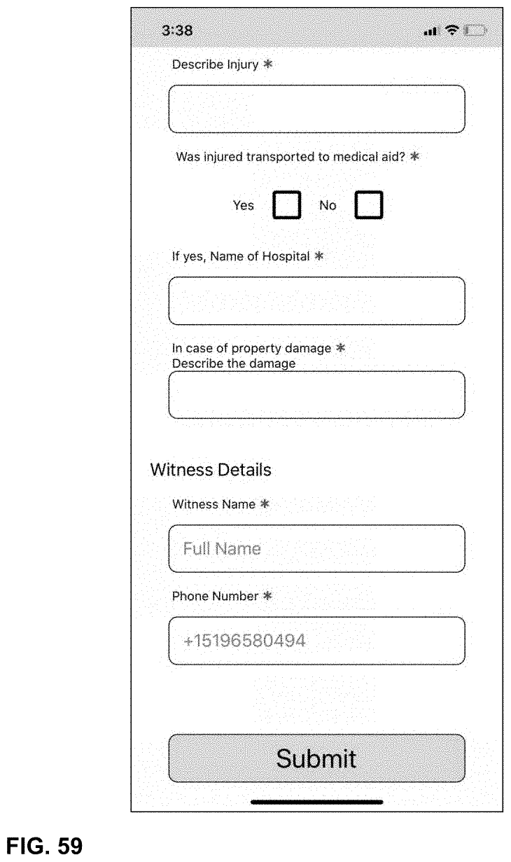

FIGS. 33 to 59 depict pages generated by a second example service request navigator style interface. FIG. 33 shows a map page identifying a location at which a service is to be performed. FIG. 34 shows a page detailing a roadside service option. FIG. 35 shows a page detailing another roadside service option. FIG. 36 shows a page detailing another roadside service option. FIG. 37 shows a page detailing another roadside service option. FIG. 38 shows a page detailing another roadside service option. FIG. 39 shows a page detailing another roadside service option.

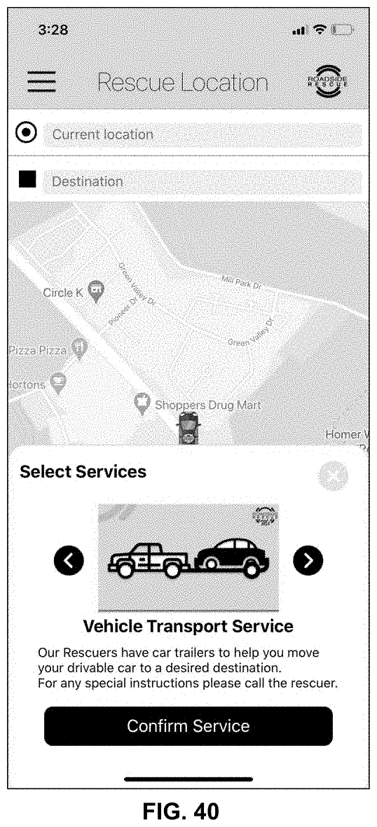

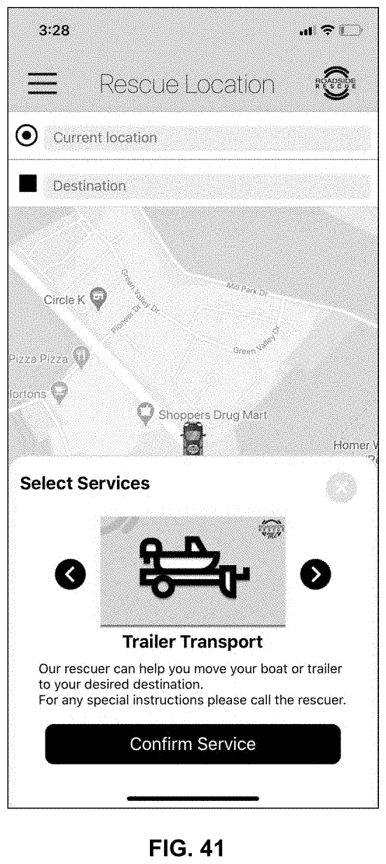

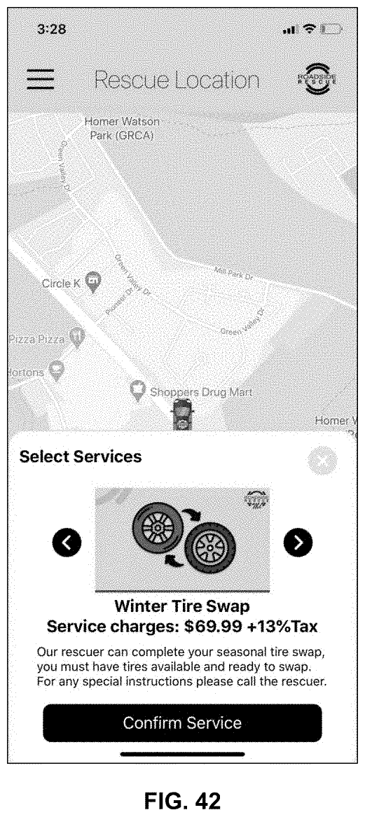

FIG. 40 shows a page detailing a vehicle service option. FIG. 41 shows a page detailing a vehicle service option. FIG. 42 shows a page detailing a vehicle service option.

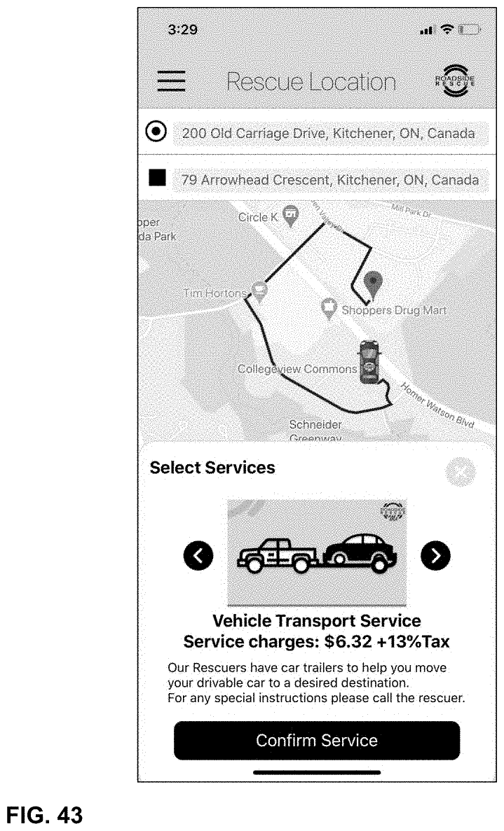

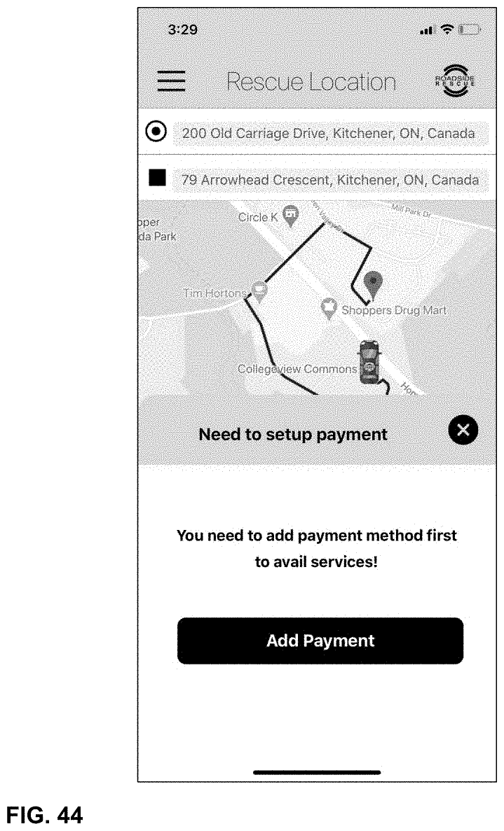

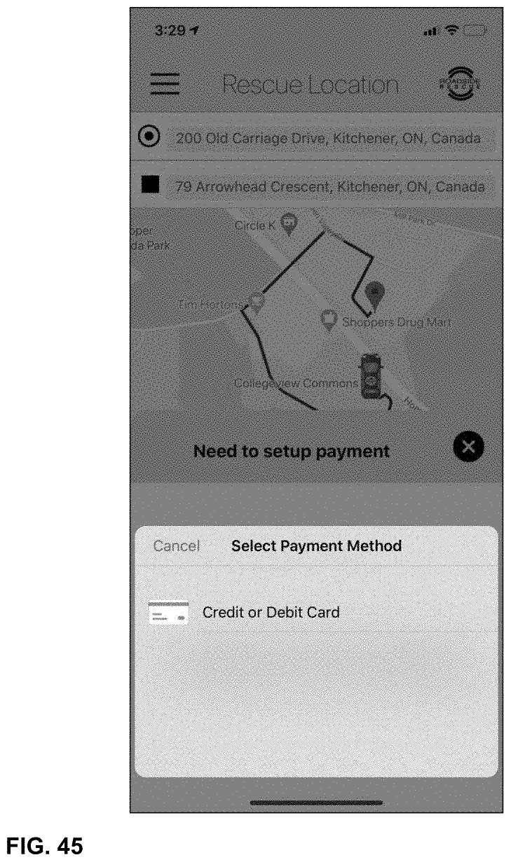

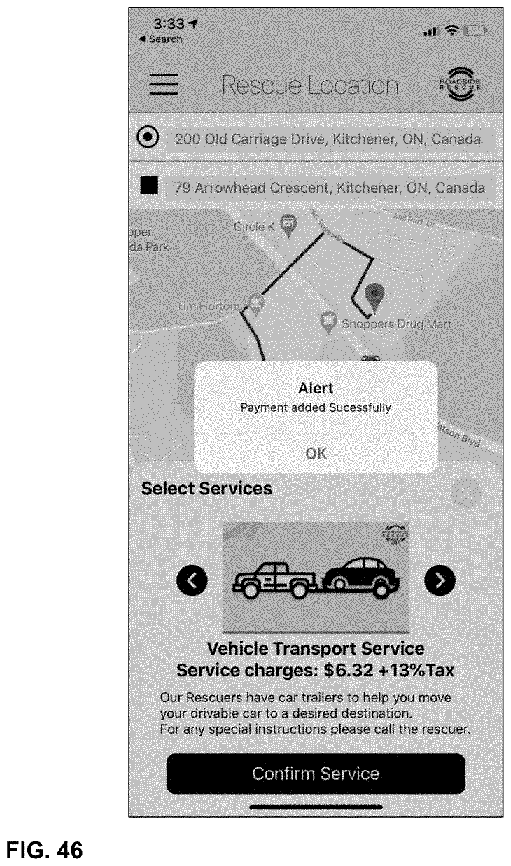

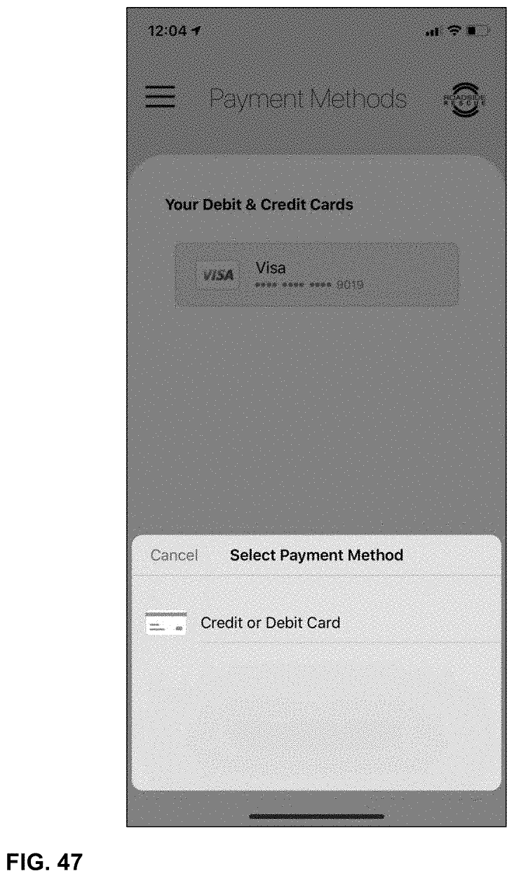

Once a service user has selected a service option and entered service information, a page may show a summary of the service request as shown for example in FIG. 43. In some examples, a service user is required to enter a payment method prior to requesting a service, and may be prompted to do so, such as by a payment prompt screen as shown for example in FIG. 44. A user may be offered one or more payment options on a payment information screen, as shown for example in FIG. 45. FIG. 46 shows an example confirmation page. FIG. 47 shows an alternative payment information screen, showing a preexisting payment method saved for the user's future use.

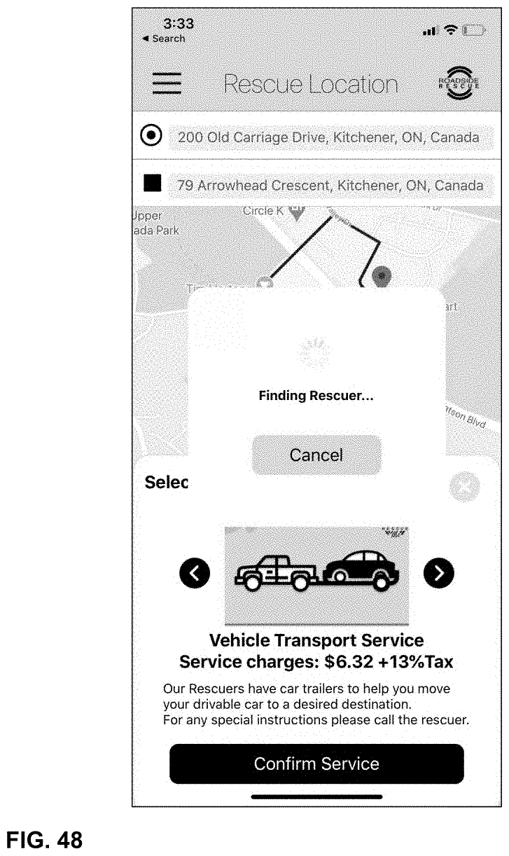

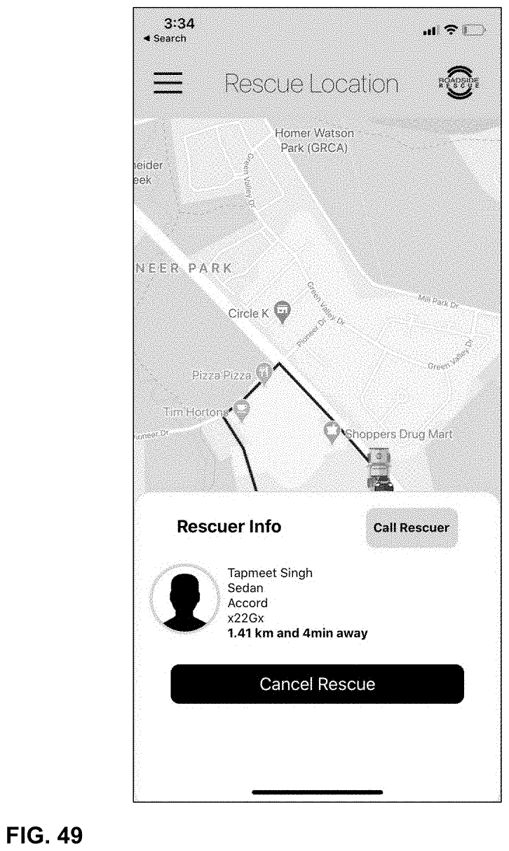

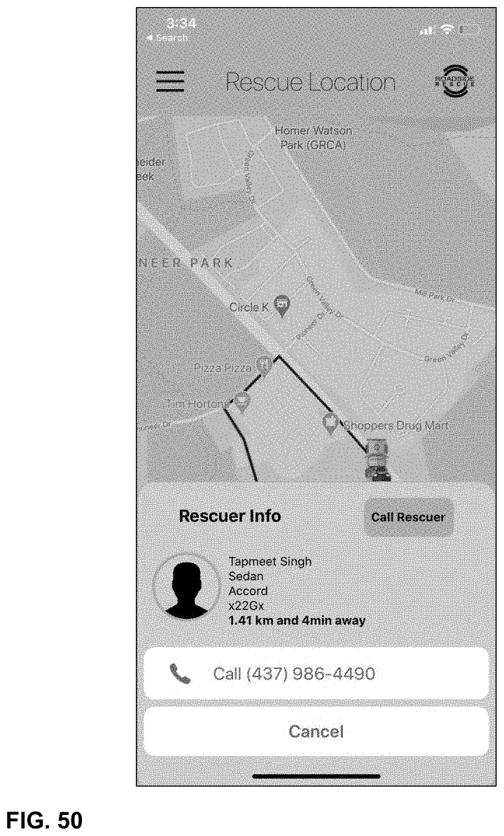

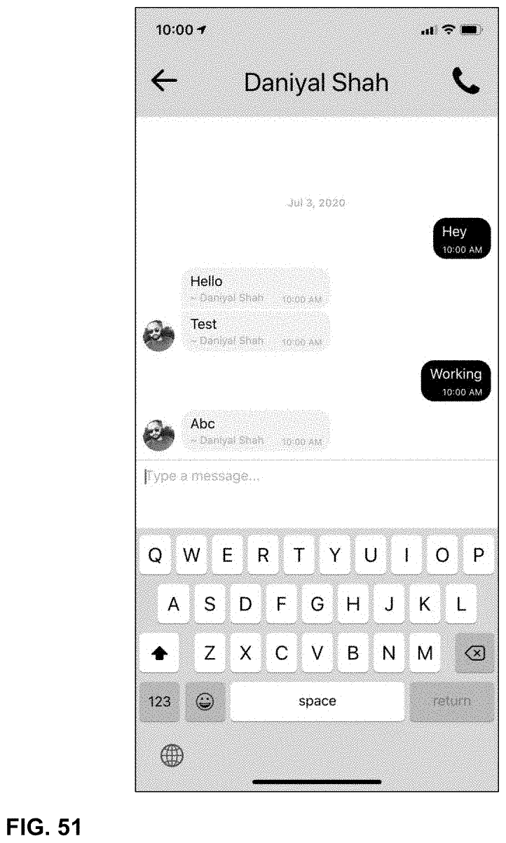

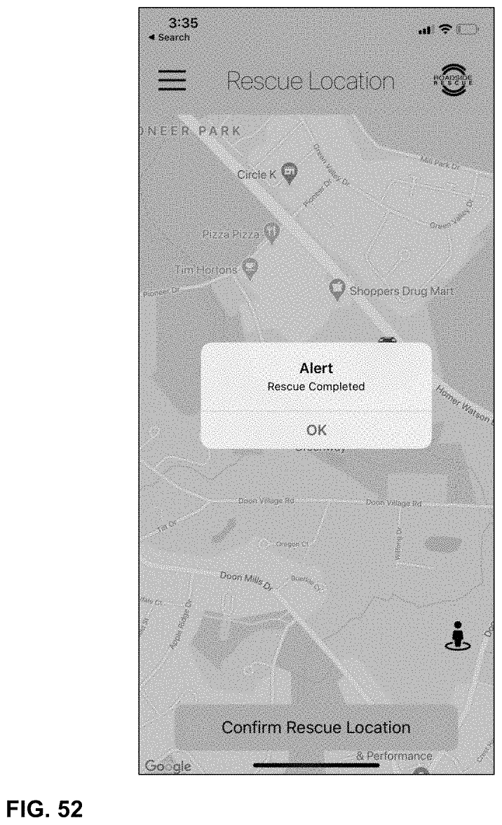

As shown in FIG. 48, a service user may be shown a loading page while the service user is matched to a service provider. When a service provider is selected, the service user may be provided with a service provider information page, as shown for example in FIG. 49. As show in FIG. 50, the service user may be able to call the service provider via a phone number provided on a further information page. In some examples, the service provider and/or service user may be able to communicate with the other, such as by sending messages to the other. FIG. 51 shows an example chat page for messaging between the service provider and the service user. When a service or rescue is complete, the service user may be provided with a service completion confirmation page, as shown for example in FIG. 52. The messaging ability through the system or method may be disabled once the rescue is complete.

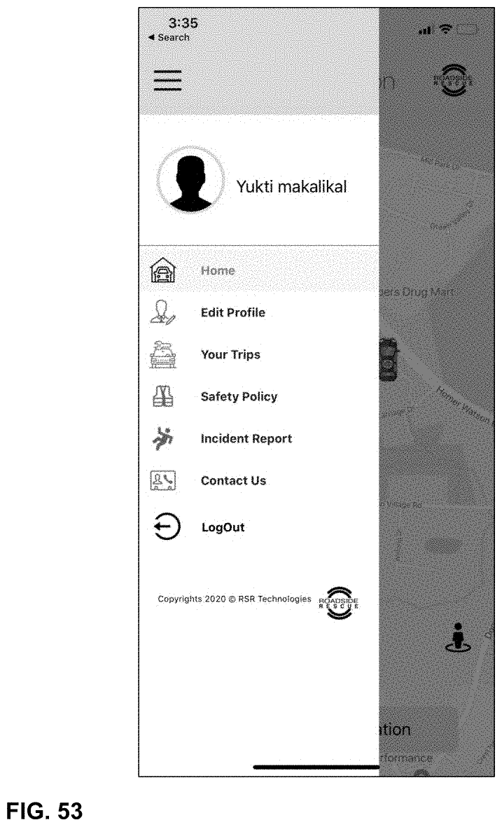

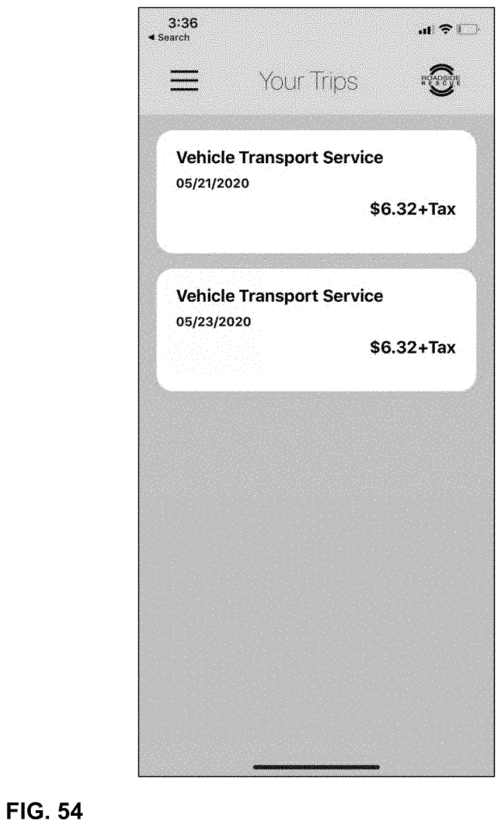

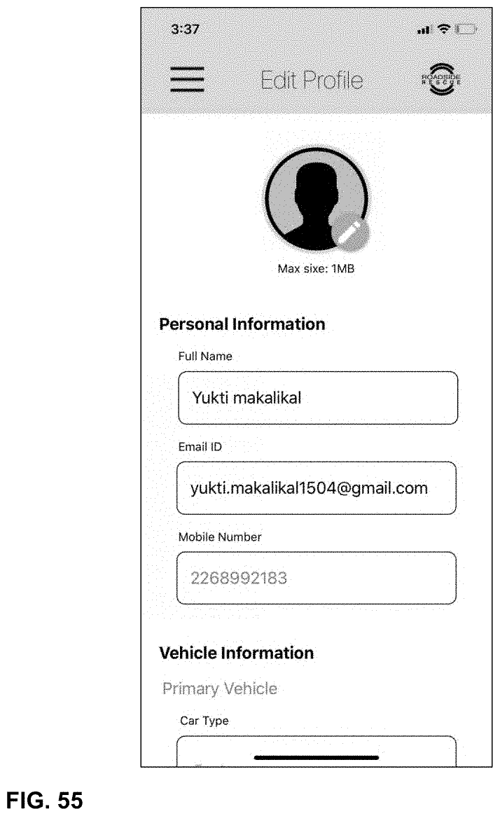

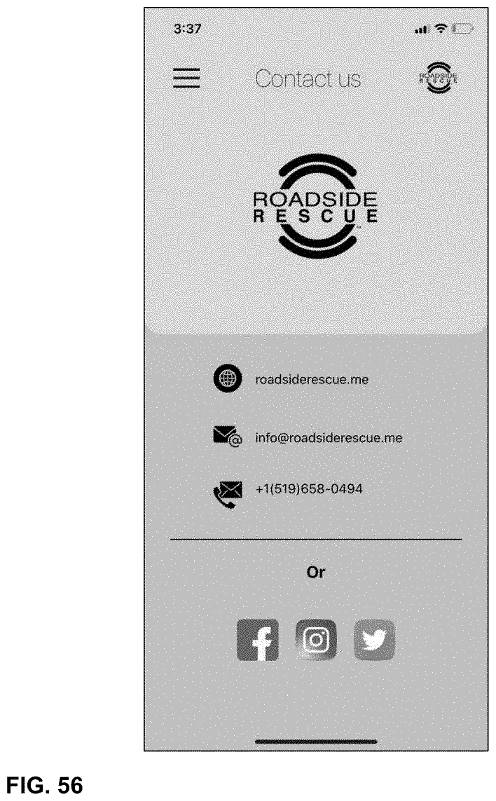

A service user may be able to access a menu page, as shown for example in FIG. 53. The service user may be able to access a history page showing a list of past service requests and associated information, as shown for example in FIG. 54. The user may also be able to access an profile editing page as shown for example in FIG. 55. FIG. 56 shows an example vehicle assistance system administration contact page, providing the service user which contact information for an administrator.

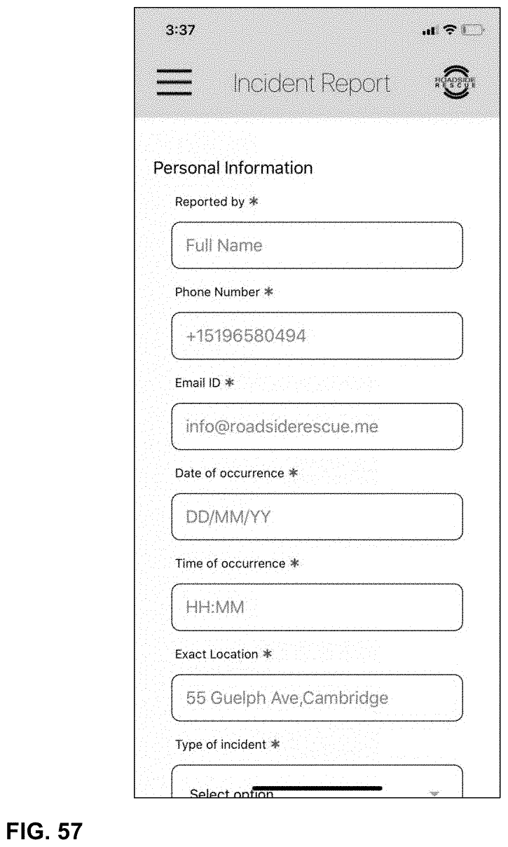

If an incident takes place during a service, the service user may be able to report the incident. FIGS. 57 to 59 show an example incident report page. The service user may user the incident report page to enter details about the incident, such as what took place, if any damage has occurred, and if anyone was injured.

A service provider may be prompted to provide personal and vehicle information when signing up, and, optionally, to select a service class and service type to offer to provide to a service user. The service user may also be prompted to provide evidence of possessing skills and/or tools needed to provide a given service.

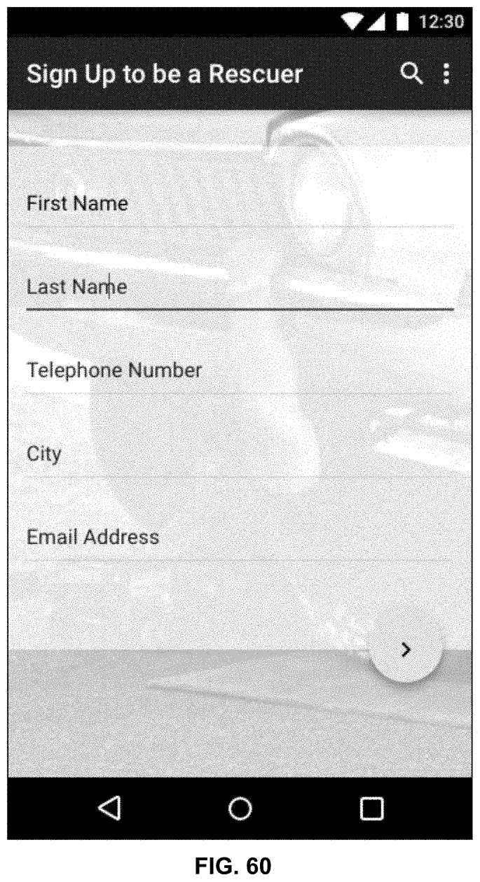

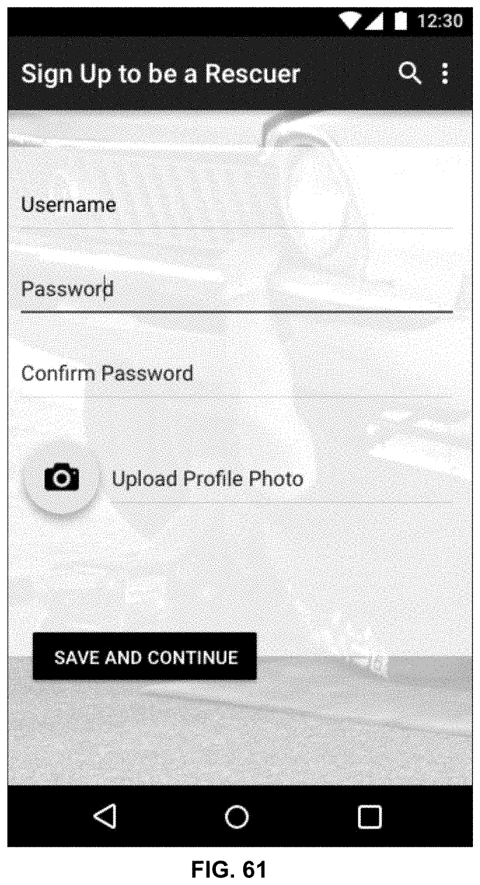

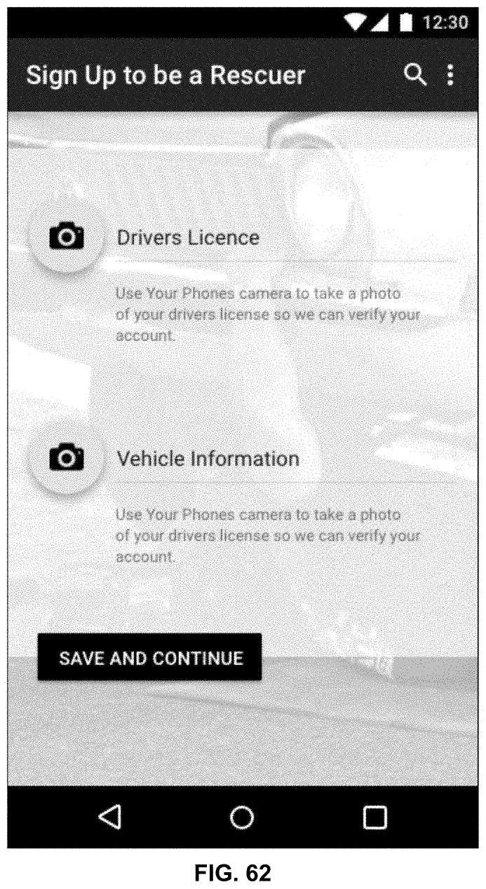

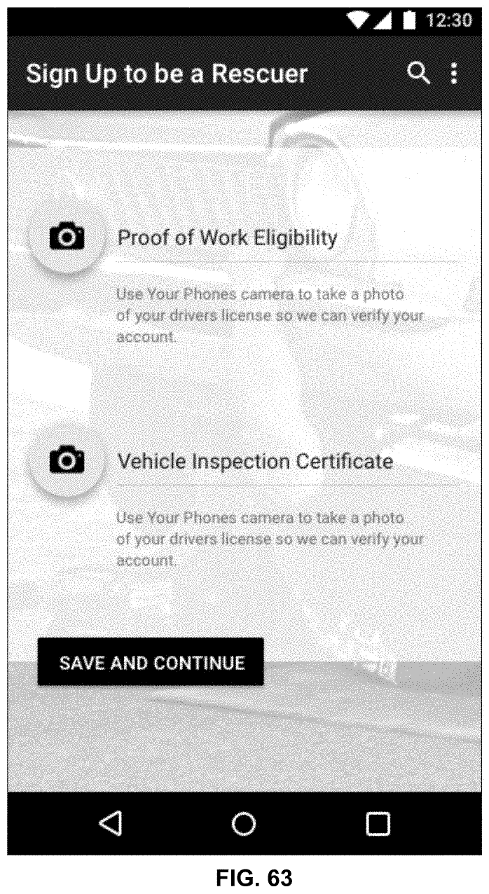

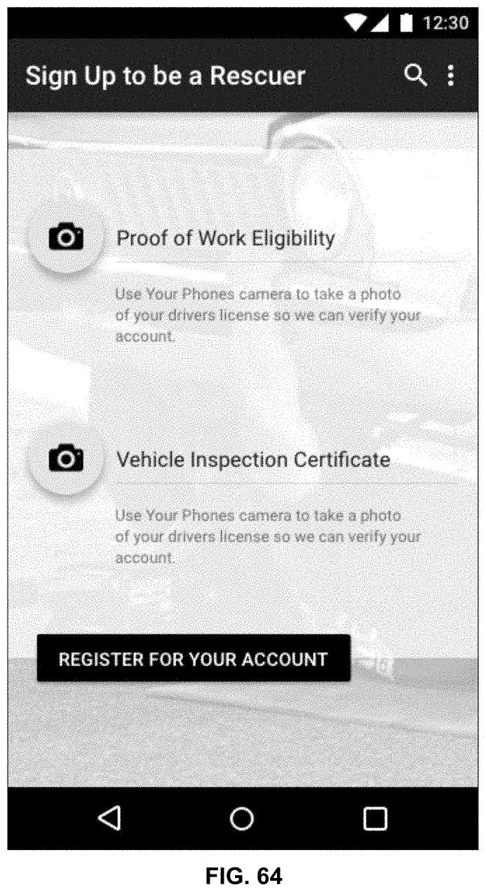

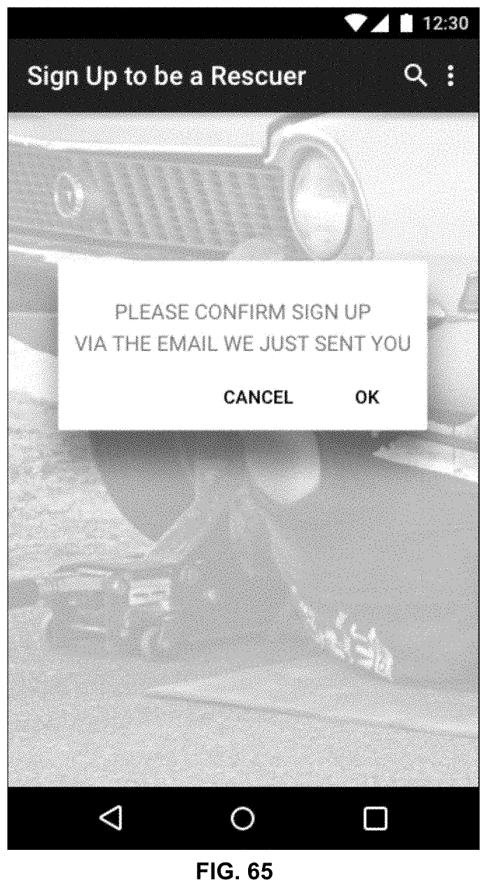

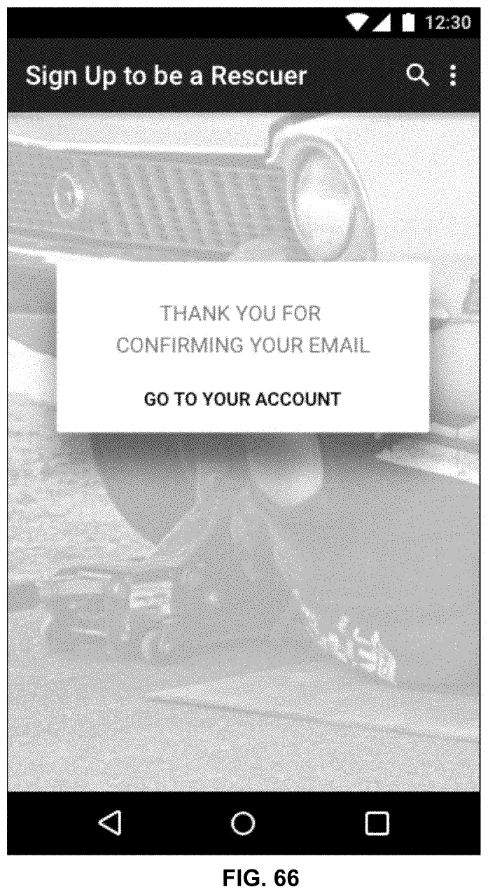

A service provider may be presented with a sign up FIGS. 60 to 66 depict pages generated by a first service provider sign up navigator style interface. The pages generated by the first service provider sign up navigator style interface are similar to the pages generated by the first service user sign up navigator style interface. The service provider is prompted to provide personal information (FIG. 60) and to set up a user name and password and provide a photo (FIG. 61). The service provider is prompted to provide evidence of one or more licenses, such as a driver's license, and to provide vehicle information (FIGS. 62 to 64). FIGS. 65 and 66 show, respectively, a page asking the service provider to confirm sign up via an email sent to their email account and a page notifying the service provider that confirmation was received.

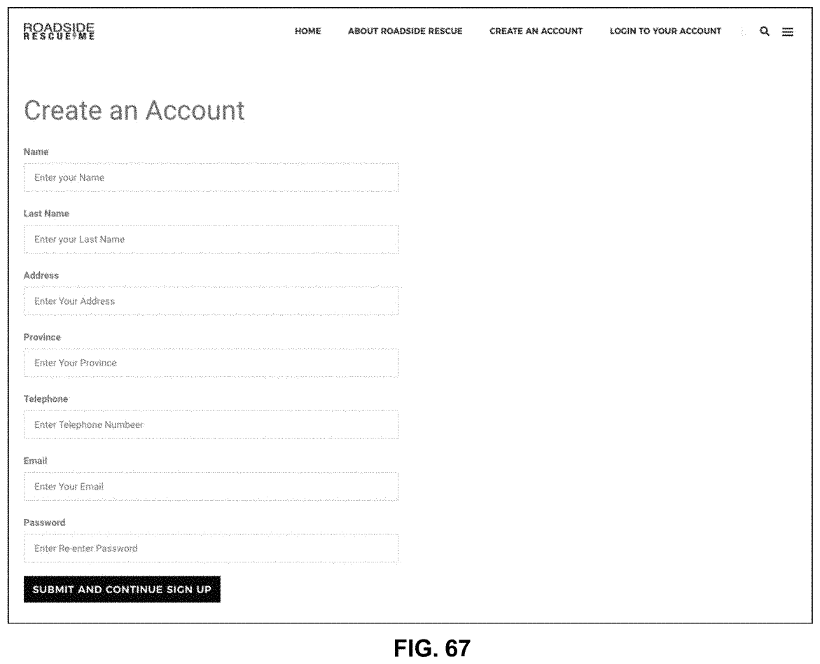

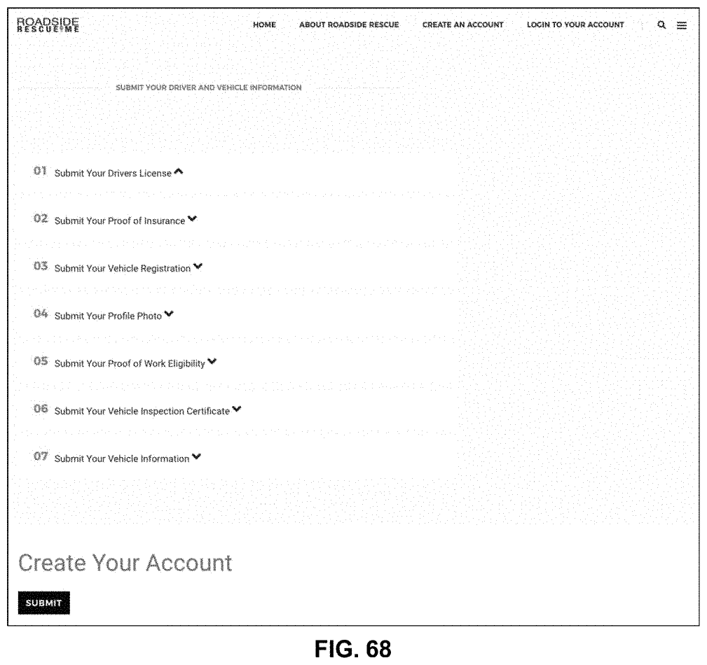

FIGS. 67 and 68 show pages generated by a second service provider sign up navigator style interface. The second service provider sign up navigator style interface is a web-based interface rather than an mobile application interface. As indicated in the example pages of FIGS. 67 and 68, the service provider is prompted to provide information and evidence.

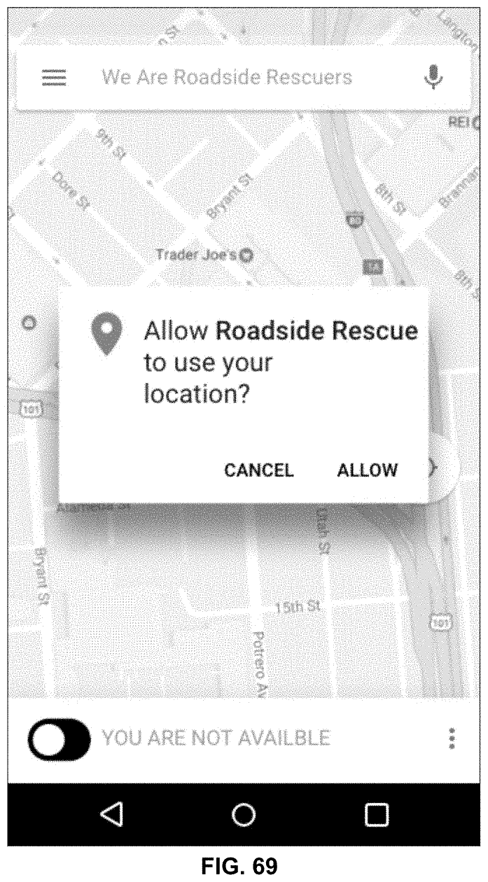

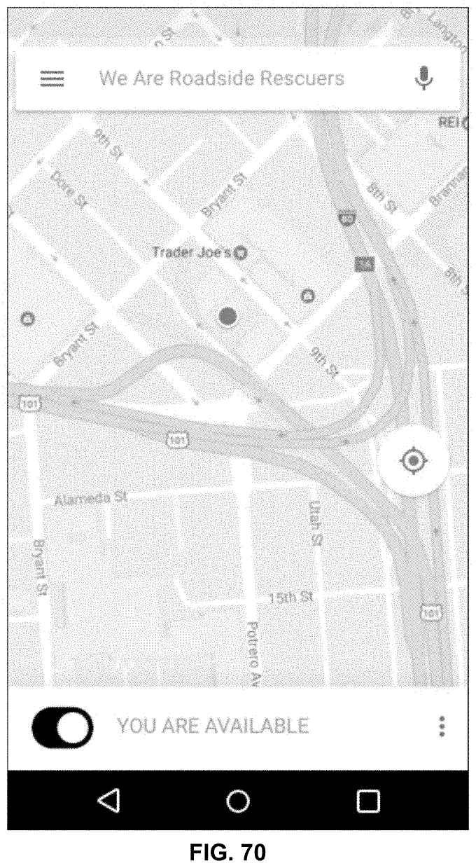

FIGS. 69 and 70 show examples of pages generated by a first service prover response navigator style interface. FIG. 69 shows an example of a location service access request page prompting the service provider to allow access to the location services of their mobile device. FIG. 70 shows an example of an available screen showing the service provider that they are currently identified as available in the vehicle assistance system, and showing their current location. In some examples, the service provider is able to indicate availability via a toggle provided on a page, such as a toggle as shown on the page of FIG. 70. When a service provider is marked unavailable vehicle assistance system, the vehicle assistance system and/or backend administration may still receive a signal to identify whether the service provider is in certain areas.

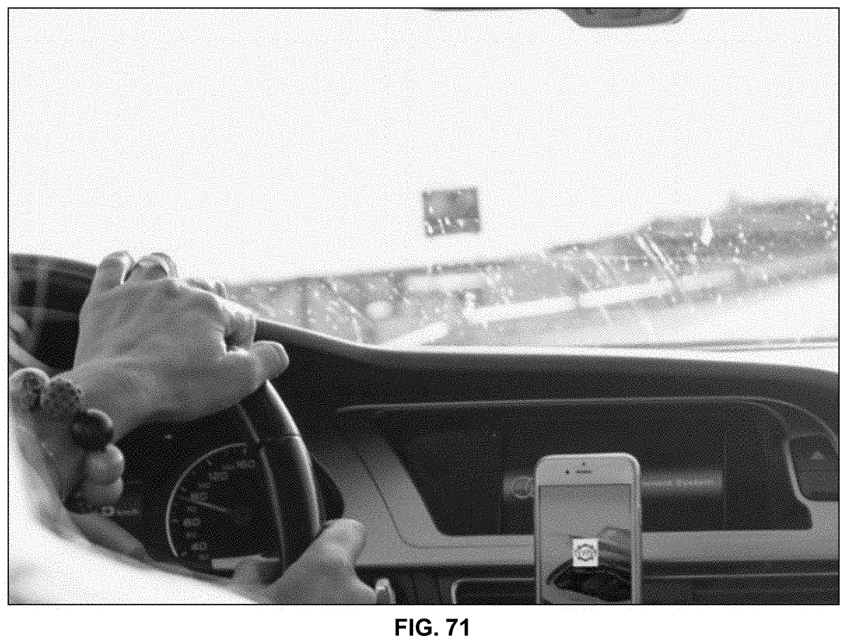

FIG. 71 shows a dashboard of a service provider vehicle, with a mobile device of the service provider displaying a page generated by the vehicle assistance system.

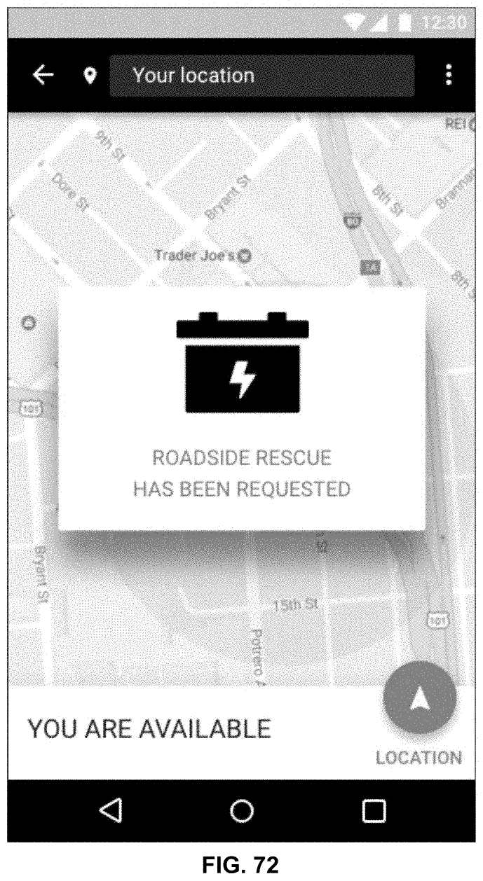

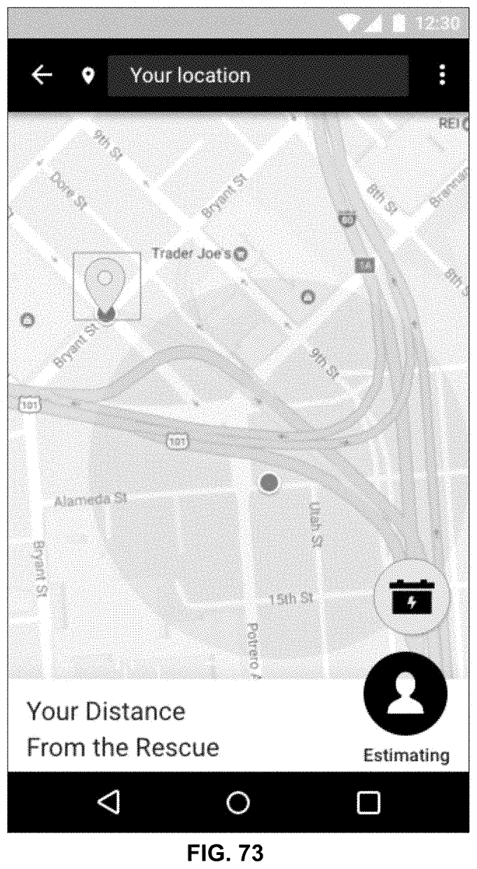

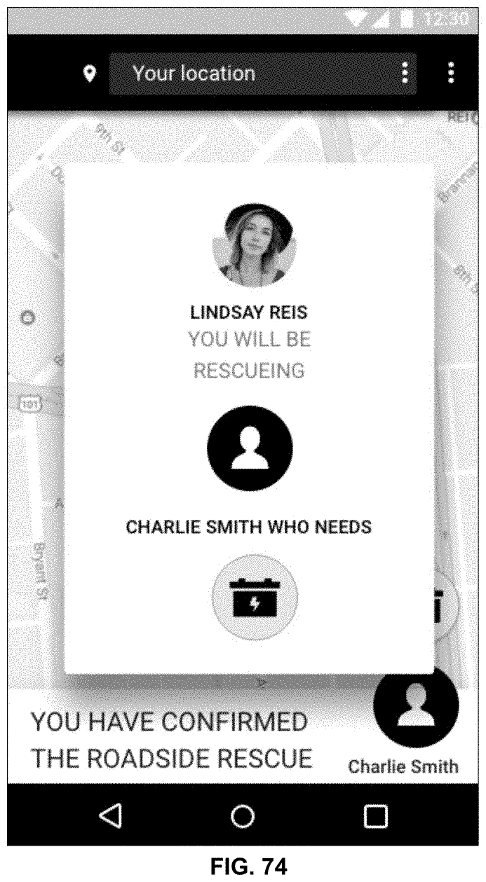

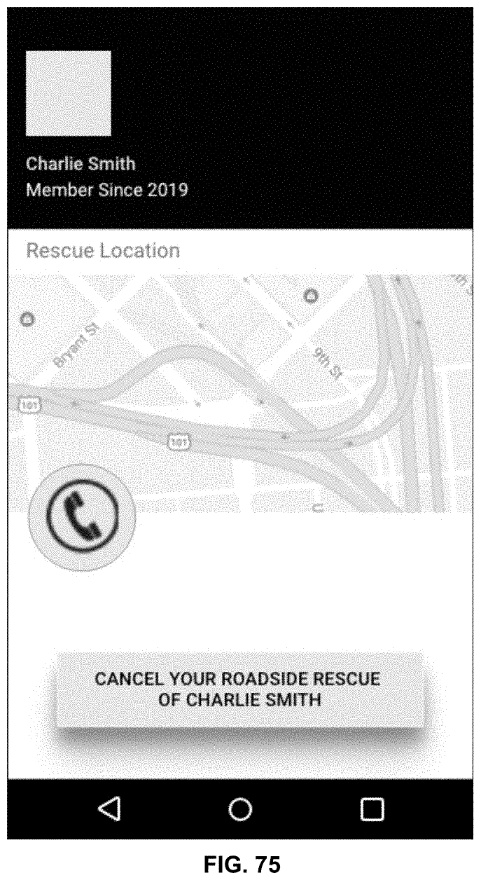

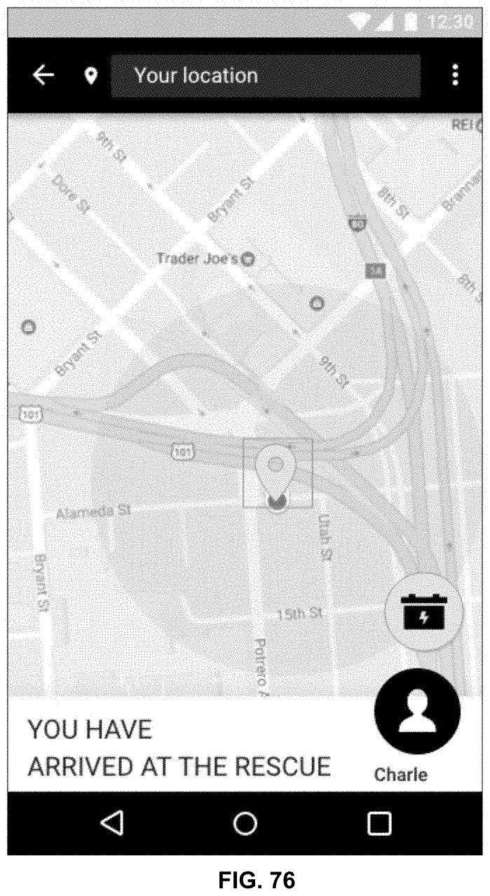

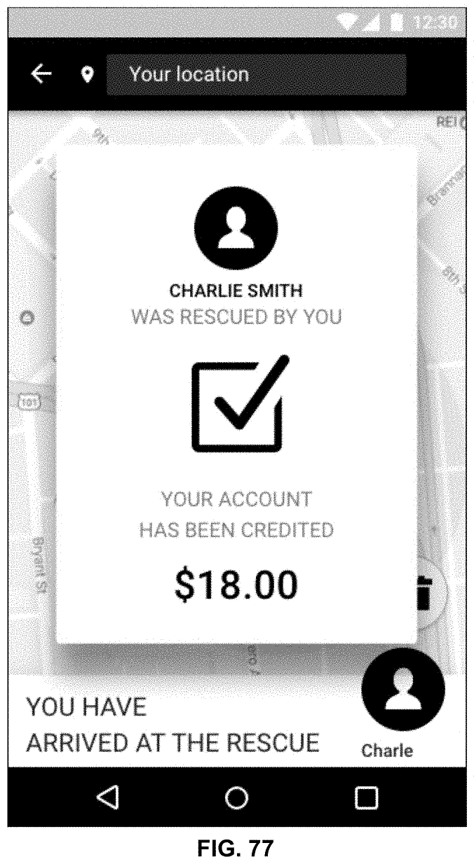

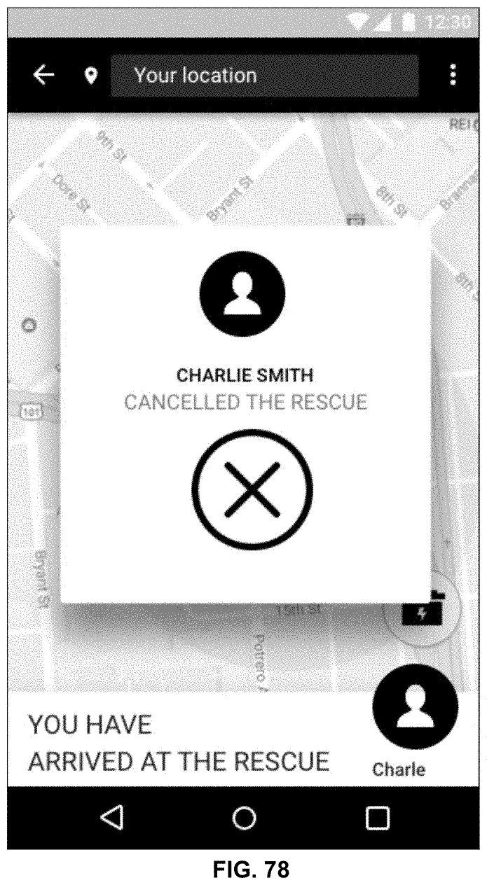

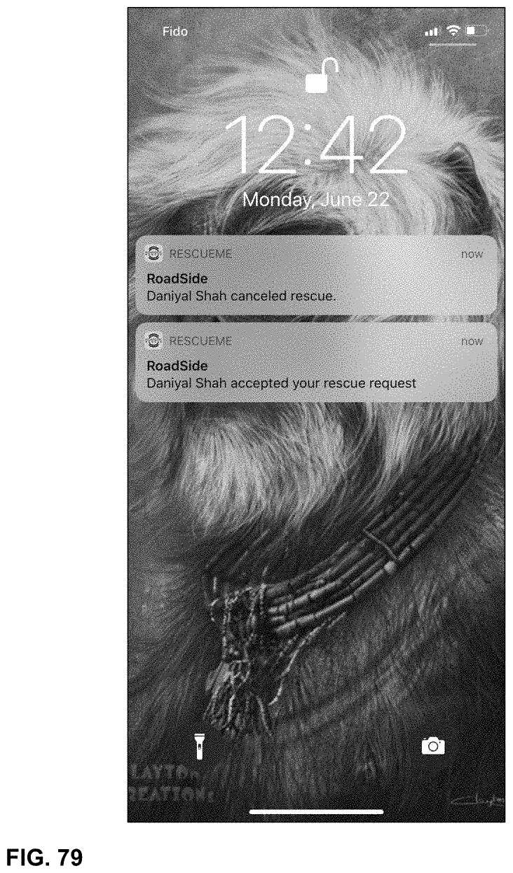

FIGS. 72 to 79 show further examples of pages generated by the first service prover response navigator style interface. If the service provider is marked as available when a rescue request (i.e. a service user's service selection) comes in, the vehicle assistance system may provide the service provider with a notification. The notification may include the user service selection. An example of a notification page is shown in FIG. 72. The service provider may also be provided with a location (e.g. a distance to the requested rescue), such as by way of a page as shown in FIG. 73. After the service provider accepts, the service provider may also be provided with a name or other information about the user, such as via the example page of FIG. 74. As shown in the example interaction page of FIG. 75, the vehicle assistance system may enable the service provider to view who has requested the rescue and their location, to call the service user, and/or to cancel upcoming rescue. In some examples, the vehicle assistance system provides a notice page, such as the example of FIG. 76, to inform the service provider that they have arrived at the service location In some examples, after the service user indicates that they have completed the roadside assistance service, the vehicle assistance system notifies the service provider of a credit to the service provider's account , such as via the example summary page shown in FIG. 77. If the service is cancelled, the service provider may be notified, such as via the notice page shown in FIG. 78 or via a popup notification as shown in FIG. 79.

In some examples, the service request will be broadcasted to the available service provider devices that are within an initial region, such as a 20 km radius. In some examples, the service user can look for service providers in an expanded region, such as a 40 km radius, with increased flat rates for requesting a service provider outside the initial region but within the expanded region.

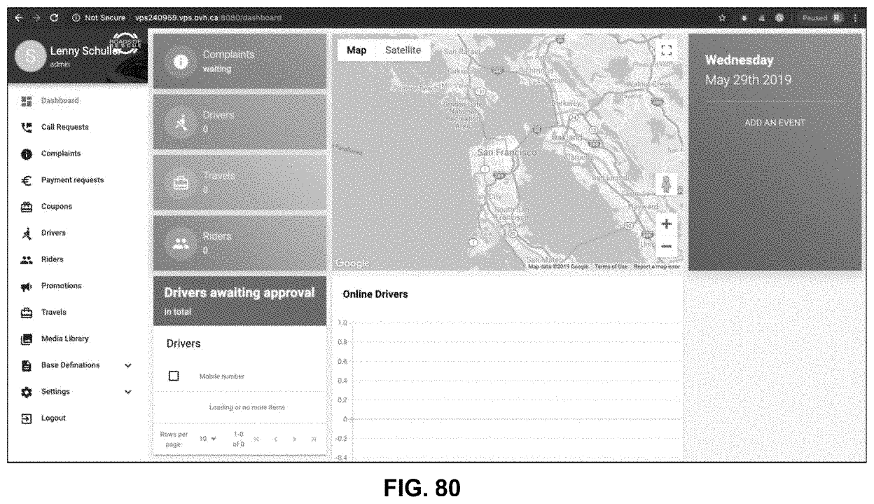

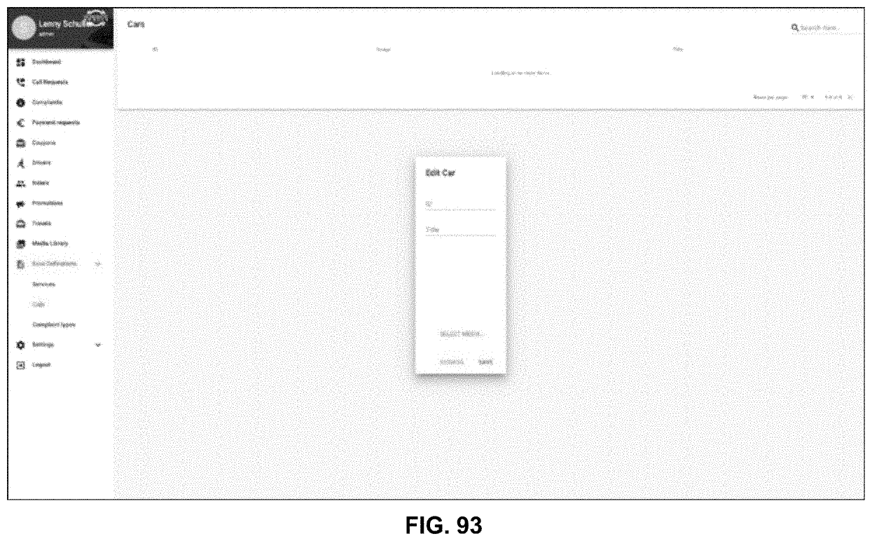

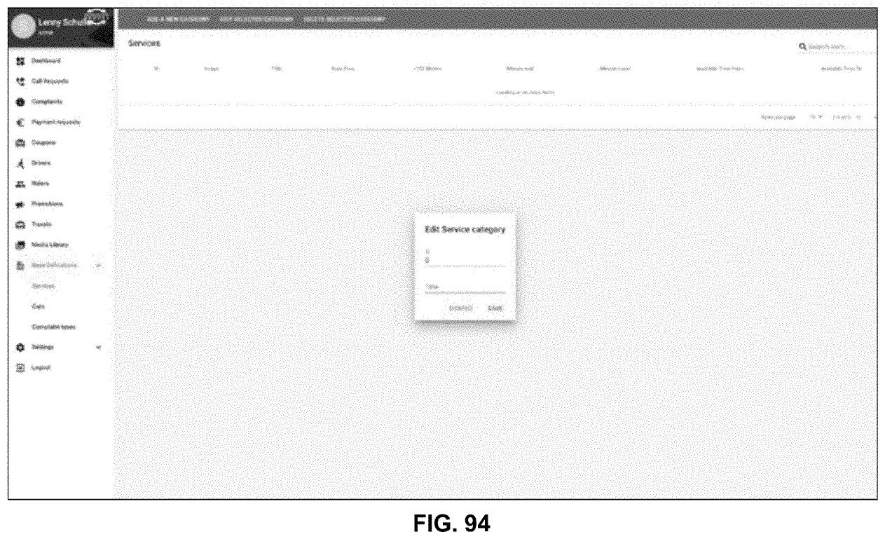

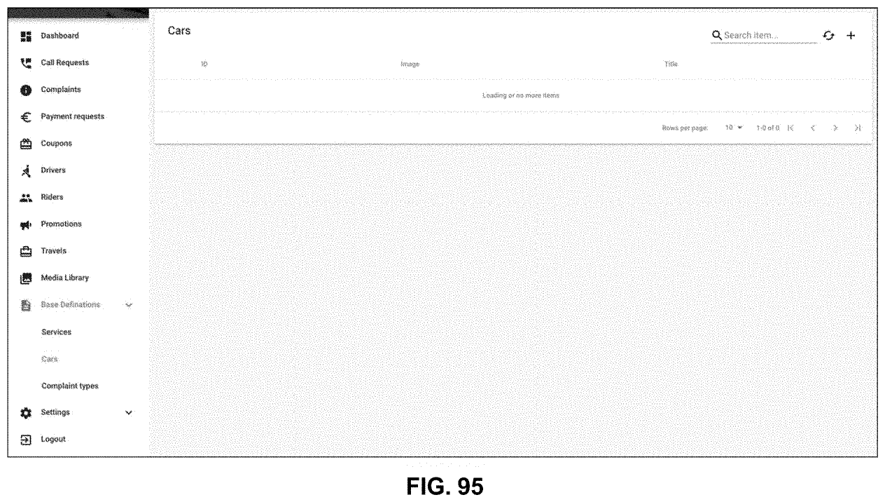

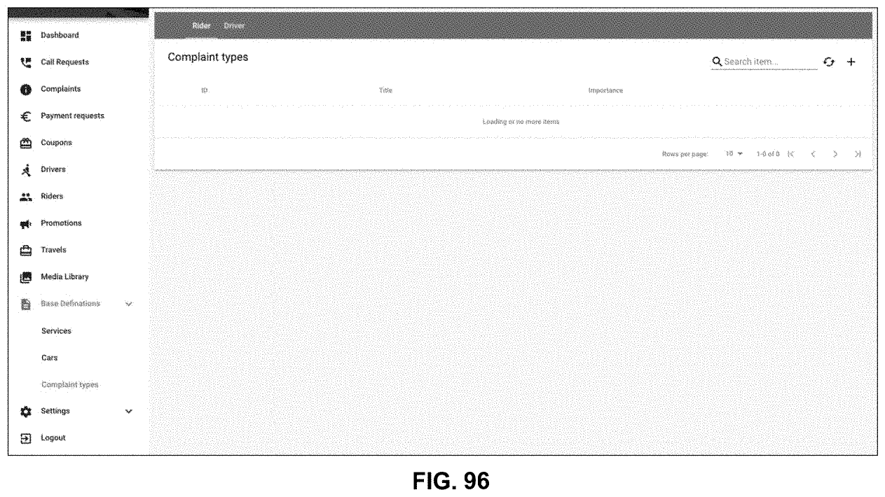

FIGS. 80 to 98 depict pages generated by an administrator navigator style interface.

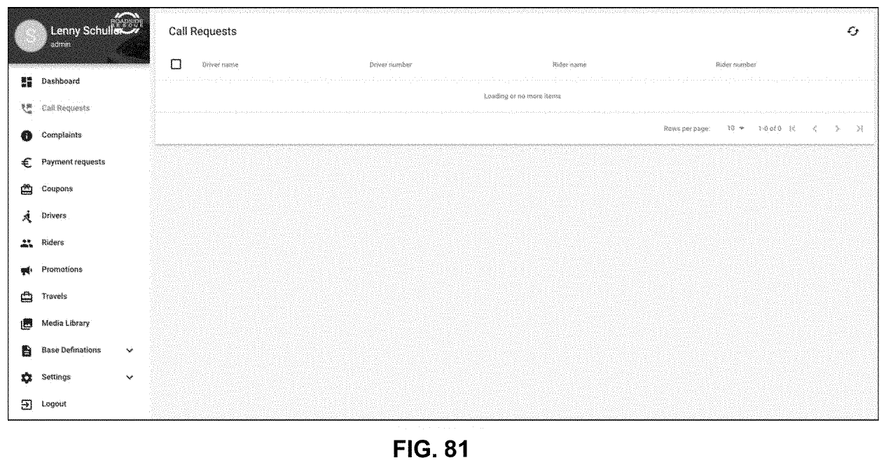

A dashboard page may be provided, such as the example of FIG. 80. A call requests page, such as the example shown in FIG. 81, may be provided to an administrator user to help track requested calls and/or active calls of both service providers and service users.

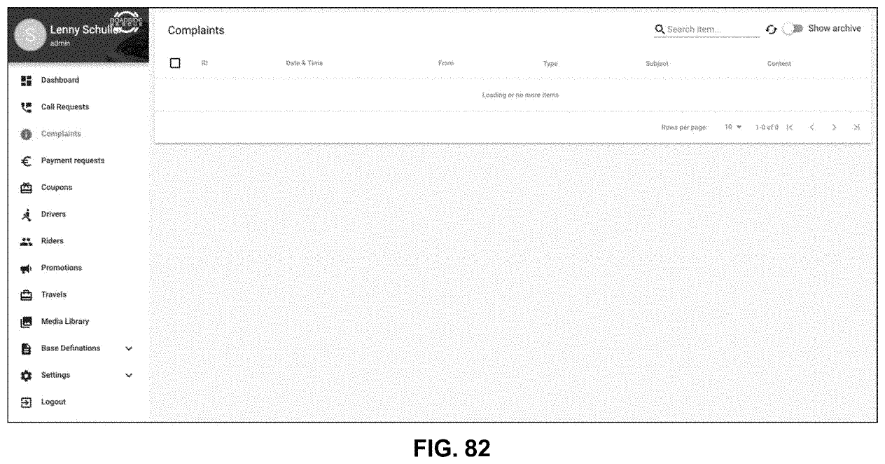

Complaints pages may be provided to help administrators to track complaints from service users. In some examples, the system can break down complaints, and track and compile knowledge concerning typical complaint types and more serious ones as the number of users grows. In some examples, the system can suspend drivers, or fully and completely remove drivers, based on complaints. An example of a complaints page is shown in FIG. 82.

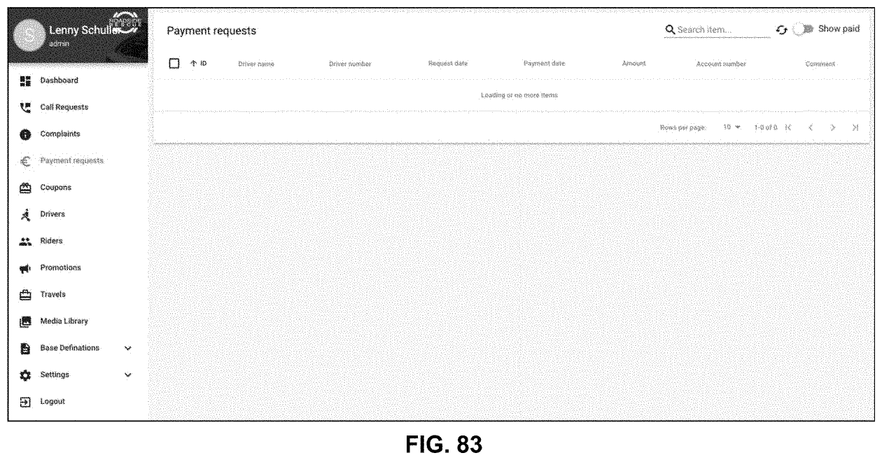

Payment requests pages may help an administrator user to track payments made to service providers via the system. In some examples, payments are made directly into the accounts of each service provider via a payment gateway built and/or integrated into the platform—e.g., the Braintree™ payment gateway offered by PayPal Holdings, Inc. of Chicago, Ill. An example of a payment requests page is shown in FIG. 83.

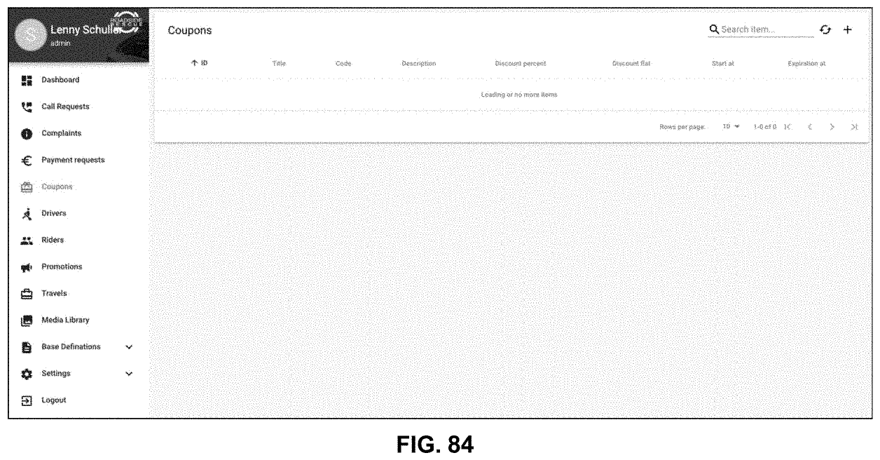

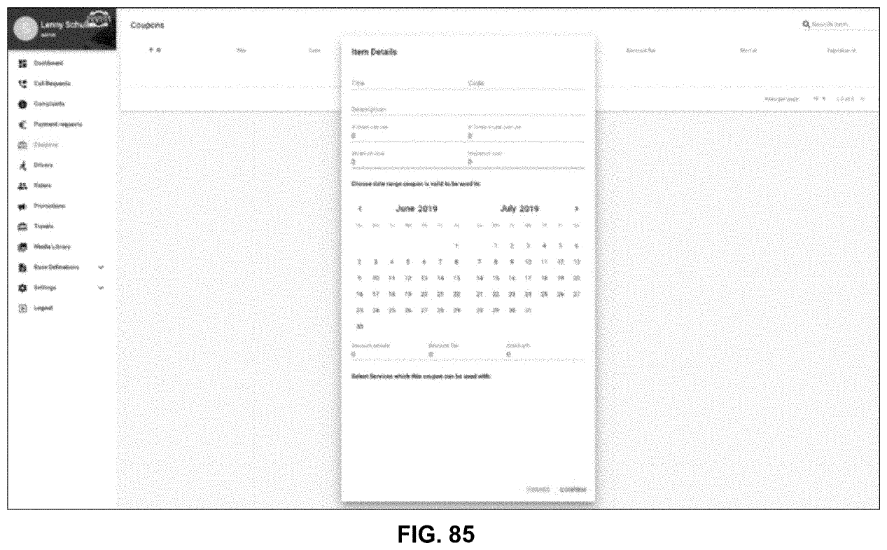

In some examples, one or more coupon pages may be provided to enable coupons to be generated in one space and sent out to users. In some examples, maximum and minimum amounts can be set. In some examples, dates, discounts, credits, and number of times can all be set via a central page or pages by an administrator user. Examples of coupon pages are shown in FIGS. 84 and 85.

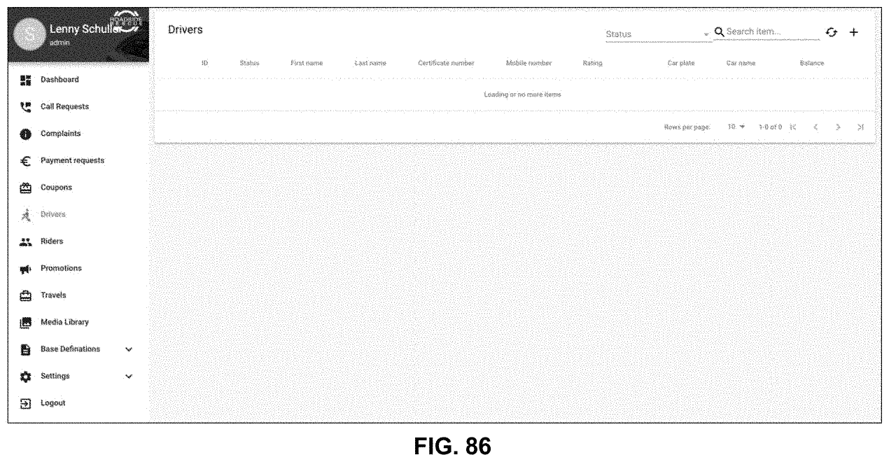

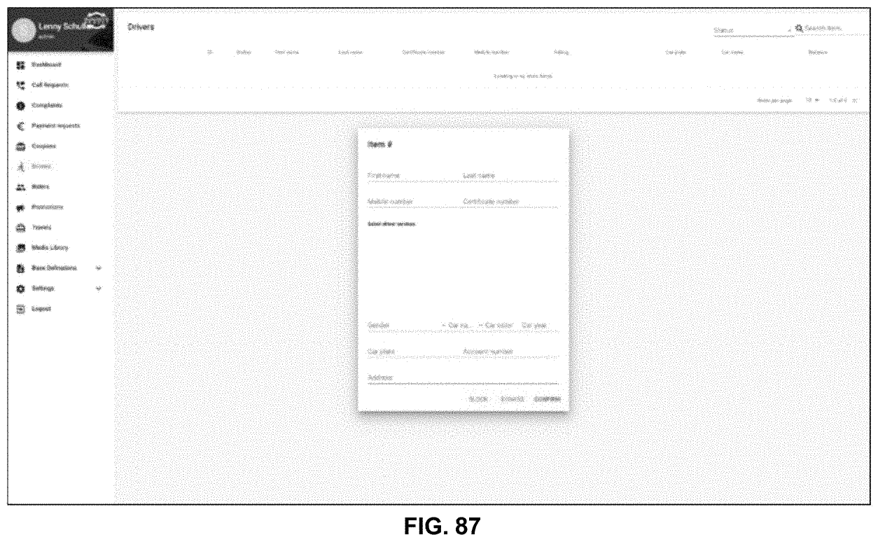

In some examples, a drivers page is provided and may help the platform and backend administration to track the accounts of each service provider / driver on the platform, and/or to track the travel time of each driver from their current location to their destination address. Preferably, this panel also presents the driver's status, name, rating, car license plate, and account balance. The vehicle assistance system may be operable to change, edit, remove, and block drivers based on ratings, complaints, or otherwise. Examples of drivers pages are shown in FIGS. 86 and 87.

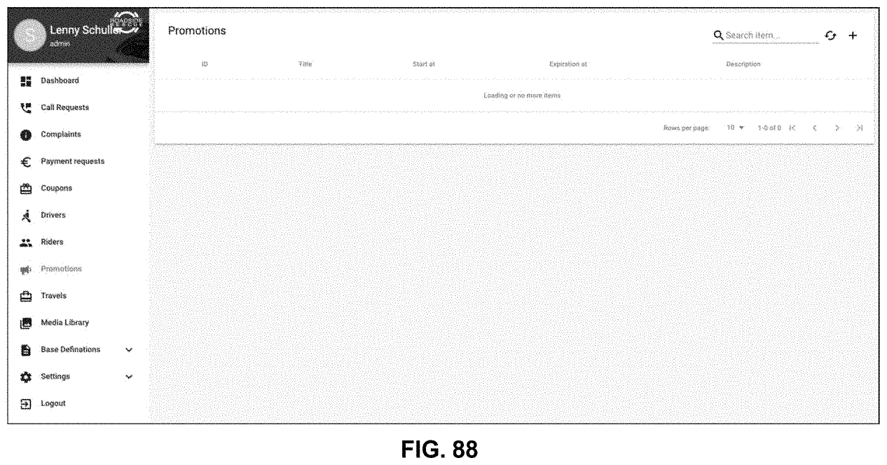

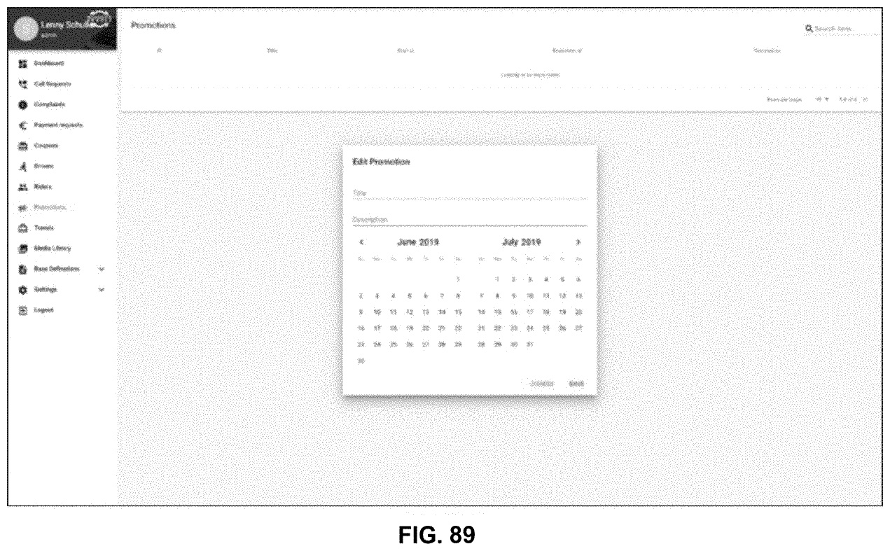

In some examples, promotions pages are provided. Examples are shown in FIGS. 88 and 89.

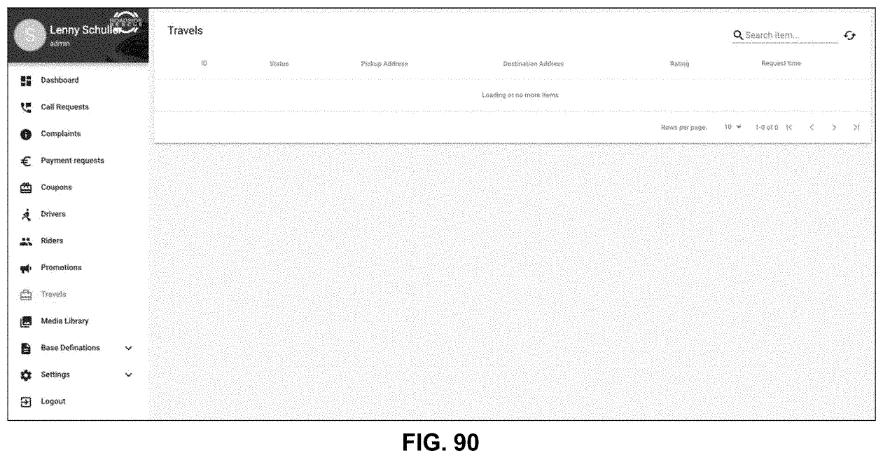

In some examples, a travels page is provided. An example is shown in FIG. 90.

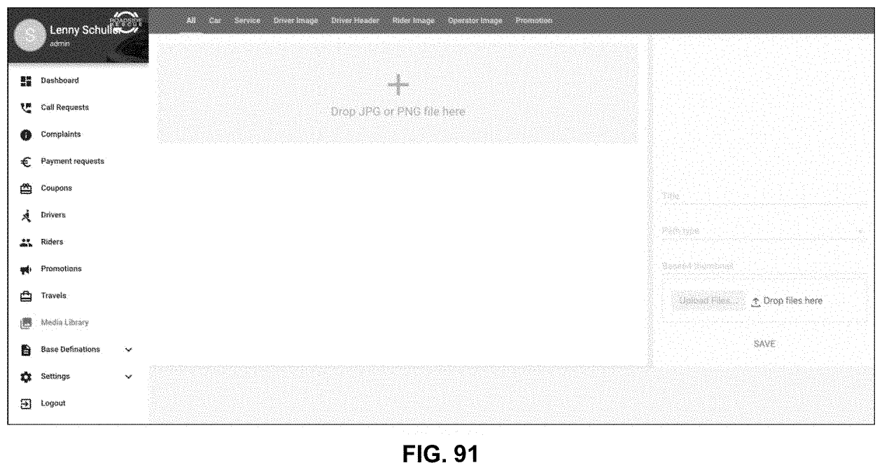

In some examples, a media library page provides an administrator user with the ability to upload or delete images and media stored. The vehicle assistance system may automatically generate thumbnails. The media library page may be drag-and-drop enabled. An example of a media library page is shown in FIG. 91.

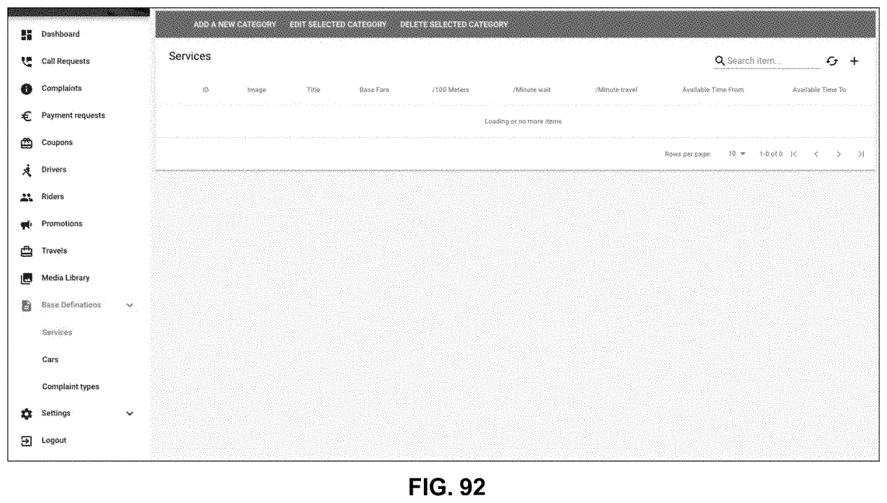

In some examples, base definitions pages enable administrator users to add, remove, and edit service categories and to assign values (and other quantities, qualities, and/or characteristics) to each service offered and, under an edit car services section, to add and subtract services and/or images. Examples are shown in FIGS. 92 to 96.

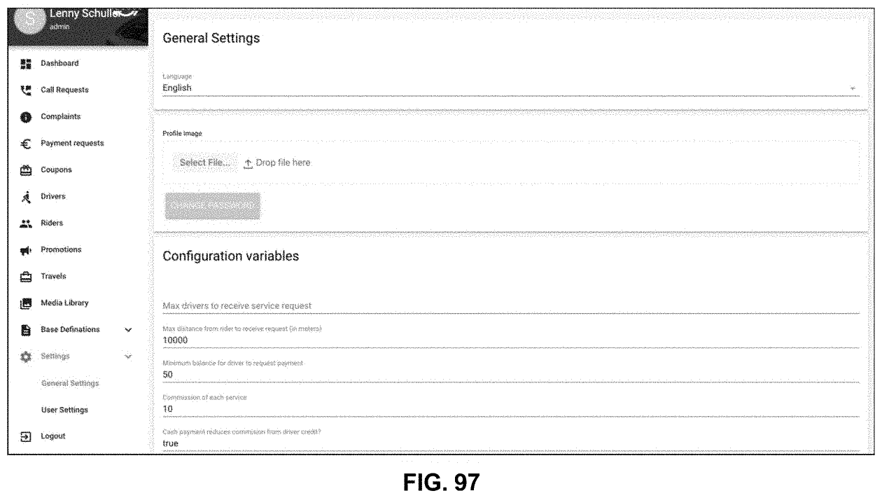

In some examples, a general settings page enables administrator users to set, review, and change commission rates, distance to receive a rescue call, and device versions, etc. An example is shown in FIG. 97.

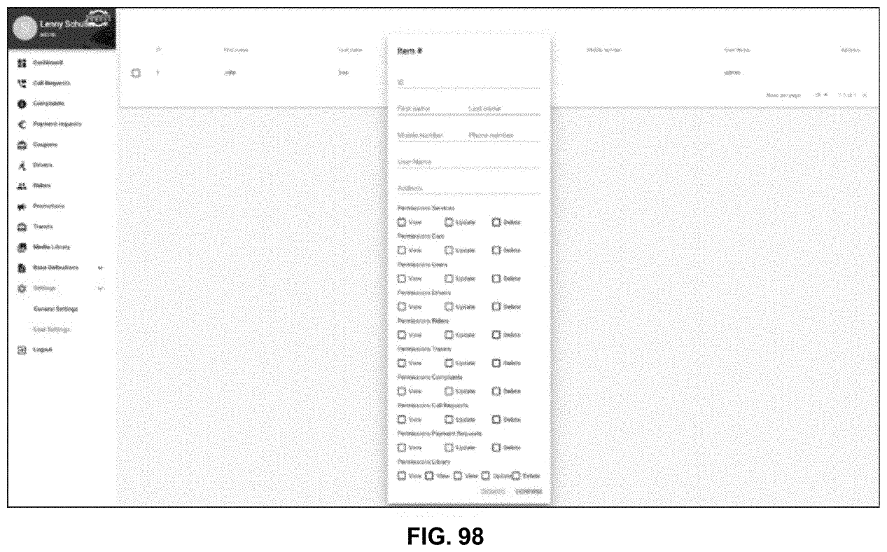

In some examples, a user settings page enables administrator users to set, review, and change various permissions that users can access, from within the interfaces, on Apple™ and Android™ mobile devices. An example is shown in FIG. 98.

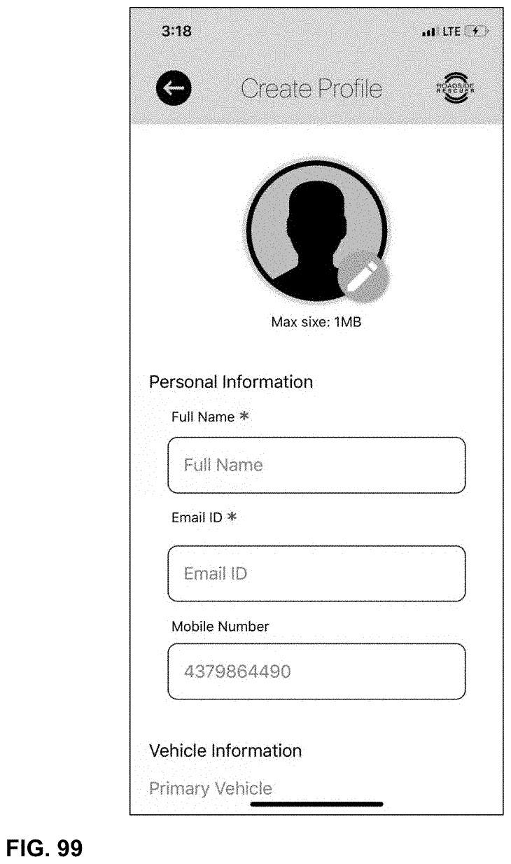

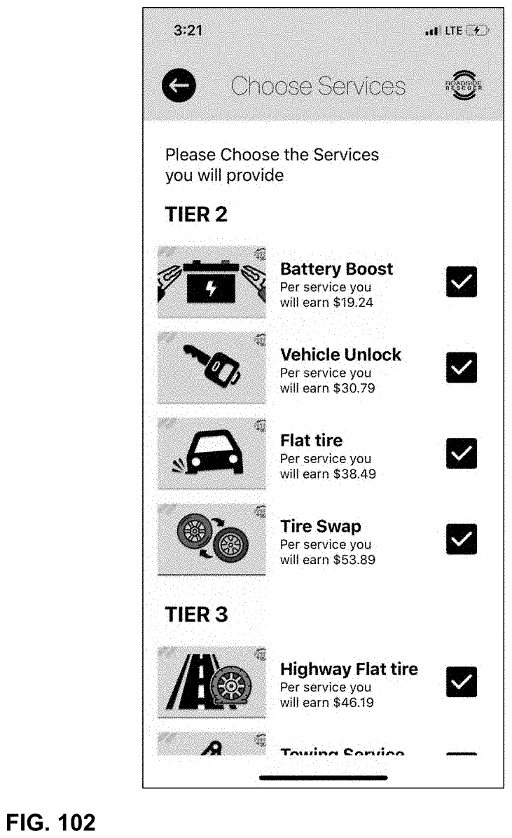

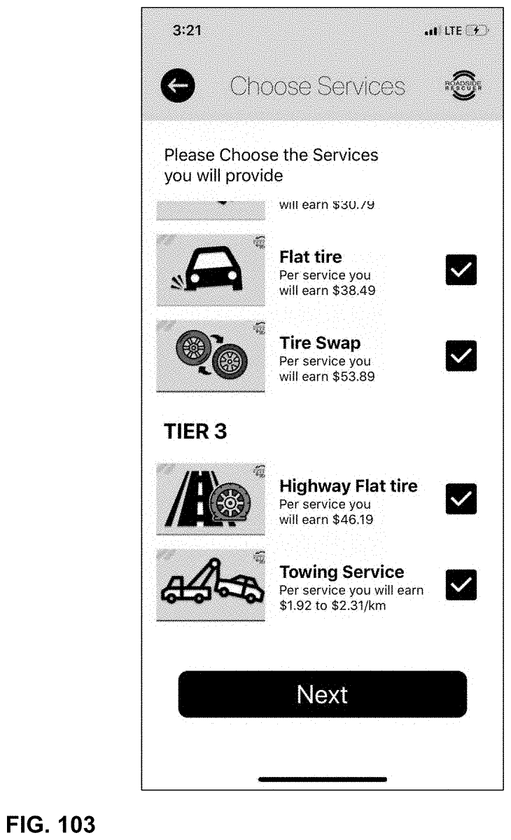

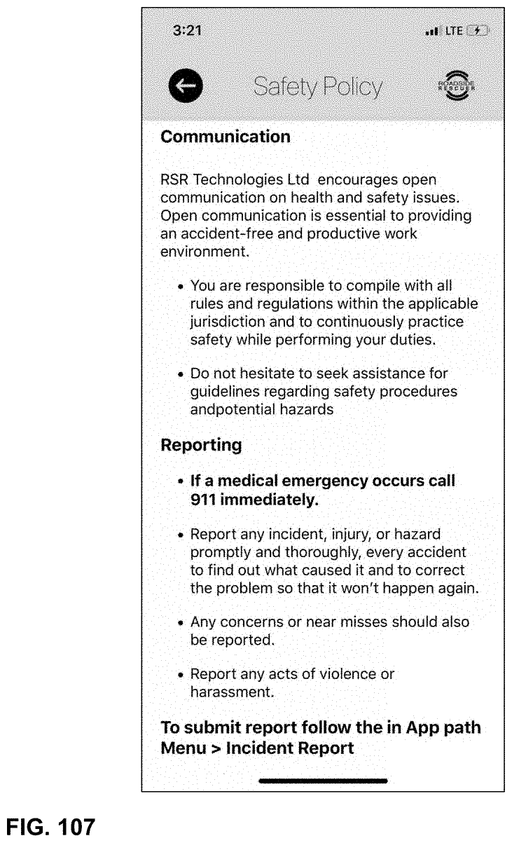

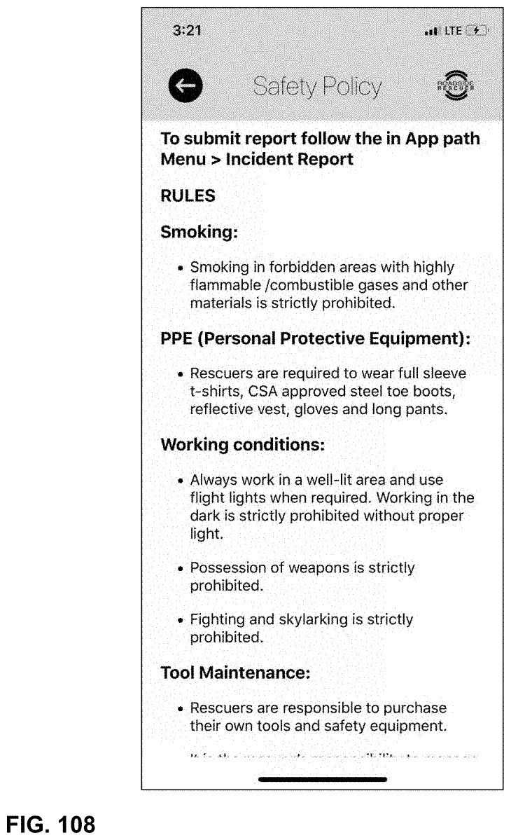

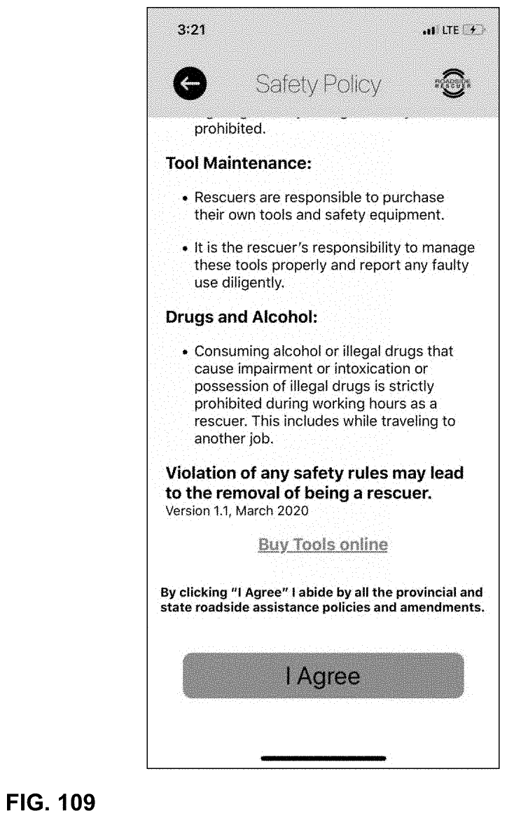

FIGS. 99 to 114 depict pages generated by a third provider sign up navigator style interface.

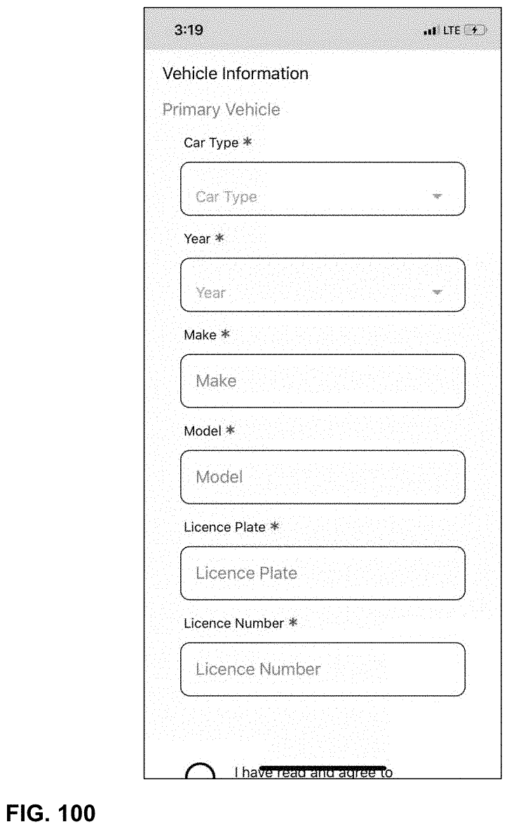

The service provider may be provided with sign up pages asking for personal information and information about the service provider's vehicle. FIG. 99 shows an example sign up page asking for service provider personal information. FIG. 100 shows an example sign up page asking for service provider vehicle information.

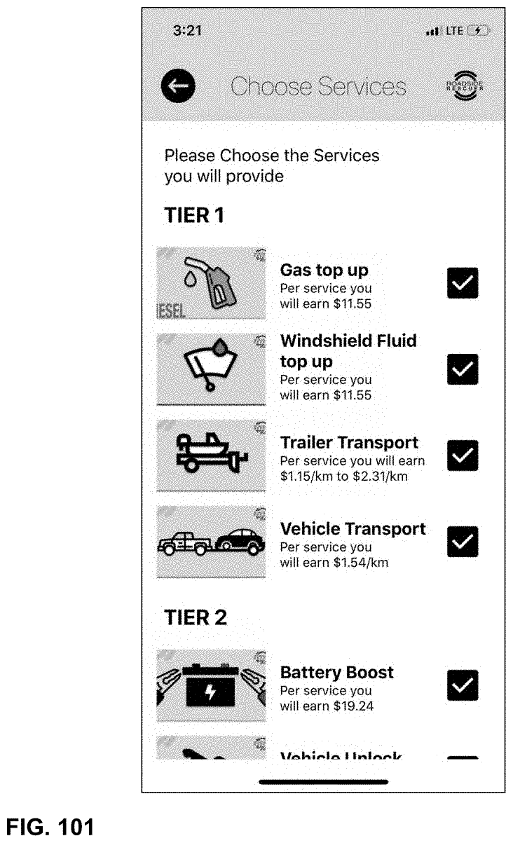

The service provider may be presented with two or more service types and, optionally, two or more classes of service types. The service provider may be prompted to choose at least one service type and/or class as a service offering that the service provider can offer. FIGS. 101 to 103 show an example of a service offering selection page presenting the service provider with a choice of at least two classes (i.e. tiers) of roadside services. Each of the at least two classes of the example includes at least two roadside service types. The service provider may select at least one class and at least one roadside service type as a service offering, using the third provider sign up navigator style interface.

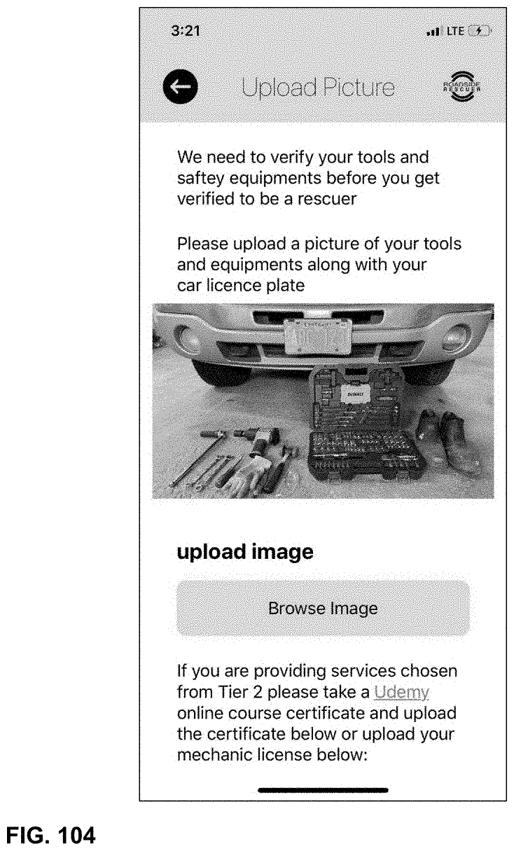

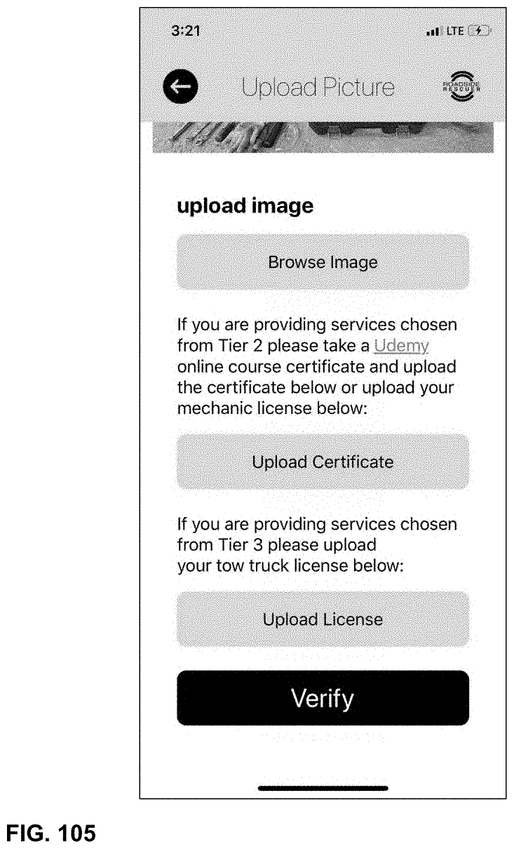

The service provider may be prompted to supply evidence of a service skill and/or tool associated with the service offering. The evidence may be reviewed by an administrator user prior to the service provider being approved to offer the service offering to a service user. FIGS. 104 and 105 show examples of evidence pages, prompting the service provider to provide at least a first piece of evidence of possession of a roadside service skill for performing the roadside service type that the service provider has selected as a service offering. The at least one service user is also prompted to provide at least one piece of evidence of possession of a roadside service tool for performing the service offering. The vehicle assistance system may also receive the evidence through the pages. For example, the service provider may be able to upload images or other files showing, tools, equipment, a vehicle license plate, safety gear, a training course certificate, a mechanic's license, or a tow truck operator's license.

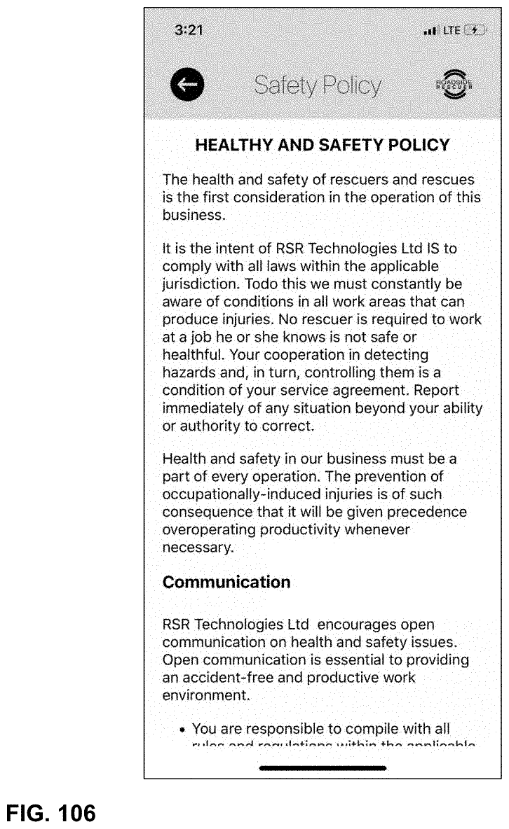

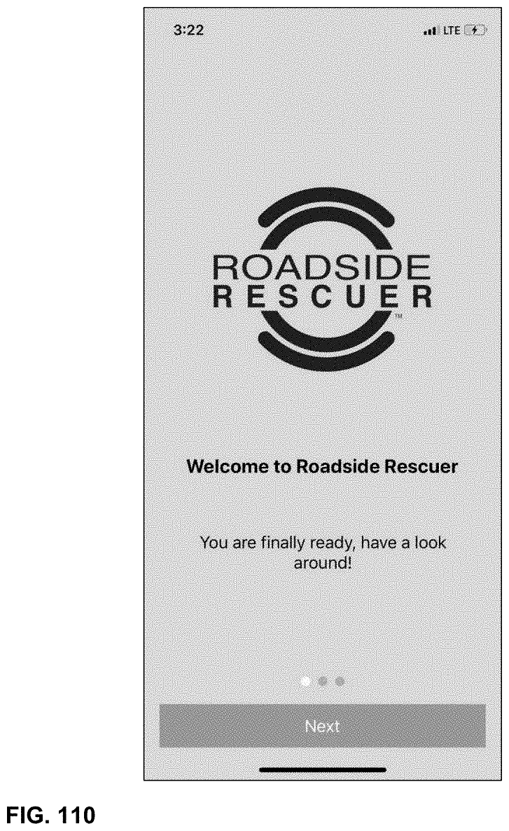

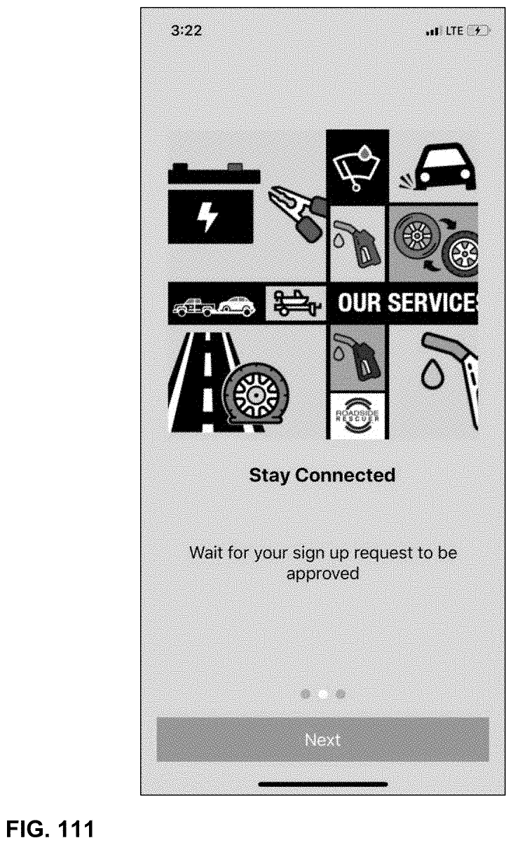

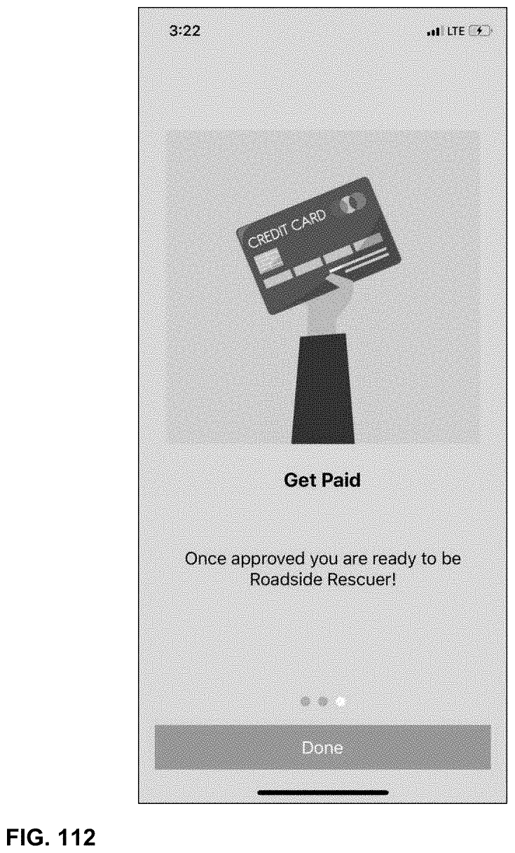

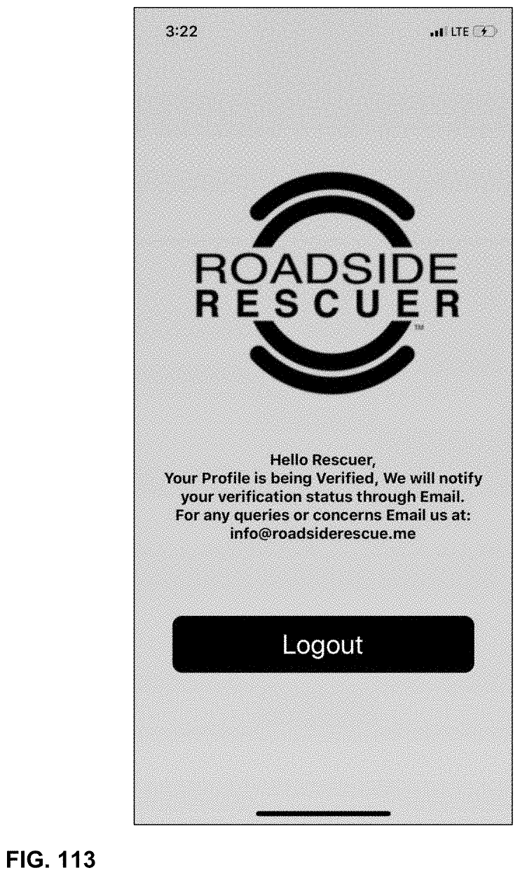

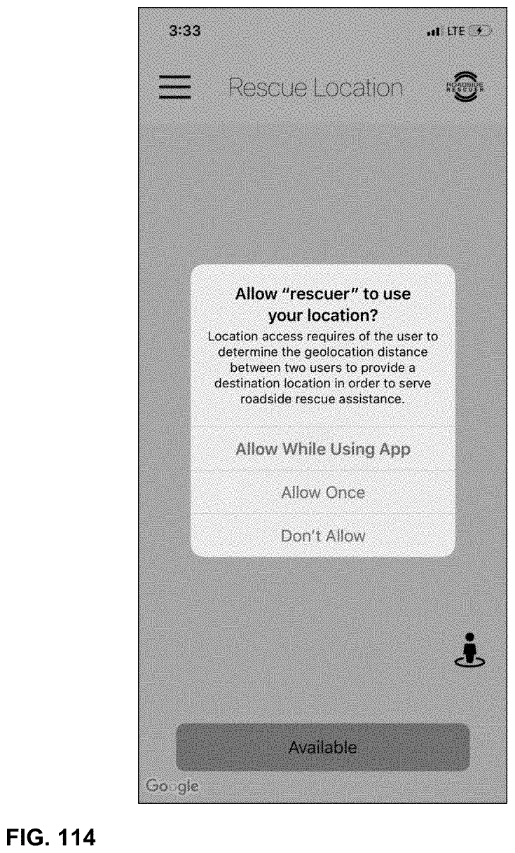

FIGS. 106 to 109 show a safety policy page asking the user to accept a safety policy. FIG. 110 shows a welcome page. FIG. 111 shows a loading page. FIG. 112 shows a notice page regarding a need for a payment method to receive payment from the vehicle assistance system. FIG. 113 depicts a logout page. FIG. 114 shows a location request page prompting the service provider to allow the vehicle assistance system to use the location generated by the mobile device of the service provider.

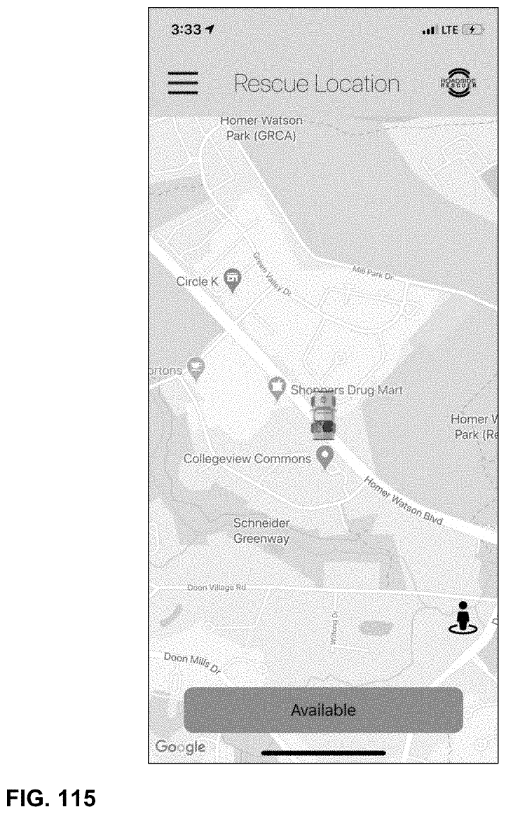

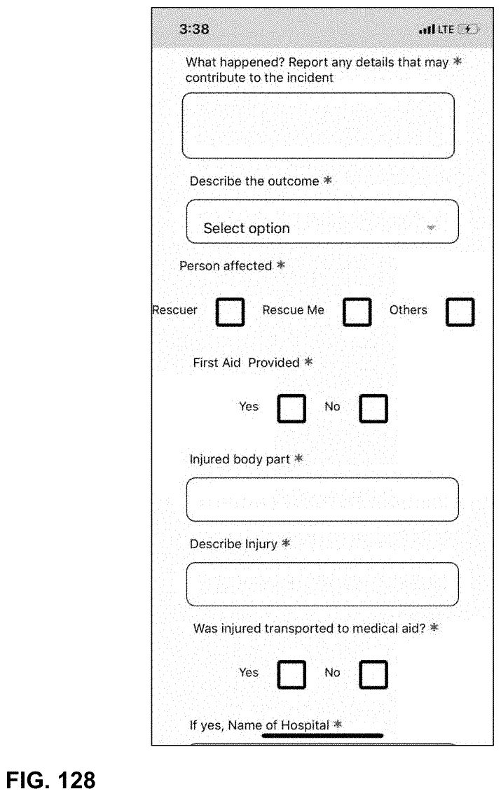

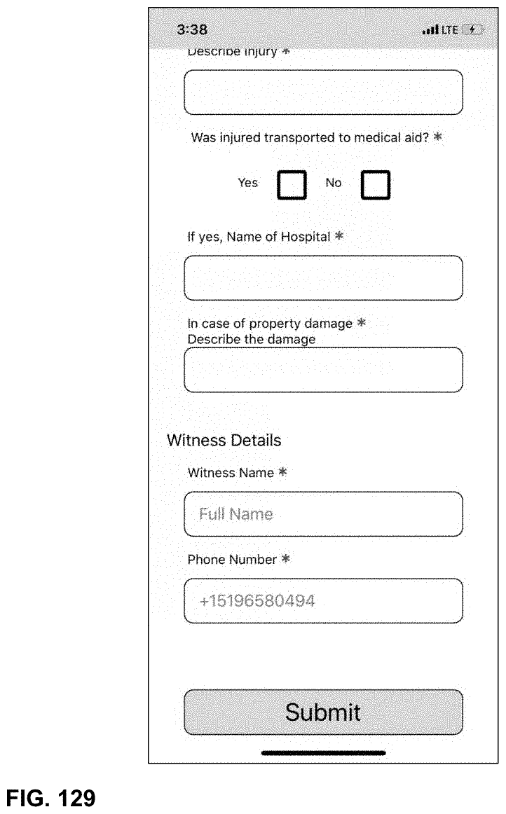

FIGS. 115 to 129 depict pages generated by a second service provider response navigator style interface.

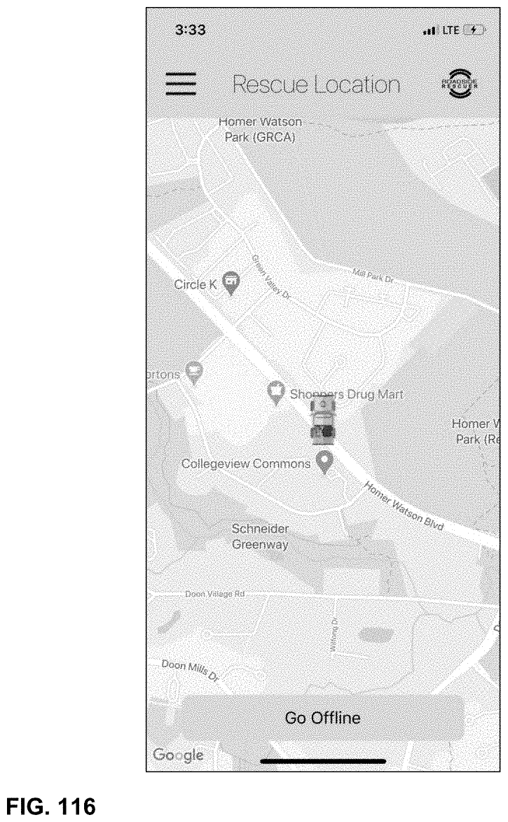

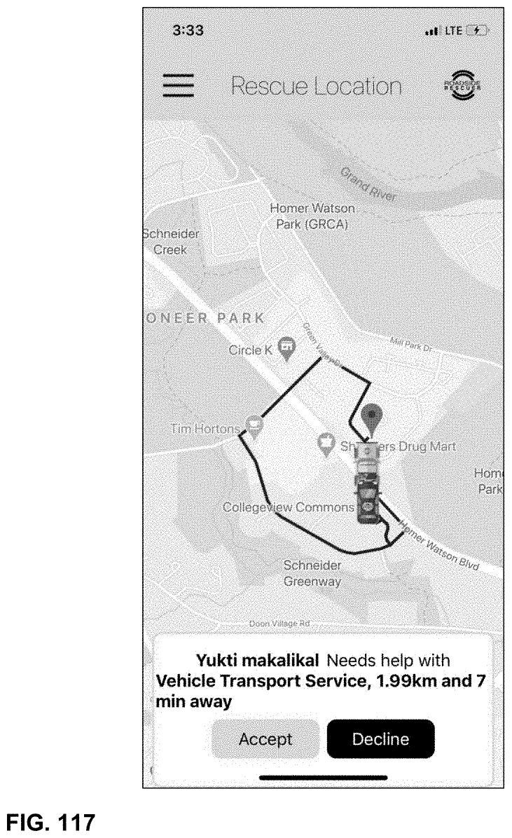

The service provider may be provided with a map showing the service provider's current location and availability status. If the service provider is matched to a service request, the service provider may be provided with information about the service request. FIG. 115 shows a map page identifying a location of the service provider. FIG. 116 shows an alternative map page identifying the location of the service provider. FIG. 117 shows a route page showing a route to a location of a service user who has requested a service, along with information regarding the service that has been requested and the vehicle of the service user.

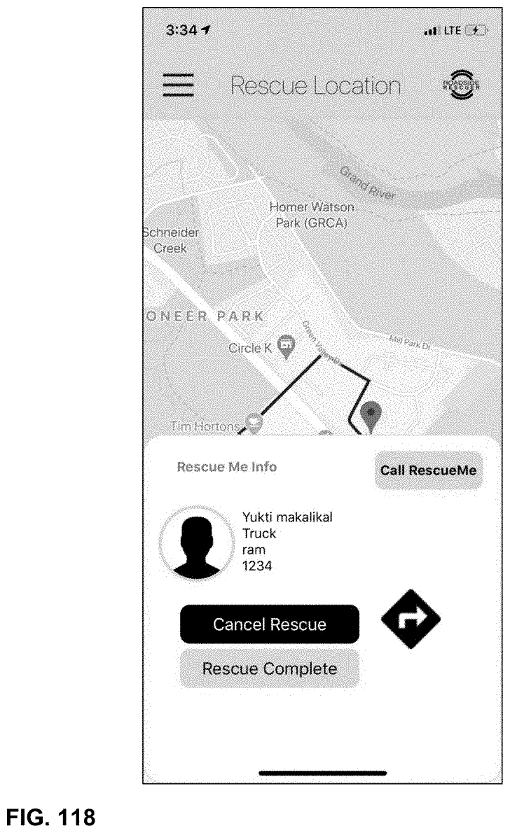

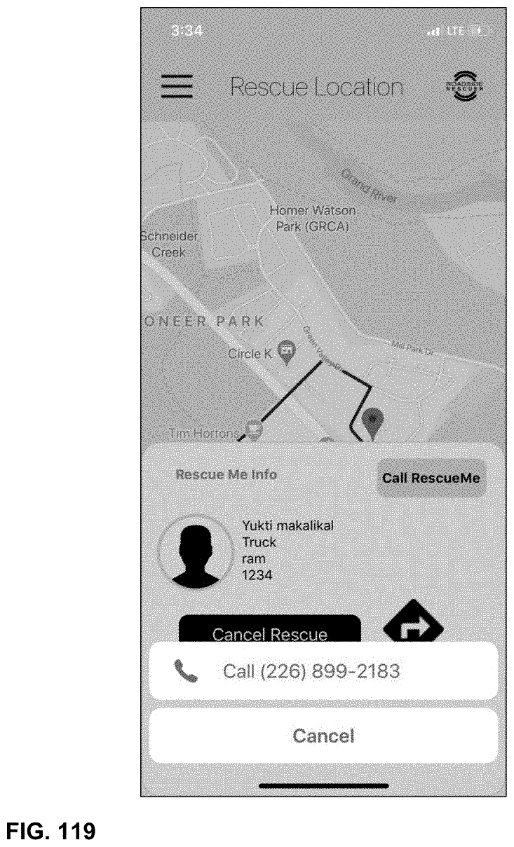

The service provider may be able to contact the service user, such as en route. FIGS. 118 and 119 show pages provided to the service provider which include service user summary information, including a phone number to enable the service provider to call the service user.

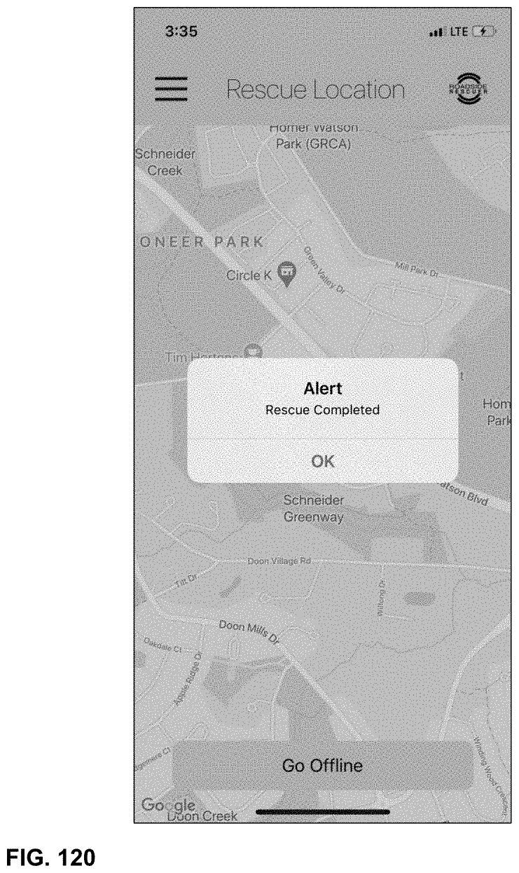

The service provider may be notified when the service is complete. An example notice page notifying the service provider that the service is complete is shown in FIG. 120.

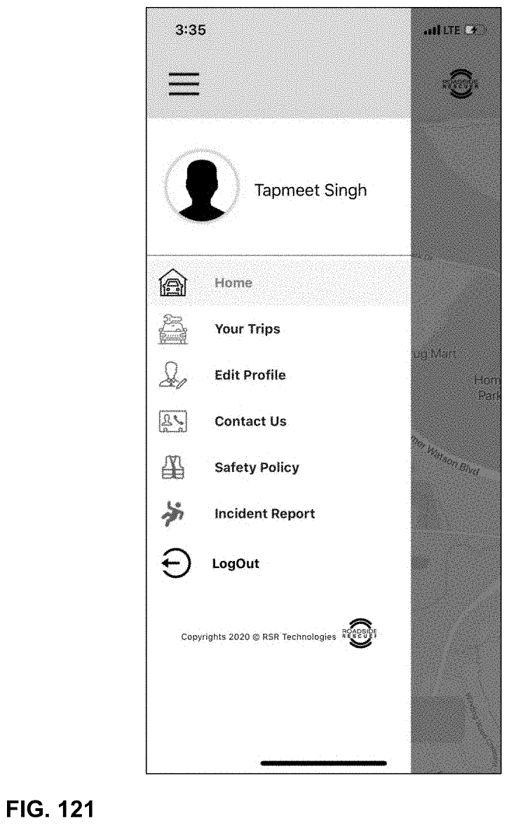

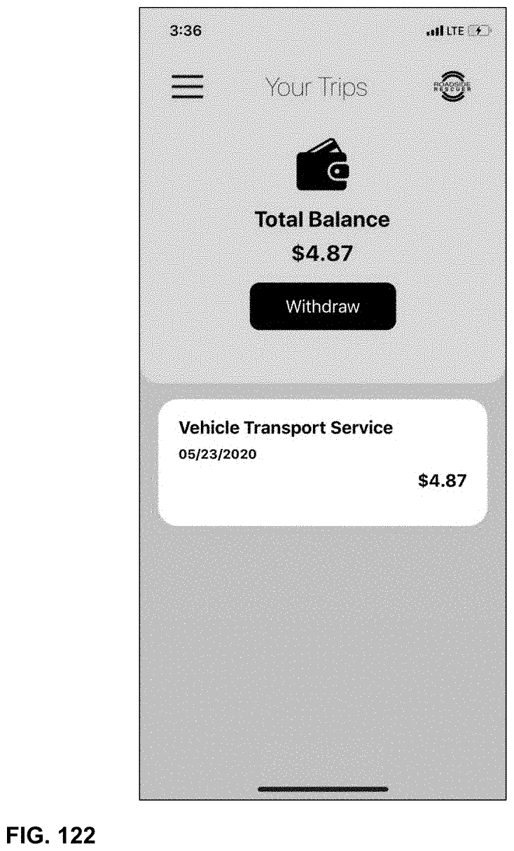

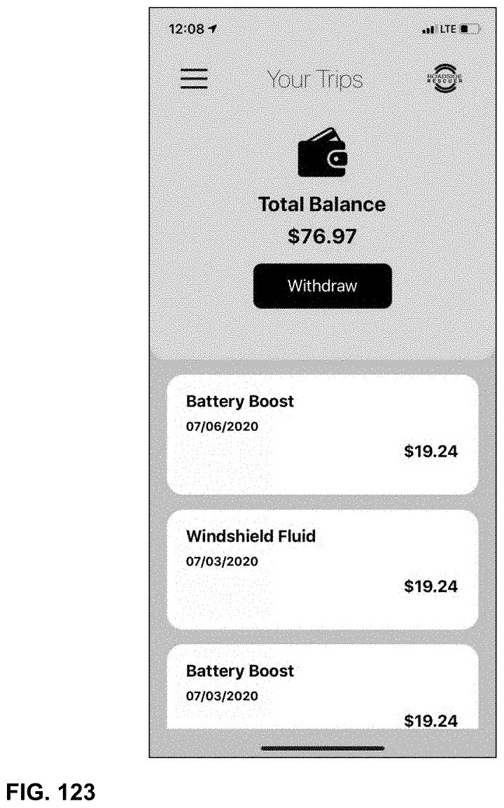

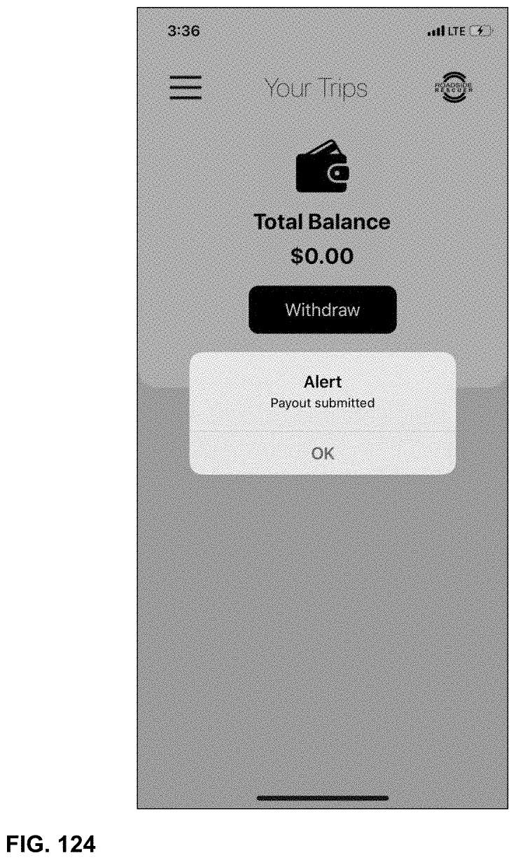

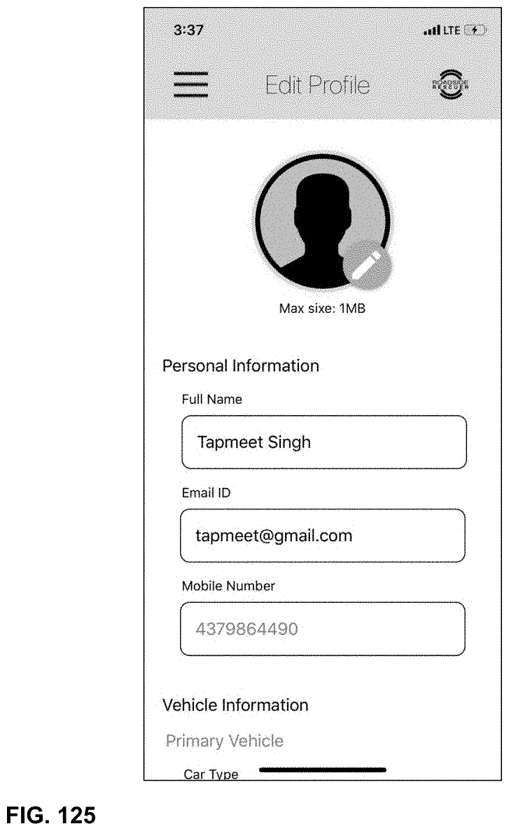

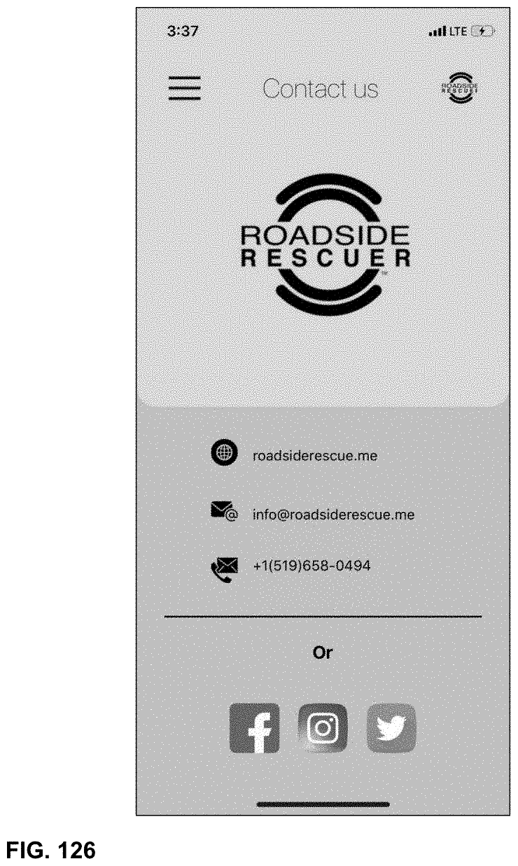

A service provider may be able to access a menu page, as shown for example in FIG. 121. The service provider may be able to access a history page showing a list of past service requests and associated information, as shown for example in FIG. 122 and an alternative example is shown in FIG. 123. The service provider may be able to withdraw funds from the vehicle assistance system, and may be provided with a notice page (e.g. the page shown in FIG. 124) notifying the service provider that funds have been withdrawn. The service provider may also be able to access a profile editing page, as shown for example in FIG. 125. FIG. 126 shows an example vehicle assistance system administration contact page, providing the service provider with contact information for an administrator.

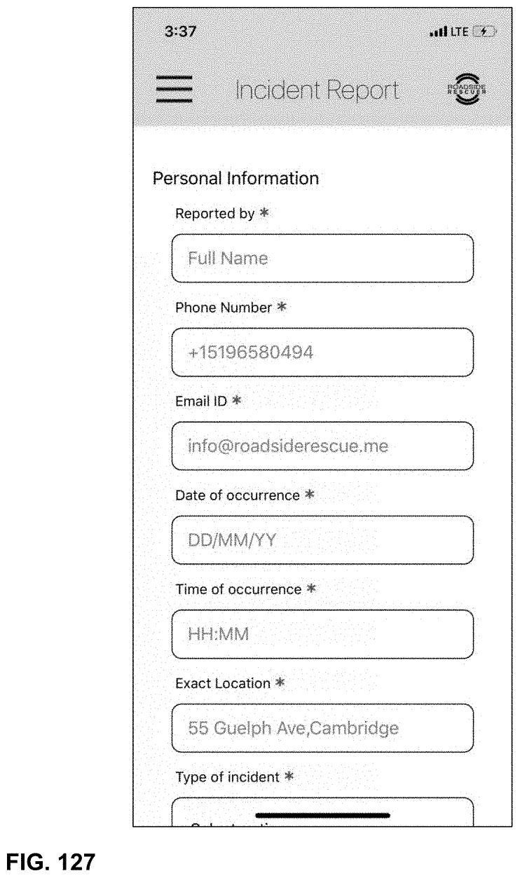

If an incident takes place during a service, the service provider may be able to report the incident. FIGS. 127 to 129 show an example incident report page. The service provider may user the incident report page to enter details about the incident, such as what took place, if any damage has occurred, and if anyone was injured.

FIG. 130 depicts a page generated by a third service provider response navigator style interface. The illustrated page is an information page showing the service provider a list of services and fees accumulated, and allowing the service provider to request a payout of the fees.

In some examples, the vehicle system is to operable to allow users to send service providers to provide roadside assistance services to or for non-users.

The present has been provided by way of example only. Various modification and variations may be made to these examples without departing from the scope of the invention, which is limited only by the appended claims.

1. A roadside assistance system, comprising:
at least one processor; and
at least one data storage device communicatively coupled to the at least one processor, and
wherein the at least one processor is operable to:
provide a first navigator style interface to a service user;
prompt, via the first navigator style interface, the service user to provide a user vehicle identifier to identify a vehicle of the service user;
receive the user vehicle identifier;
present a plurality of roadside service options to the service user;
receive a user service selection of the plurality of roadside service options from the service user;
receive a user location of the service user;
match the user service selection to a service provider; and
provide the service provider with the user service selection, the user vehicle identifier, and the user location.

2. The roadside assistance system of claim 1, wherein the at least one processor is operable to, prior to matching the user service selection to the service provider:
provide a second navigator style interface to the service provider;
prompt, via the second navigator style interface, the service provider to provide a first piece of evidence of possession of a roadside service skill for performing the user service selection;
prompt, via the second navigator style interface, the service provider to provide a second piece of evidence of possession of a roadside service tool for performing the user service selection;
receive the first piece of evidence and the second piece of evidence from the service provider.

3. The roadside assistance system of claim 2, wherein the at least one processor is operable to, prior to matching the user service selection to the service provider:
provide the first piece of evidence and the second piece of evidence to an administrator user; and
receive a confirmation of eligibility from the administrator user, the confirmation of eligibility indicating that the service provider is eligible to provide the user service selection.

4. The roadside assistance system of claim 3, wherein the at least one processor is operable to:
prompt, via the second navigator interface, the service provider to provide a provider vehicle identifier to identify a vehicle of the service provider; and
provide the provider vehicle identifier to the service user.

5. The roadside assistance system of claim 3, wherein the at least one processor is operable to, prior to matching the user service selection to the service provider:
present, via the second navigator style interface, the service provider with a choice of at least two classes of roadside services, each of the at least two classes including at least two roadside service types; and
receive from the service provider, via the second navigator style interface, at least one class selection of the at least two classes and at least one service type selection of the at least two roadside service types, the at least one service type selection including the user service selection.

6. The roadside assistance system of claim 3, wherein the first piece of evidence includes evidence of a mechanic's license and the second piece of evidence includes evidence of a set of mechanic's tools.

7. The roadside assistance system of claim 1, wherein the plurality of roadside service options includes a battery boost service, a vehicle unlock service, a tire change service, a towing service, and a fluid top up service.

8. A method of providing roadside assistance, comprising:
providing a service user with a first navigator style interface for walking the user through a user profile creation process;
eliciting from the service user, via the first navigator style interface, at least one user vehicle identifier for identifying a user vehicle of the service user;
generating a user profile, the user profile including the at least one user vehicle identifier;
presenting the service user with a plurality of roadside service options each directed to a different type of roadside assistance;
receiving from the service user a user service selection of the plurality of roadside service options;
receiving a user location of the service user;
matching the user service selection to a service provider; and
providing the service provider with the user service selection, the user vehicle identifier, and the user location.

9. The method of claim 8, further comprising, prior to matching the user service selection to the service provider:
providing a second navigator style interface to the service provider;
prompting, via the second navigator style interface, the service provider to provide a first piece of evidence of possession of a roadside service skill for performing the user service selection;
prompting, via the second navigator style interface, the service provider to provide a second piece of evidence of possession of a roadside service tool for performing the user service selection; and
receiving the first piece of evidence and the second piece of evidence from the service provider.

10. The method of claim 9, further comprising, prior to matching the user service selection to the service provider:
providing the first piece of evidence and the second piece of evidence to an administrator user; and
receiving a confirmation of eligibility from the administrator user, the confirmation of eligibility indicating that the service provider is eligible to provide the user service selection.

11. The method of claim 10, further comprising:
prompting, via the second navigator interface, the service provider to provide a provider vehicle identifier to identify a vehicle of the service provider; and
providing the provider vehicle identifier to the service user.

12. The method of claim 10, further comprising, prior to matching the user service selection to the service provider:
presenting, via the second navigator style interface, the service provider with a choice of at least two classes of roadside services, each of the at least two classes including at least two roadside service types; and
receiving from the service provider, via the second navigator style interface, at least one class selection of the at least two classes and at least one service type selection of the at least two roadside service types, the at least one service type selection including the user service selection.

13. The method of claim 10, wherein the first piece of evidence includes evidence of a mechanic's license and the second piece of evidence includes evidence of a set of mechanic's tools.

14. The method of claim 8, wherein the plurality of roadside service options includes a battery boost service, a vehicle unlock service, a tire change service, a towing service, and a fluid top up service.

15. A roadside assistance system, comprising:
at least one processor; and
at least one data storage device communicatively coupled to the at least one processor, and
wherein the at least one processor is operable to:
provide a first navigator style interface to a service user;
present, via the first navigator style interface, a plurality of roadside service options to the service user;
receive, via the first navigator style interface, a user service selection of the plurality of roadside service options from the service user;
receive a user location of the service user;
access the at least one data storage device to retrieve a user profile associated with the service user, the user profile including a user vehicle identifier to identify a vehicle of the service user;
access the at least one data storage device to retrieve a provider profile of a service provider, the provider profile including a confirmation that the service provider possesses a roadside service skill and a roadside service tool for performing the user service selection; and
send the user service selection, the user vehicle identifier, and the user location to the service provider.

16. The roadside service system of claim 15, wherein the selected service is a first roadside service, and the plurality of roadside service options also includes a second roadside service, the first roadside service associated with a first set of skills and tools and the second roadside service associated with a second set of skills and tools different from the first set of skills and tools.

17. The roadside service system of claim 15, wherein the confirmation includes a first piece of evidence of possession of the roadside service skill and a second piece of evidence of possession of the roadside service tool.

18. The roadside assistance system of claim 17, wherein the first piece of evidence includes evidence of a mechanic's license and the second piece of evidence includes evidence of a set of mechanic's tools.

19. The roadside service system of claim 15, wherein the provider profile includes a provider vehicle identifier to identify a vehicle of the service provider, and the at least one processor is operable to provide the provider vehicle identifier to the service user.

20. The roadside assistance system of claim 15, wherein the plurality of roadside service options includes a battery boost service, a vehicle unlock service, a tire change service, a towing service, and a fluid top up service.
